(19) United States
(12) Patent Application Publication
(10) Pub. No.: US 2006/0137726 A1
(43) Pub. Date: Jun. 29, 2006

(54) Substrate treating apparatus

(75) Inventors: Kenichi Sano, Kyoto (JP); Shuzo Nagami, Kyoto (JP); Ichiro Mitsuyoshi, Kyoto (JP); Takiyoshi Sakai, Kyoto (JP)

Correspondence Address: OSTROLENK FABER GERB & SOFFEN, 1180 AVENUE OF THE AMERICAS, NEW YORK, NY, 100368403, US

(73) Assignee: Dainippon Screen Mfg. Co., Ltd.

(21) Appl. No.: 11/316,238

(22) Filed: Dec. 21, 2005

(30) Foreign Application Priority Data
Dec. 24, 2004 (JP) 2004-372882
Mar. 18, 2005 (JP) 2005-079585
Mar. 18, 2005 (JP) 2005-079586
Mar. 18, 2005 (JP) 2005-079587

(51) Int. Cl. B08B 3/00; B05C 11/00

(52) U.S. Cl. 134/61; 118/696

(57) ABSTRACT

A substrate treating apparatus includes a storage block for accommodating foups each storing a plurality of substrates, a first treating block for treating a plurality of substrates en bloc, a second treating block for treating one substrate at a time, and a transport device for transporting the substrates between the foups, first treating block and second treating block. The substrates may be treated in a mode of treating a plurality of substrates en bloc, and/or a mode of treating one substrate at a time.

### BACKGROUND OF THE INVENTION

(1) Field of the Invention

This invention relates to a substrate treating apparatus for treating substrates such as semiconductor wafers, glass substrates for liquid crystal displays and the like (hereinafter called simply substrates).

(2) Description of the Related Art

For various types of substrate treating apparatus, treating modes may be classified broadly into a batch mode for treating a plurality of (e.g. 25) substrates en block, and a piecemeal mode for treating one substrate at a time.

In the batch treating mode, a plurality of substrates under treatment are immersed en bloc in a treating solution stored in a treating tank. This mode has an excellent mass production feature of substrate treatment, and assures a uniform quality of substrate treatment (as disclosed in Japanese Unexamined Patent Publication No. 2001-196342, for example).

In the piecemeal or single-substrate treating mode, a treating solution is supplied to a single substrate spinning in horizontal posture for treatment. This mode can treat substrates with a relatively high accuracy (as disclosed in Japanese Unexamined Patent Publication No. 2000-070873, for example).

Both these modes have advantages and disadvantages depending on the particulars of treatment. Each mode is employed according to what is required of treatment.

The conventional apparatus operable in such modes have the following drawbacks.

With the batch treating mode, substrates sometimes show unsatisfactory results or quality of treatment. Particularly when the cleaning of substrates is inadequate, the substrates treated in the batch mode must be further cleaned in the piecemeal mode to enhance the quality of treatment.

In addition, when a necessity arises in the course of a series of treating processes to treat substrates in the two modes combined, separate substrate treating apparatus designed for the two different modes must be made available. This results in inconveniences of enlarged installation space and an increase in cost. Moreover, when transporting substrates between these substrate treating apparatus, the substrates once move outside one of the apparatus, thus facing a possibility of being contaminated.

### SUMMARY OF THE INVENTION

This invention has been made having regard to the state of the art noted above, and its object is to provide a substrate treating apparatus for treating substrates in one or both of a first treating block for treating the substrates in a batch mode, and a second treating block for treating the substrates in a piecemeal mode.

The above object is fulfilled, according to this invention, by a substrate treating apparatus comprising a receptacle table for supporting a receptacle that stores a plurality of substrates; a substrate treating block including a first treating section for treating a plurality of substrates en bloc, and a second treating section for treating the substrates one at a time; a transport mechanism for transporting the substrates between the receptacle table, the first treating section and the second treating section; and a control device for controlling, based on substrate treating conditions, a transport operation of the transport mechanism for transporting the substrates between the receptacle table, the first treating section and the second treating section.

According to this invention, the substrate treating block includes a first treating section for treating a plurality of substrates en bloc, and a second treating section for treating the substrates one at a time. The transport mechanism, under control of the control device, transports the substrates from the receptacle table to either the first treating section or the second treating section. Thus, one substrate treating apparatus can perform cleaning, etching, stripping and drying treatments in the mode of treating a plurality of substrates en bloc, and the mode of treating one substrate at a time. In this way, the substrates may be treated with high precision.

The substrate treating block may be divided into two regions, the first treating section and the second treating section being arranged opposite each other, the first treating section being disposed in one of the regions, and the second treating section being disposed in the other of the regions. The substrate treating block is divided into two regions. The first treating section and second treating section are arranged in the respective regions as opposed to each other. This provides improved efficiency in arranging the substrate treating block to realize a reduced footprint. The transport operation of the transport mechanism involves a reduced amount of movement to realize excellent transporting efficiency.

The apparatus may further comprise a partition between the two regions noted above. The partition separates the atmospheres in the respective regions, and prevents the atmosphere of one region from diffusing to the other region. Thus, the substrates may be treated properly in each of the first and second treating sections arranged in these regions.

The first treating section may include a treating unit for treating a plurality of substrates in vertical posture with a treating solution; a drying unit for drying the plurality of substrates in vertical posture after being treated in the treating unit; a posture changing mechanism for delivering and receiving the plurality of substrates to/from the transport mechanism, and changing the plurality of substrates between horizontal posture and vertical posture; and a first treating section's transport mechanism for delivering and receiving the plurality of substrates to/from the posture changing mechanism, and transporting the substrates between the treating unit and the drying unit.

In the course of transporting the substrates between the first treating section and the transport mechanism, the posture changing mechanism changes the posture of the plurality of substrates en bloc. This provides a convenience in transporting the substrates to the treating unit or drying unit which treats the plurality of substrates in vertical posture. The first treating section's transport mechanism, while delivering and receiving the substrates to/from the posture changing mechanism, transports the substrates between the treating unit and the drying unit. This further improves the efficiency of transport within the first treating section.

The second treating section may include a single-substrate treating unit for treating one substrate at a time, and a second treating section's transport mechanism for transporting the substrates between the transport mechanism and the single-substrate treating unit. The second treating section's transport mechanism transporting the substrates between the transport mechanism and the single-substrate treating unit further improves the efficiency of transport within the second treating section.

The posture changing mechanism included in the first treating section may be a first posture changing mechanism, and the apparatus may further comprise a second posture changing mechanism disposed opposite the transport mechanism across the substrate treating block, for transporting the substrates between the first treating section and the second treating section, and changing the plurality of substrates between horizontal posture and vertical posture. In the course of transporting the substrates between the first treating section and second treating section, the second posture changing mechanism changes the posture of the plurality of substrates en bloc. This provides a convenience in transporting the substrates between the first treating section and second treating section. With the second posture changing mechanism disposed opposite the transport mechanism across the substrate treating block, there is no chance of the second posture changing mechanism interfering with the transport mechanism. Thus, transport operations of the transport mechanism and second posture changing mechanism may be controlled independently of each other.

The transport mechanism may be arranged to transport the substrates treated in the first treating section to the second treating section. The substrates treated in the mode of treating a plurality of substrates en bloc may be treated continually in the mode of treating one substrate at a time.

The transport mechanism may be arranged to transport the substrates treated in the second treating section to the first treating section. The substrates treated in the mode of treating one substrate at a time may be treated continually in the mode of treating a plurality of substrates en bloc.

In another aspect of the invention, a substrate treating apparatus comprises a storage block for receiving a receptacle that stores a plurality of substrates; a first treating block for treating a plurality of substrates en bloc; a second treating block for treating the substrates one at a time; and a transport block for transporting the substrates between the receptacle received in the storage block, the first treating block and the second treating block.

According to this invention, the apparatus with the first treating block and second treating block can treat the substrates both in the mode of treating a plurality of substrates en bloc and in the mode of treating one substrate at a time. Further, the atmosphere of the storage block that accommodates the receptacle is maintained clean.

The second treating block may be disposed between the first treating block and the storage block, and the transport block may be disposed between the first treating block and the storage block, and opposed to the second treating block. In this arrangement, the transport block is surrounded by the first treating block, second treating block and storage block, which realizes a shortened transport track. Consequently, the substrates may be transported efficiently.

The first treating block, the second treating block and the storage block may be arranged along a long side of the substrate treating apparatus. This arrangement allows the short sides of the substrate treating apparatus to be shorter than where the first treating block and second treating block are arranged at one side of the storage block. Dead space can also be eliminated to reduce the footprint of the apparatus.

In a further aspect of the invention, a substrate treating apparatus comprises a receptacle table for supporting a receptacle that stores a plurality of substrates; a first treating block for treating a plurality of substrates en bloc; a second treating block for treating the substrates one at a time; and a transport block for transporting the substrates between the receptacle placed on the receptacle table, the first treating block and the second treating block; wherein the second treating block is disposed between the first treating block and the receptacle table, and the transport block is disposed between the first treating block and the receptacle table and opposed to the second treating block.

According to this invention, the apparatus with the first treating block and second treating block can treat the substrates both in the mode of treating a plurality of substrates en bloc and in the mode of treating one substrate at a time. Further, the transport block is surrounded by the first treating block, second treating block and storage block, which realizes a shortened transport track. Consequently, the substrates may be transported efficiently.

In a still further aspect of the invention, a substrate treating apparatus comprises a receptacle table for supporting a receptacle that stores a plurality of substrates; a first treating block for treating a plurality of substrates en bloc; a second treating block for treating the substrates one at a time; and a transport block for transporting the substrates between the receptacle placed on the receptacle table, the first treating block and the second treating block; wherein the first treating block, the second treating block and the receptacle table are arranged in order along a long side of the substrate treating apparatus.

According to this invention, the apparatus with the first treating block and second treating block can treat the substrates both in the mode of treating a plurality of substrates en bloc and in the mode of treating one substrate at a time. Further, the above-noted arrangement allows the short sides of the substrate treating apparatus to be shorter than where the first treating block and second treating block are arranged at one side of the storage block. Dead space can also be eliminated to reduce the footprint of the apparatus.

The first treating block may be arranged to clean and dry a plurality of substrates en bloc, and the second treating block to clean and dry the substrates one at a time. Then, the substrates may be cleaned and dried both in the mode of treating a plurality of substrates en bloc and in the mode of treating one substrate at a time.

The second treating block may be arranged to clean at least edge regions on a back surface of each of the substrates.

The second treating block may be arranged further to etch the substrates one at a time.

The transport block may be arranged to transport the substrates treated in the second treating block from the second treating block to the first treating block. By transporting the substrates in this way, the substrates having been treated in the second treating block are treated in the first treating block.

The transport block may be arranged to transport the substrates treated in the first treating block from the first treating block to the second treating block. By transporting the substrates in this way, the substrates having been treated in the first treating block are treated in the second treating block.

The transport block may be arranged to transport the substrates from the receptacle to the second treating block, to transport the substrates treated in the second treating block from the second treating block to the first treating block, and to transport the substrates treated in the first treating block from the first treating block to the receptacle. By transporting the substrates in this way, the substrates to be treated, stored in the receptacle, are treated in the first treating block and then in the second treating block, and the substrates having undergone these treatments are loaded as treated substrates back into the receptacle.

The transport block may include a transport block's transport mechanism for transporting a plurality of substrates en bloc; and the second treating block may include a single-substrate treating section for cleaning and drying the substrates one at a time, a second treating block's substrate rack for holding a plurality of substrates, and a second treating block's transport mechanism for transporting the substrates one at a time between the single-substrate treating section and the second treating block's substrate rack; the transport block's transport mechanism placing and fetching a plurality of substrates en bloc on/from the second treating block's substrate rack. The transport block having the transport block's transport mechanism transports a plurality of substrates en bloc to the second treating unit. This provides a high efficiency of transporting the substrates. The second treating block has the second treating block's substrate rack for holding a plurality of substrates, to be able to deliver and receive the substrates to/from the transport block's transport mechanism. The second treating block has also the second treating block's transport mechanism for transporting the substrates one at a time. Thus, the substrates can be transported between the second treating block's substrate rack and the single-substrate treating section.

The second treating block's substrate rack may include a pre-treatment substrate rack for holding a plurality of substrates before treatment in the single-substrate treating section, and a post-treatment substrate rack for holding a plurality of substrates after the treatment in the single-substrate treating section; the second treating block's transport mechanism transporting the substrates one at a time from the pre-treatment substrate rack to the single-substrate treating section, and transporting the substrates one at a time from the single-substrate treating section to the post-treatment substrate rack; the transport block's transport mechanism placing a plurality of substrates en bloc on the pre-treatment substrate rack, and fetching a plurality of substrates en bloc from the post-treatment substrate rack. With the second treating block's substrate rack including the pre-treatment substrate rack and post-treatment substrate rack, the substrates transported into the second treating block are placed on one rack, while the substrates to be transported out of the second treating block are placed on the other rack. Thus, the substrates having been treated in the second treating block are not contaminated by the substrates to be treated in the second treating block.

Where the transport block's transport mechanism can transport the substrates, N in number, each of the pre-treatment substrate rack and the post-treatment substrate rack may hold the substrates, a multiple of N in number. Then, each of the pre-treatment substrate rack and the post-treatment substrate rack can hold in stock the number of substrates corresponding to the quantity transported N times by the transport block's transport mechanism.

The single-substrate treating section may include a plurality of treating units arranged in a plurality of rows and in a plurality of stages, the second treating block's transport mechanism transporting the substrates one at a time from the pre-treatment substrate rack to each of the treating units, and transporting the substrates one at a time from each of the treating units to the post-treatment substrate rack. The single-substrate treating section with the plurality of treating units has an increased treating capacity. Since the treating units are stacked vertically, an increase in footprint is avoided.

The transport block may include a transport block's transport mechanism for transporting a plurality of substrates en bloc; and the first treating block may include a batch treating section for liquid-treating and drying a plurality of substrates en bloc, a first treating block's substrate rack for holding a plurality of substrates, and a first treating block's transport mechanism for transporting a plurality of substrates en block between the batch treating section and the first treating block's substrate rack; the transport block's transport mechanism placing and fetching a plurality of substrates en bloc on/from the first treating block's substrate rack. With this construction, the transport block can transport the substrates to the first treating block appropriately through the first treating block's substrate rack. The first treating block's transport mechanism can transport the substrates appropriately between the batch treating section and first treating block's substrate rack.

The transport block's transport mechanism may be arranged to deliver and receive the substrates in horizontal posture to/from the first treating block's substrate rack; the first treating block's transport mechanism may be arranged to deliver and receive the substrates in vertical posture to/from the first treating block's substrate rack; and the first treating block's substrate rack may be arranged to change a plurality of substrates en block between horizontal posture and vertical posture for transfer to the transport block's transport mechanism and the first treating block's transport mechanism. The transport block's transport mechanism which transports a plurality of substrates in horizontal posture en bloc can transport the substrates conveniently to and from the receptacle which stores a plurality of substrates in horizontal posture, and to and from the second treating block's substrate rack which holds a plurality of substrates in horizontal posture. The first treating block's transport mechanism, which transports a plurality of substrates in vertical posture en bloc, can transport the substrates conveniently to and from the first treating block's substrate rack, and to and from the batch treating section which treats a plurality of substrates in vertical posture en bloc. According to this invention, the first treating block's substrate rack changes a plurality of substrates en block between horizontal posture and vertical posture in the course of substrate transfer between the transport block's transport mechanism and first treating block's transport mechanism. Consequently, the substrates can be transferred conveniently between the transport block's transport mechanism and first treating block's transport mechanism.

The apparatus according to this invention may further comprise a partition separating the storage block from the second treating block and the transport block, and defining a passage opening opposed to the receptacle in the storage block for allowing passage of the substrates, and a shutter member for opening and closing the passage opening, the transport block being arranged to load and unload the substrates into/from the receptacle in the storage block through the passage opening. The partition and shutter member prevent the atmosphere of the storage block flowing into the second treating block and transport block. The first treating block disposed opposite the storage block across the second treating block is shielded from the atmosphere of the storage block, as are the second treating block and transport block. Thus, in the transport block which receives the substrates from the receptacle, or in the first and second treating blocks, the substrates are never contaminated by the atmosphere from the storage block.

The receptacle may have an opening formed in one side thereof, and a lid for closing the opening, the shutter member having an attaching/detaching and holding mechanism for attaching, detaching and holding the lid of the receptacle in the storage block. The lid of the receptacle is detachable by the shutter member which opens and closes the passage opening in the partition. Thus, the interior of the receptacle is opened only to the transport block. Since the atmosphere of the storage block accommodating the receptacle does not flow into the receptacle, the substrates in the receptacle are free from contamination.

In a still further aspect of the invention, a substrate treating apparatus comprises a storage block for receiving receptacles each storing a plurality of substrates; a first treating block for treating a plurality of substrates en bloc; and a second treating block for treating the substrates one at a time; the storage block including a first table for holding the receptacles for access from the first treating block; a second table for holding the receptacles for access from the second treating block; and a receptacle transport device for transporting the receptacles between the first table and the second table; wherein the first treating block includes a first transport mechanism for loading and unloading the substrates into/from the receptacles placed on the first table; and the second treating block includes a second transport mechanism for loading and unloading the substrates into/from the receptacles placed on the second table.

According to this invention, the apparatus with the first treating block and second treating block can treat the substrates both in the mode of treating a plurality of substrates en bloc and in the mode of treating one substrate at a time. Further, the atmosphere of the storage block that accommodates the receptacles is maintained clean.

Further, the first treating block and second treating block are arranged such that the substrates are transported therebetween by way of the storage block. The substrates are never transferred directly between the first treating block and second treating block. Therefore, the first treating block and second treating block may be controlled independently of each other without requiring coordination between the two treating blocks. Even where the first treating block and second treating block are controlled independently, the two treating blocks may be coordinated and adjusted by controlling the storage block.

The first treating block and second treating block include the first transport mechanism and second transport mechanism, respectively. Thus, the substrates may be transported between the storage block and first treating block, and between the storage block and second treating block.

The receptacle transport device may be arranged to transport receptacles storing substrates treated in the second treating block, from the second table to the first table. By transporting the substrates in this way, the substrates treated in the second treating block may be treated in the first treating block.

The receptacle transport device may be arranged to transport receptacles storing substrates treated in the first treating block, from the first table to the second table. By transporting the substrates in this way, the substrates treated in the first treating block may be treated in the second treating block.

The first treating block and the second treating block may be arranged at one side of the storage block. This arrangement facilitates transfer of the substrates between the storage block and first treating block, and between the storage block and second treating block.

The first treating block and the second treating block may be opposed to each other. With this arrangement, the substrates are transported with ease to the first treating block and second treating block from the storage block disposed between these treating blocks.

The storage block may further include a rack for holding a plurality of receptacles, the receptacle transport device having a further function for transporting the receptacles to and from the rack. With the rack accessible to the receptacle transport device, the storage block can accommodate the receptacle in a convenient way.

The rack may be disposed on a receptacle transport track between the first table and the second table. This arrangement allows the receptacle transport device to access the rack with ease.

The rack may be arranged to hold the plurality of receptacles as arranged along a receptacle transport track of the receptacle transport device. Then, the receptacle transport device can access an increased number of receptacles, thereby increasing the quantity to be transported. Since these receptacles are all arranged on the transport path, transporting efficiency is improved also.

The receptacle transport device may include a third transport mechanism for transporting the receptacles between the first table and the rack, and a fourth transport mechanism for transporting the receptacles between the second table and the rack. The separate, third and fourth transport mechanisms can independently transport the receptacles between the first table and rack, and between the second table and rack. This improves transporting efficiency.

The third transport mechanism may be movable along one side of the rack for loading and unloading the receptacles on/from the rack at the one side, and the fourth transport mechanism movable along the other side of the rack for loading and unloading the receptacles on/from the rack at the other side.

Since the third transport mechanism and fourth transport mechanism have different transport paths, no interference occurs between operations of the third transport mechanism and fourth transport mechanism. Since the rack is from the two sides, both the transport paths of the third transport mechanism and fourth transport mechanism can be formed along the rack. This arrangement assures high transporting efficiency.

The second table may comprise a plurality of tables arranged on an extension of the rack, the fourth transport mechanism being movable along the other side of the rack which is remote from the first treating block. With the second tables arranged on an extension of the rack, the transport path of the fourth transport mechanism can be formed straight. The plurality of second tables allow an increased number of substrates to be transported between the storage block and second treating block.

The apparatus according to this invention may further comprise a first partition separating the storage block from the first treating block, and defining a first passage opening opposed to the receptacles placed on the first table for allowing passage of the substrates; a first shutter member for opening and closing the first passage opening; a second partition separating the storage block from the second treating block, and defining a second passage opening opposed to the receptacles placed on the second table for allowing passage of the substrates; and a second shutter member for opening and closing the second passage opening; the first transport mechanism being arranged to load and unload the substrates en bloc into/from the receptacles on the first table through the first passage opening; the second transport mechanism being arranged to load and unload the substrates one at a time into/from the receptacles on the second table through the second passage opening. The first and second partitions and first and second shutter members prevent the atmosphere of the storage block flowing into the first and second treating blocks. Thus, in the first and second treating blocks which receive the substrates from the receptacles, the substrates are never contaminated by the atmosphere from the storage block.

Each of the receptacles may have an opening formed in one side thereof, and a lid for closing the opening; the first shutter member having a first attaching/detaching and holding mechanism for attaching, detaching and holding the lid; the second shutter member having a second attaching/detaching and holding mechanism for attaching, detaching and holding the lid. With the first and second attaching/detaching and holding mechanisms, the lid of each receptacle is detachable by the first and second shutter members which open and close the first and second passage openings. Thus, the interior of each receptacle is opened only to the first and second treating blocks. Since the atmosphere of the storage block accommodating the receptacles does not flow into the receptacles, the substrates in the receptacles are free from contamination.

The first treating block may be arranged to clean and dry a plurality of substrates en bloc, and the second treating block to clean and dry the substrates one at a time. Then, the substrates may be cleaned and dried both in the mode of treating a plurality of substrates en bloc and in the mode of treating one substrate at a time.

The second treating block may be arranged to clean at least edge regions on a back surface of each of the substrates.

In a different aspect of the invention, a substrate treating apparatus comprises a storage block for receiving receptacles each storing a plurality of substrates; a first treating block for treating a plurality of substrates en bloc; and a second treating block for treating the substrates one at a time; the storage block including a first table for holding a receptacle for access from the first treating block, a second table for holding a receptacle for access from the second treating block, a third table for holding receptacles for access from outside the substrate treating apparatus, and a receptacle transport device for transporting the receptacles between the first table, the second table and the third table; wherein the first treating block includes a first transport mechanism for loading and unloading the substrates into/from a receptacle placed on the first table; and the second treating block includes a second transport mechanism for loading and unloading the substrates into/from a receptacle placed on the second table, and is disposed between the first treating block and the third table.

In another aspect of the invention, a substrate treating apparatus comprises a storage block for receiving receptacles each storing a plurality of substrates; a first treating block for treating a plurality of substrates en bloc; and a second treating block for treating the substrates one at a time; the storage block including a first table for holding a receptacle for access from the first treating block, a second table for holding a receptacle for access from the second treating block, and a receptacle transport device for transporting the receptacles between the first table and the second table; the first treating block including a first transport mechanism for loading and unloading the substrates into/from a receptacle placed on the first table, and a batch treating section for treating with a solution or drying a plurality of substrates en bloc; wherein the second treating block includes a second transport mechanism for loading and unloading the substrates into/from a receptacle placed on the second table, and is disposed on an extension of a direction in which the batch treating section is arranged.

According to this invention, the apparatus with the first treating block and second treating block can treat the substrates both in the mode of treating a plurality of substrates en bloc and in the mode of treating one substrate at a time. Further, the atmosphere of the storage block that accommodates the receptacles is maintained clean.

Further, the first treating block and second treating block are arranged such that the substrates are transported therebetween by way of the storage block. The substrates are never transferred directly between the first treating block and second treating block. Therefore, even where the first treating block and second treating block are controlled independently, the two treating blocks may be coordinated and adjusted by controlling the storage block.

Where the second treating block is disposed between the first treating block and the third table, or is disposed on an extension of the direction in which the batch treating section is arranged, the short sides of the substrate treating apparatus can be shorter than where the first treating block and second treating block are arranged at one side of the storage block. Dead space can also be eliminated to reduce the footprint of the apparatus.

The first treating block and second treating block include the first transport mechanism and second transport mechanism, respectively. Thus, the substrates may be transported between the storage block and first treating block, and between the storage block and second treating block.

The receptacles placed on the first table and the second table may have substrate-loading and -unloading planes thereof facing in the same direction. Then, the receptacle transport device is not required to turn the receptacles around in the storage block.

The apparatus according to this invention may further comprise shelves arranged along a transport path of the receptacle transport device for holding a plurality of receptacles as arranged thereon, the receptacle transport device transporting the receptacles to and from the shelves.

With the shelves arranged in the storage block, the latter may accommodate the receptacles in a convenient way. The receptacle transport device can access an increased number of receptacles, thereby increasing the quantity to be transported. Since these receptacles are all arranged on the transport path, transporting efficiency is improved also.

The shelves may be arranged in a position between the first treating block and the third table, and opposed to the second treating block. The storage block delivers and receives substrates to and from the first treating block as well as the second treating block, and therefore includes a portion opposed to the second treating block. The storage block can be made compact by installing the shelves in that portion.

The shelves may have one lateral end thereof acting as the first table. With one of the shelves located at the lateral end opposed to the first treating block acting as the first table, the storage block can be formed more compact than where the first table is provided separately from the shelves.

The second table may be disposed on an extension of the shelves. With the second table disposed on an extension of the shelves, the transport path of the receptacle transport device may be formed linear.

The second table may comprise a plurality of tables arranged vertically. The plurality of second tables allow an increased number of substrates to be transported between the storage block and second treating block. Since the second tables are arranged vertically, an increase in footprint is avoided.

The apparatus according to this invention may further comprise a first partition separating the storage block from the first treating block, and defining a first passage opening opposed to the receptacles placed on the first table for allowing passage of the substrates; a first shutter member for opening and closing the first passage opening; a second partition separating the storage block from the second treating block, and defining a second passage opening opposed to the receptacles placed on the second table for allowing passage of the substrates; and a second shutter member for opening and closing the second passage opening; the first transport mechanism being arranged to load and unload the substrates en bloc into/from the receptacles on the first table through the first passage opening; the second transport mechanism being arranged to load and unload the substrates one at a time into/from the receptacles on the second table through the second passage opening. The first and second partitions and first and shutter members prevent the atmosphere of the storage block flowing into the first and second treating blocks. Thus, in the first and second treating blocks which receive the substrates from the receptacles, the substrates are never contaminated by the atmosphere from the storage block.

Each of the receptacles may have an opening formed in one side thereof, and include a lid for closing the opening; the first shutter member having a first attaching/detaching and holding mechanism for attaching, detaching and holding the lid; the second shutter member having a second attaching/detaching and holding mechanism for attaching, detaching and holding the lid. With the first and second attaching/detaching and holding mechanisms provided, the lids of the receptacles are detachable by the first and second shutter members which open and close the first and second passage openings. Thus, the interiors of the receptacles are opened only to the first and second treating blocks. Since the atmosphere of the storage block accommodating the receptacles does not flow into the receptacles, the substrates in the receptacles are free from contamination.

The first treating block may be arranged to clean and dry a plurality of substrates en bloc, and the second treating block to clean and dry the substrates one at a time. Then, the substrates may be cleaned and dried both in the mode of treating a plurality of substrates en bloc and in the mode of treating one substrate at a time.

The second treating block may be arranged to clean at least edge regions on a back surface of each of the substrates.

### BRIEF DESCRIPTION OF THE DRAWINGS

For the purpose of illustrating the invention, there are shown in the drawings several forms which are presently preferred, it being understood, however, that the invention is not limited to the precise arrangement and instrumentalities shown.

FIG. 1 is a plan view showing an outline of a substrate treating apparatus in Embodiment 1;

FIG. 2A shows a plan view and a side view of a first posture changer when a support base is in horizontal posture;

FIG. 2B shows a plan view and a side view of the first posture changer when the support base is in vertical posture;

FIG. 3A is a front view of a first pusher and the first posture changer acting to transfer substrates;

FIG. 3B is a front view of the first pusher and first posture changer acting to transfer the substrates;

FIG. 4A is a front view showing a transfer of a group of substrates between the first pusher and a batch transport mechanism;

FIG. 4B is a front view showing the transfer of the group of substrates between the first pusher and batch transport mechanism;

FIG. 5 is a sectional view showing an outline of a drying unit;

FIG. 6A is a schematic view of a cleaning unit;

FIG. 6B is a schematic view showing a transfer of a group of substrates between a lifter and the batch transport mechanism;

FIG. 7 is a schematic view of a cleaning and drying unit;

FIG. 8 is a flow chart showing an example of operation of the substrate treating apparatus;

FIG. 9 is a plan view showing an outline of a substrate treating apparatus in Embodiment 2;

FIG. 10 is a plan view showing an outline of a substrate treating apparatus in Embodiment 3;

FIG. 11 is a perspective view of a foup;

FIG. 12A is a plan view of a storage block;

FIG. 12B is a front view of an interior of the storage block;

FIG. 13 is a side view showing portions of the storage block and a transport device;

FIG. 14 is a perspective view of a shutter member;

FIG. 15 is a side view illustrating operation of the shutter member;

FIG. 16A shows a plan view (above) and a side view (below berth) of a first treating block's substrate rack when a support base is in horizontal posture;

FIG. 16B is shows a plan view (above) and a side view (below) of the substrate rack when the support base is in vertical posture.

FIG. 17A is a front view of a pusher and the substrate rack acting to transfer substrates;

FIG. 17B is a front view of the pusher and substrate rack acting to transfer the substrates;

FIG. 18A is a side view showing a transfer of a group of substrates between the pusher and a first treating block's transport mechanism;

FIG. 18B is a side view showing the transfer of the group of substrates between the pusher and first treating block's transport mechanism;

FIG. 18C is a side view showing the transfer of groups of substrates between the pusher and first treating block's transport mechanism;

FIG. 18D is a side view showing the transfer of the groups of substrates between the pusher and first treating block's transport mechanism;

FIG. 19 is a schematic view showing an outline of a drying unit;

FIG. 20A is a schematic view of a deionized water cleaning unit;

FIG. 20B is a schematic view showing a transfer of a group of substrates between a lifter and the first treating block's transport mechanism;

FIG. 21A is a plan view of a pre-treatment substrate rack;

FIG. 21B is a front view of the pre-treatment substrate rack;

FIG. 22 is a perspective view showing an outline of a treating unit;

FIG. 23 is a flow chart showing an example of operation of the substrate treating apparatus;

FIG. 24 is a plan view showing an outline of a substrate treating apparatus in Embodiment 4;

FIG. 25 is a plan view showing an outline of a substrate treating apparatus in Embodiment 5;

FIG. 26 is a plan view of a storage block;

FIG. 27 is a front view of a rack;

FIG. 28 is a side view showing portions of the storage block and a first treating block;

FIG. 29 is a perspective view of a shutter member;

FIG. 30 is a side view illustrating operation of the shutter member;

FIG. 31 is a side view of a second transport mechanism;

FIG. 32 is a flow chart showing an example of operation of the substrate treating apparatus;

FIG. 33 is a plan view showing an outline of a substrate treating apparatus in Embodiment 6;

FIG. 34 is a plan view showing an outline of a substrate treating apparatus in Embodiment 7;

FIG. 35A is a plan view of a storage block;

FIG. 35B is a front view of a rack;

FIG. 36 is a side view showing portions of the storage block and a first treating block;

FIG. 37 is a side view of a foup transport mechanism;

FIG. 38 is a perspective view of a first shutter member;

FIG. 39 is a side view illustrating operation of the first shutter member;

FIG. 40 is a side view illustrating operation of a second shutter member;

FIG. 41 is a flow chart showing an example of operation of the substrate treating apparatus; and

FIG. 42 is a plan view showing an outline of a substrate treating apparatus in Embodiment 8.

### DESCRIPTION OF THE PREFERRED EMBODIMENTS

Preferred embodiments of this invention will be described in detail hereinafter with reference to the drawings.

### Embodiment 1

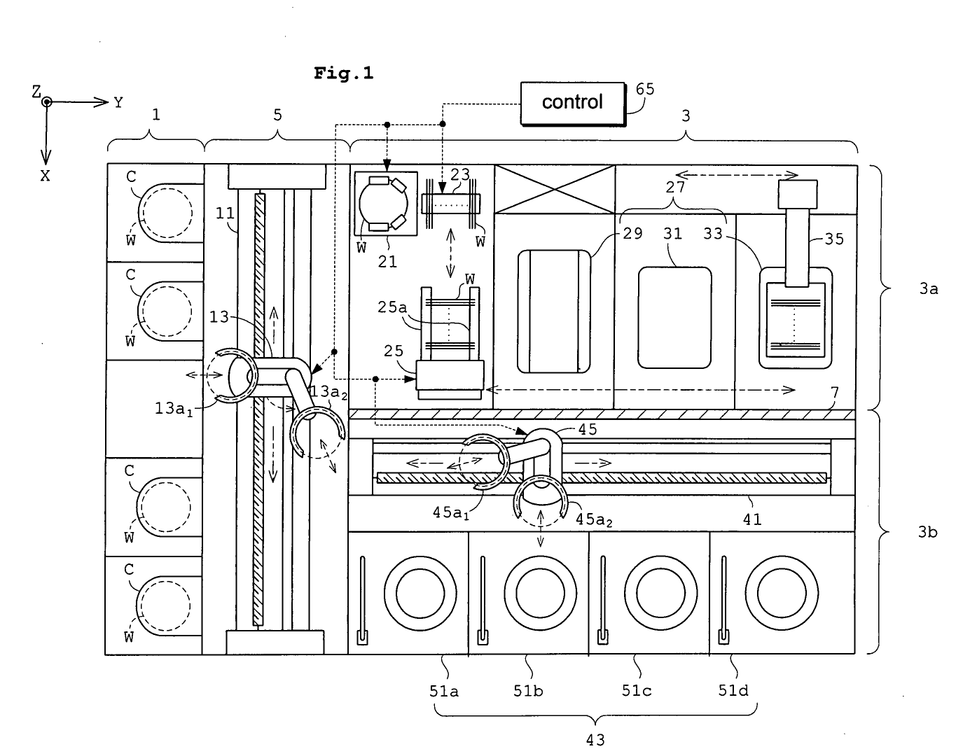

FIG. 1 is a plan view showing an outline of a substrate treating apparatus in Embodiment 1.

The substrate treating apparatus is constructed for performing a predetermined treatment (e.g. resist stripping treatment) of substrates or wafers W (e.g. semiconductor wafers). The apparatus, broadly, includes a cassette table 1 for supporting cassettes C storing wafers W, a treating block 3 for performing the predetermined treatment of wafers W, and a transport block 5 disposed between the cassette table 1 and treating block 3 for transporting the wafers W therebetween. The treating block 3 has a first treating section 3a for treating a plurality of wafers W en bloc, and a second treating section 3b for treating the wafer W one at a time.

Each cassette C placed on the cassette table 1 contains a plurality of (e.g. 25) wafers W in horizontal posture and in multiple stages (which wafers W may be called hereinafter “group of wafers W” where appropriate).

The transport block 5 includes a transport path 11 formed along the cassette table 1, and a transport mechanism 13 disposed on the transport path 11 for transporting wafers W. The transport mechanism 13 is driven by a screw feed mechanism to move horizontally (in X-direction in FIG. 1) along the transport path 11. The transport mechanism 13 has, arranged in upper positions thereof, two U-shaped holding arms 13a₁ and 13a₂ (hereinafter collectively called the holding arms 13a where the two arms are not distinguished), each for holding wafers W in horizontal posture one at a time. The transport mechanism 13 itself also drives the two holding arms 13a, by means of a drive mechanism not shown, to make swiveling movement, vertical movement, and horizontal extension and retraction. The transport mechanism 13 transports wafers W one at a time to a cassette C, the first treating section 3a or the second treating section 3b.

The treating block 3 is divided in a direction substantially normal to the transport path 11 into two regions. One region is the first treating section 3a, and the other the second treating section 3b. Thus, each of the treating sections 3a and 3b adjoins the transport block 5, while the two treating sections 3a and 3b are opposed to each other. A partition 7 is disposed between the two treating sections 3a and 3b for preventing flows of atmosphere therebetween.

The first treating section 3a has a first posture changer 21 for delivering and receiving wafers W to/from the transport block's transport mechanism 13, and changing the posture of a group of wafers W en bloc between horizontal posture and vertical posture, a first pusher 23 for delivering and receiving the group of wafers W en bloc to/from the first posture changer 21, a first treating section's transport mechanism 25 for delivering and receiving a group of wafers W to/from the first pusher 23, and a batch treating station 27 for delivering and receiving a group of wafers W to/from the transport mechanism 25, and treating the group of wafers W en bloc.

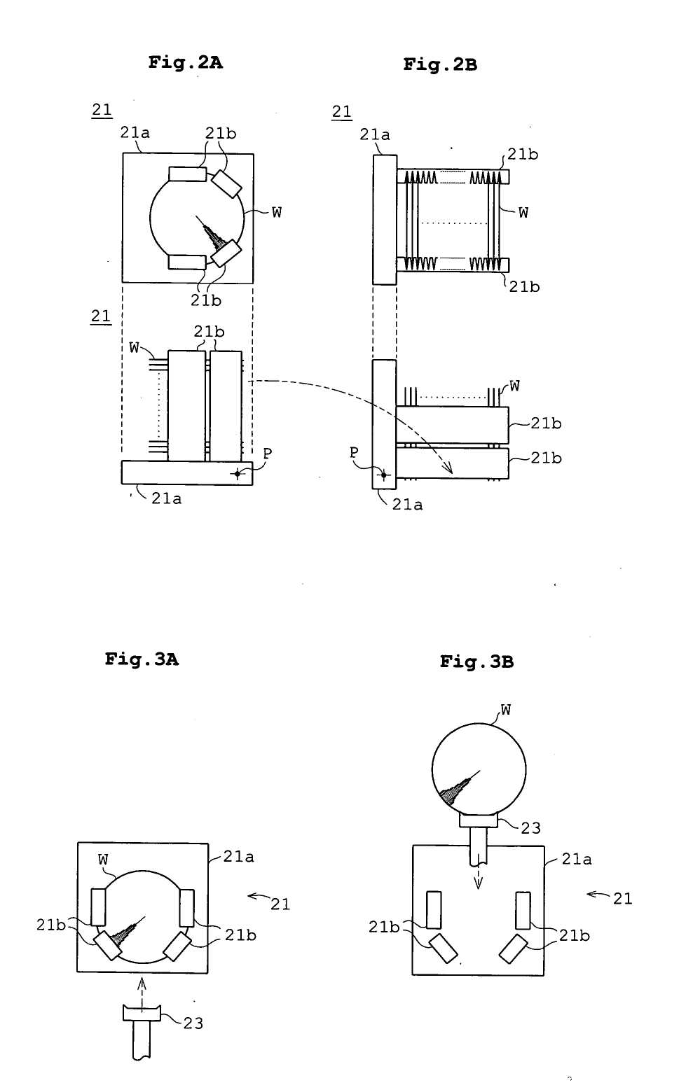

The first posture changer 21 will be described with reference to FIG. 2. FIG. 2A shows a plan view (above) and a side view (below) of the first posture changer 21 when a support base 21a is in horizontal posture. FIG. 2B shows a plan view (above) and a side view (below) of the first posture changer 21 when the support base 21a is in vertical posture. The first posture changer 21 has the support base 21a, and a plurality of (e.g. four) holders 21b arranged on the support base 21a for holding wafers W in multiple stages. The support base 21a is pivotable, by a drive mechanism not shown, about a horizontal axis P at a proximal end of the support base 21a. Thus, the support base 21a can take the horizontal posture shown in FIG. 2A, and the vertical posture shown in FIG. 2B. The holders 21b also are pivotable with the support base 21a, whereby the group of wafers W held by the holders 21b is switched between horizontal posture and vertical posture.

This first posture changer 21 is opposed to the transport path 11 to deliver and receive the wafers W to/from the transport block's transport mechanism 13 when the support base 21a is in horizontal posture.

The first pusher 23 is disposed beside the first posture changer 21. The first pusher 23 is driven by a drive mechanism, not shown, to make swiveling movement, vertical movement (in Z-direction in FIG. 1) and horizontal movement (in X-direction in FIG. 1). The first pusher 23 has an upper end thereof defining a plurality of grooves extending parallel to one another for contacting and holding wafers W en bloc.

FIG. 3 refers. FIGS. 3A and 3B are front views of the first pusher and first posture changer transferring wafers W therebetween. When a group of wafers W is transferred between the first pusher 23 and first posture changer 21, the support base 21a of the first posture changer 21 is in vertical posture as shown in FIGS. 3A and 3B. When the first pusher 23 receives the group of wafers W from the first posture changer 21, as shown in FIG. 3A, the first pusher 23 is located under the first posture changer 21. Then, as shown in FIG. 3B, the first pusher 23 moves upward to receive the group of wafers W en bloc from the first posture changer 21.

The first treating section's transport mechanism 25 is movable by a drive mechanism not shown, horizontally along the batch treating station 27 (in Y-direction in FIG. 1). The transport mechanism 25 has a pair of open/close clamps 25a extending horizontally for holding a group of wafers W en bloc.

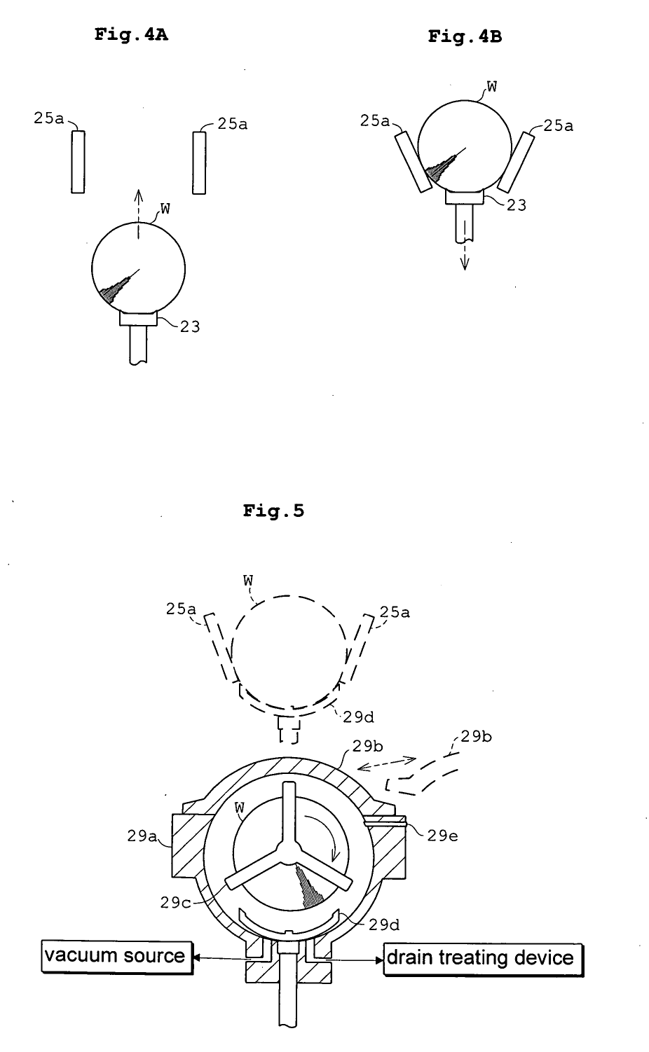

The transport mechanism 25 delivers and receives a group of wafers W to/from the first pusher 23, in a standby position not opposed to the batch treating station 27. As shown in FIGS. 4A and 4B, the group of wafers W is transferred between the first pusher 23 and transport mechanism 25 as the first pusher 23 moves vertically and the clamps 25a take open/close action.

The batch treating station 27 includes a drying unit 29, a cleaning unit 31 and a chemical treating unit 33. In this embodiment, the batch treating station 27 is described as having a function to remove resist from wafers W, i.e. to perform what is called resist stripping treatment. It should be noted that resist (organic substance) serves only as one example, and is not limitative.

FIG. 5 refers. The drying unit 29 is a spin drier having a drying container 29a defining a top opening for passing a group of wafers W therethrough, and a slide lid 29b slidable to open and close the top opening. The drying container 29a has, arranged therein, a spin holder 29c for rotatably holding a group of wafers W in vertical posture, and a drier's pusher 29d for vertically movably holding the group of wafers W. A nozzle 29e is formed in a side wall of the drying container 29a for supplying nitrogen gas and rinsing liquid. Further, the drying container 29a is in communication with a vacuum source for decompressing its interior, and a drain treating device for treating waste liquids drained from the drying container 29a.

The dryer's pusher 29d moves upward above the drying container 29a to deliver and receive a group of wafers W to/from the first treating section's transport mechanism 25 (in FIG. 5, dotted lines show the dryer's pusher 29d when delivering or receiving a group of wafers W to/from the transport mechanism 25). Further, inside the drying container 29a, the dryer's pusher 29d delivers and receives the group of wafers W to/from the spin holder 29c. Before drying treatment, the pusher 29d descends to the bottom of the drying container 29a to avoid interference with the spin holder 29c in a spin (in FIG. 5, solid lines show the dryer's pusher 29d in this state).

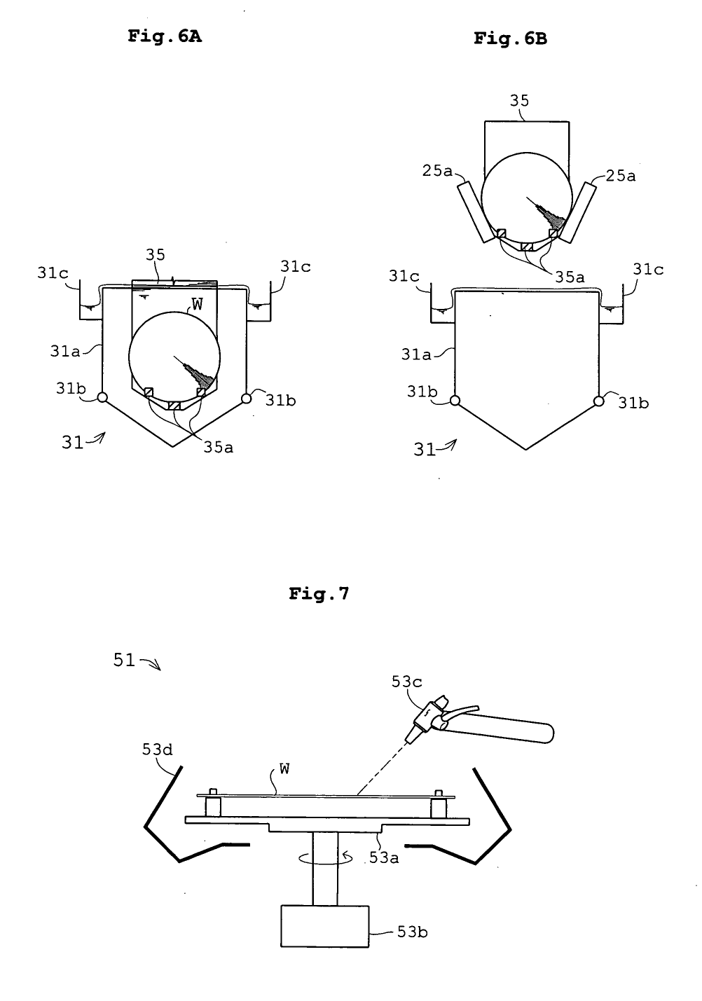

FIGS. 6A and 6B refer. The cleaning unit 31 includes a cleaning tank 31a for storing a cleaning solution, filling pipes 31b arranged in the bottom of the cleaning tank 31a for supplying the cleaning solution, and an outer tank 31c surrounding a top opening of the cleaning tank 31a for collecting overflows of the cleaning solution. Further, a lifter 35 is provided for immersing a group of wafers W en bloc in the cleaning tank 31a. The lifter 35 has a plurality of holding rods 35a extending horizontally for holding the group of wafers W en bloc in vertical posture. The lifter 35 is vertically and horizontally movable by a drive mechanism not shown.

The chemical treating unit 33 has a construction similar to the cleaning unit 31, and thus its illustration is omitted. The chemical treating unit 33 includes a chemical tank for storing a resist stripper which is a chemical solution, filling pipes arranged in the bottom of the chemical tank for supplying the resist stripper, and an outer tank for collecting the solution. The lifter 35 described above is used to immerse a group of wafers W en bloc in the chemical tank. That is, the lifter 35 is shared with the cleaning unit 31.

The lifter 35 moves upward above the cleaning tank 31a as shown in FIG. 6B to transfer a group of wafers W between the cleaning unit 31 and chemical treating unit 33, and the first treating section's transport mechanism 25.

Next, the second treating section 3b will be described. The second treating section 3b includes a second treating section's transport path 41 formed along the partition 7, a single-substrate treating station 43 arranged at one side of the transporting path 41 for treating wafers W in horizontal posture, and a second treating section's transport mechanism 45 for transporting wafers W one at a time between the single-substrate treating station 43 and the transport block's transport mechanism 13.

The second treating section's transport mechanism 45 is driven by a screw feed mechanism to move horizontally (in Y-direction in FIG. 1) along the second treating section's transport path 41. The transport mechanism 45 has, arranged in upper positions thereof, two U-shaped holding arms 45a1 and 45a2 (hereinafter collectively called the holding arms 45a where the two arms are not distinguished), each for holding one wafer W at a time. The two holding arms 45a also are driven by a drive mechanism not shown, to make swiveling movement, vertical movement, and horizontal extension and retraction. The transport mechanism 45 moves on the second treating section's transport path 41 to a position opposed to the transport block's transport path 11, and delivers and receives wafers W one at a time to/from the transport block's transport mechanism 13.

In this embodiment, the single-substrate treating station 43 has a plurality of (e.g. four) cleaning and drying units 51a, 51b, 51c and 51d (hereinafter collectively called the cleaning and drying units 51 where these units are not distinguished). Each cleaning and drying unit 51 is arranged to have its loading opening opposed to the second treating section's transport path 41.

FIG. 7 refers. Each cleaning and drying unit 51 includes a substrate holder 53a for holding a wafer W in horizontal posture, a motor 53b for spinning the substrate holder 53a, a nozzle 53c movably disposed above the wafer W for delivering a cleaning solution, and a cup 53d surrounding the wafer W for preventing scattering of the cleaning solution. A blow-off unit not shown is disposed above the wafer W for blowing a clean gas down to the surface of wafer W.

The second treating section's transport mechanism 45 is movable horizontally to a position opposed to each cleaning and drying unit 51. Then, the two holding arms 45a are moved appropriately to load a wafer W into each cleaning and drying unit 51.

The substrate treating apparatus having the above construction further includes a control unit 65 for controlling transport of a wafer W (or a group of wafers W) based on predetermined substrate treating conditions. The control unit 65 controls the transport block's transport mechanism 13, first posture changer 21, first pusher 23; first treating section's transport mechanism 25, and second treating section's transport mechanism 45 (the transport mechanisms above will be collectively called the “transport system” hereinafter). The control unit 65 includes a central processing unit (CPU) for performing various computations for substrate treatment, and a storage medium for storing the predetermined substrate treating conditions and a variety of information required for substrate treatment.

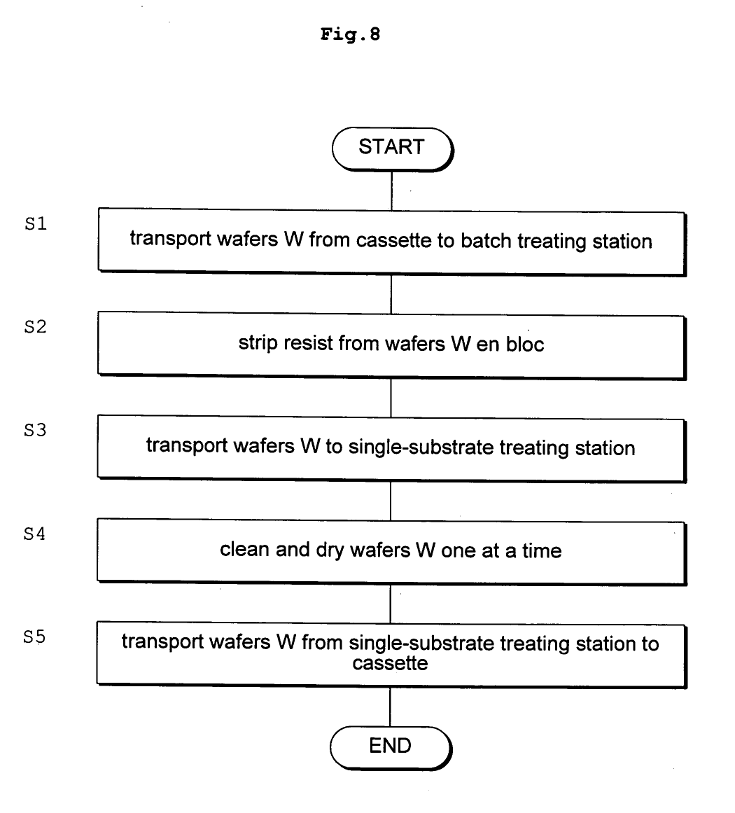

An example of operation of the substrate treating apparatus having the above construction will be described with reference to FIG. 8.

<Step S1> Transport Wafers W from Cassette C to the Batch Treating Station 27.

When a cassette C storing wafers W to be treated, in horizontal posture and in multiple stages, is placed on the cassette table 1, the transport block's transport mechanism 13 moves forward to the cassette C, and fetches the wafers W one at a time from the cassette C.

The transport mechanism 13 makes swiveling and other movements to be opposed to the first posture changer 21 in the first treating section 3a. At this time, the support base 21a of the first posture changer 21 is in horizontal posture. The transport mechanism 13 delivers the wafers W in horizontal posture one at a time to the first posture changer 21.

This operation is repeated to place 25 wafers W on the first posture changer 21. Then, the support base 21a of the first posture changer 21 pivots about the axis P into vertical posture. The 25 wafers W (which will be called the “group of wafers W” in the following description of operation) held by the holders 21b also are switched from horizontal posture to vertical posture.

The first pusher 23 moves up from below the first posture changer 21, and receives the group of wafers W en bloc from the first posture changer 21. Then, the first pusher 23 makes horizontal and swivel movements to move to the position for transfer with the first treating section's transport mechanism 25. At this time, the transport mechanism 25 stands by, with the clamps 25a open, above the first pusher 23.

When the first pusher 23 moves upward to the transfer position, the clamps 25a are closed to contact and support the group of wafers W en bloc. Then, the first pusher 23 lowers, whereby the transport mechanism 25 receives the group of wafers W en bloc.

The transport mechanism 25 holding the group of wafers W moves horizontally to a position above the chemical treating unit 33 where the lifter 35 stands by.

The lifter 35 moves up for its holding rods 35a to contact and support the group of wafers W. When the clamps 25a open subsequently, the lifter 35 descends, thereby receiving the group of wafers W en bloc from the transport mechanism 25.

The control unit 65 controls the above transport of wafers W by operating the transport system including the transport block's transport mechanism 13.

<Step S2> Perform Resist Stripping Treatment of the Group of Wafers W.

The lifter 35 holding the group of wafers W lowers into the chemical tank storing the resist stripper. The group of wafers W is immersed en bloc in the resist stripper for resist stripping treatment.

When the predetermined resist stripping treatment is completed, the lifter 35 moves up to withdraw the group of wafers W from the resist stripper. Then, the lifter 35 moves horizontally and lowers into the cleaning tank 31a to immerse the group of wafers W en bloc in the cleaning solution for cleaning treatment.

Upon completion of the cleaning treatment, the lifter 35 moves up to withdraw the group of wafers W en bloc from the cleaning solution. At this time, the first treating section's transport mechanism 25 stands by, with the clamps 25a open, above the cleaning unit 31.

When the lifter 35 moves up to the position of the transport mechanism 25, the clamps 25a close to contact and support the group of wafers W en bloc. The lifter 35 lowers again, whereby the transport mechanism 25 receives the group of wafers W en bloc.

The transport mechanism 25 moves horizontally to a position above the drying unit 29. The slide lid 29b of the drying unit 29 makes a sliding movement, and the dryer's pusher 29d moves up out of the drying container 29a. When the pusher 29d holds the group of wafers W en bloc, the clamps 25a of the transport mechanism 25 open. The pusher 29d lowers again to transfer the group of wafers W to the spin holder 29c. The pusher 29d retracts to the bottom of the drying container 29a, and the slide lid 29b slides to close the opening of the drying container 29a. Then, predetermined drying treatment is carried out while spinning the group of wafers W in vertical posture.

Upon completion of the drying treatment, the slide lid 29b is opened. The pusher 29d receives the group of wafers W en bloc from the spin holder 29c, and then moves up to transfer the group of wafers W to the first treating section's transport mechanism 25.

<Step S3> Transport Wafers W from the Batch Treating Station 27 to the Single-Substrate Treating Station 43.

The first treating section's transport mechanism 25 holds the group of wafers W and moves to the standby position. The group of wafers W is passed from the transport mechanism 25 to the first pusher 23, and from the first pusher 23 to the first posture changer 21. The first posture changer 21 switches the group of wafers W en bloc from vertical posture to horizontal posture. The transport block's transport mechanism 13 makes extending and retracting movement in the position opposed to the first posture changer 21, to take the wafers W one at a time from the first posture changer 21. The transport mechanism 13, with one of the holding arms 13a holding a wafer W, moves horizontally to the second treating section 3b, and passes the wafer W to the second treating section's transport mechanism 45. The transport block's transport mechanism 13 returns to the position opposed to the first posture changer 21, and repeats the same wafer transport operation.

After receiving each wafer W, the second treating section's transport mechanism 45 moves horizontally to a position opposed to a predetermined one of the cleaning and drying units 51, carries the wafer W into the cleaning and drying unit 51, and places the wafer W on the substrate holder 53a. Then, the transport mechanism 45 also returns to the position opposed to the transport block's transport mechanism 13 to repeat the same wafer transport operation, to load wafers W into the other cleaning and drying units 51.

The control unit 65 controls the transport of wafers W, as in step S3, by operating the transport system including the transport block's transport mechanism 13.

<Step S4> Perform Cleaning and Drying Treatment of Each Wafer W.

Predetermined cleaning treatment is performed by delivering the cleaning solution from the nozzle 53c to the wafer W while spinning the wafer W by the motor 53b. After the cleaning treatment is completed, drying treatment is performed by causing the clean gas to flow from the blow-off unit, not shown, down to the wafer W spinning at high speed. The wafer W scatters away moisture from its surface, and becomes dry. Since the single-substrate treating station 43 has four cleaning and drying units 51 in this embodiment, the cleaning and drying treatment can be carried out for four wafers W in parallel.

<Step S5> Transport Wafers W from the Single-Substrate Treating Station 43 to Cassette C.

When a series of cleaning and drying treatments is completed, a procedure reversed from that in the wafer loading time is carried out. That is, the second treating section's transport mechanism 45 unloads the wafers W from the cleaning and drying units 51, and passes the wafers W to the transport block's transport mechanism 13. The transport mechanism 13 loads the wafers W into the cassette C.

The control unit 65 controls the transport of wafers W, as in step S5, by operating the transport system including the transport block's transport mechanism 13.

The substrate treating apparatus in Embodiment 1, as described above, has the batch treating station 27 and single-substrate treating station 43, and the control unit 65 controls the transport system including the transport block's transport mechanism 13. The wafers W may be transported selectively to the batch treating station 27 and single-substrate treating station 43. Thus, the wafers W may be treated in the batch treating station 27 and/or in the single-substrate treating station 43.

The batch treating station 27 is arranged as a whole in the first treating section 3a, while the single-substrate treating station 43 is arranged as a whole in the second treating section 3b. The first treating section 3a and second treating section 3b are formed to face the transport block's transport mechanism 13. This arrangement assures improved efficiency of substrate transport while realizing a reduced footprint.

The partition 7 is disposed between the first treating section 3a and second treating section 3b to separate the atmosphere in the first treating section 3a and that in the second treating section 3b, and prevent the atmosphere of one treating section from diffusing to the region of the other. Thus, the wafers W may be treated properly in each of the first and second treating sections 3a and 3b.

In the course of transporting the wafers W between the transport block's transport mechanism 13 and batch treating station 27, the first posture changer 21 changes the posture of the group of wafers W en bloc. This provides a convenience in transporting the wafers W to the batch treating station 27 which treats the group of wafers W in vertical posture, from the cassette C or the single-substrate treating station 43 which stores or treats the wafers W in horizontal posture.

The first treating section's transport mechanism 25 is provided for loading and unloading a group of wafers W en bloc into/from the batch treating station 27. The transport mechanism 25 delivers and receives the group of wafers W en bloc to/from the first posture changers 21 through the first pusher 23. This arrangement further improves the efficiency of transport to and from the batch treating station 27.

Similarly, the second treating section's transport mechanism 45 is provided for loading and unloading wafers W one at a time into/from the single-substrate treating station 43. The transport mechanism 45 delivers and receives the wafers W one at a time to/from the transport block's transport mechanism 13. This arrangement further improves the efficiency of transport to and from the single-substrate treating station 43.

As described in steps S1, S3 and S5, the control unit 65 controls the transport system to fetch wafers W to be treated from the cassette C, load the wafers W into the batch treating station 27, transport the wafers W treated in the batch treating station 27 from the batch treating station 27 to the single-substrate treating station 43, and transport the wafers W treated in the single-substrate treating station 43 from the single-substrate treating station 43 to the cassette C. Thus, after the group of wafers W is stripped of resist in the batch treating station 27, the wafers W may be cleaned in the single-substrate treating station 43. In this way, resist may be removed from the wafers W, and the latter may be cleaned with high precision as finishing treatment.

The single-substrate treating station 43 includes a plurality of cleaning and drying units 51 for treating a plurality of wafers W in parallel. Thus, the single-substrate treating station 43 has an increased capacity to improve the throughput of the substrate treating apparatus.

The batch treating station 27 has a plurality of treating units having different functions (i.e. the drying unit 29, cleaning unit 31 and chemical treating unit 33). Thus, while one group of wafers W is receiving drying treatment, chemical treatment and cleaning treatment can be performed for other groups of wafers W. This further improves the throughput of the substrate treating apparatus.

### Embodiment 2

Embodiment 2 of this invention will be described next.

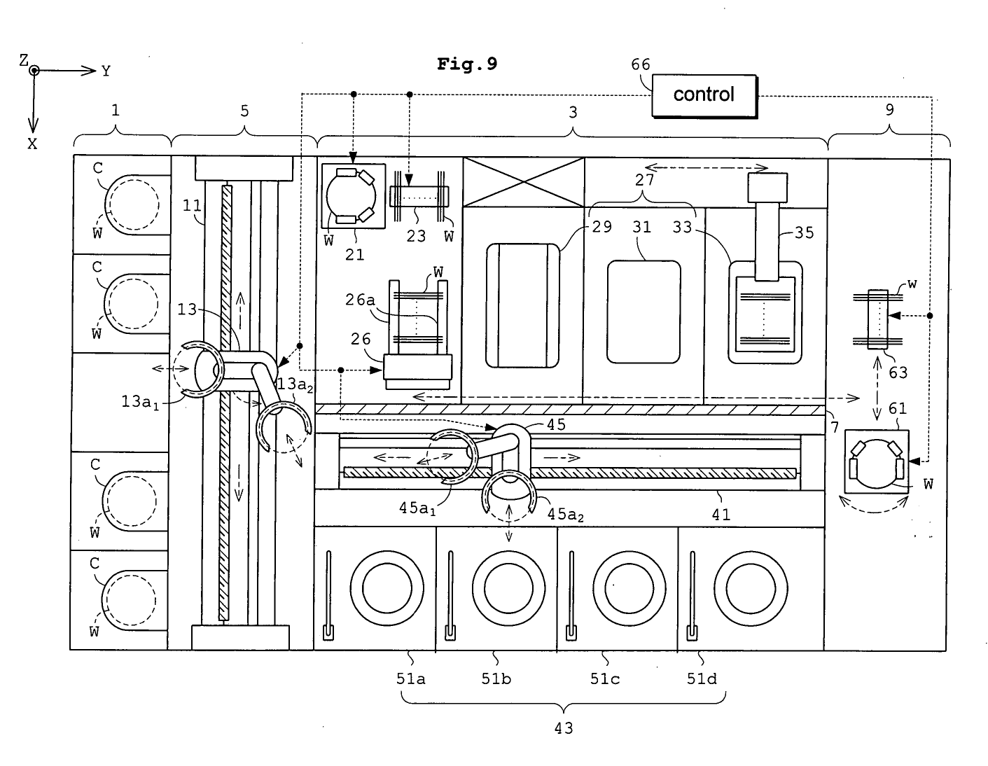

FIG. 9 is a plan view showing an outline of a substrate treating apparatus in Embodiment 2. Like reference numerals are used to identify like parts which are the same as in Embodiment 1 and will not be described again.

The substrate treating apparatus in Embodiment 2, broadly, includes a cassette table 1, a treating block 3, a transport block 5 and an auxiliary transport block 9. The auxiliary transport block 9 is disposed opposite the transport block 5 across the treating block 3.

The auxiliary transport block 9 has, arranged therein, a second posture changer 61 for delivering and receiving wafers W to/from the second treating section's transport mechanism 45, and changing the posture of a group of wafers W en bloc between horizontal posture and vertical posture, and a second pusher 63 for delivering and receiving the group of wafers W to/from a first treating section's transport mechanism 26 having a pair of clamps 26a.

The second posture changer 61, as does the first posture changer 21, has a support base and a plurality of holders (not shown). When the support base is in horizontal posture, the second posture changer 61 is swivelable about a vertical axis to be opposed to the second treating section's transport path 41 in order to deliver and receive wafers W to/from the second treating section's transport mechanism 45.

The second pusher 63 is disposed beside the second posture changer 61. The second pusher 63 is driven by a drive mechanism, not shown, to make horizontal movement (in X-direction in FIG. 9).

The first treating section's transport mechanism 26 in Embodiment 2 is horizontally movable (in Y-direction in FIG. 9) to the auxiliary transport block 9 to deliver and receive wafers W to/from the second pusher 63.

A control unit 66 in Embodiment 2 controls a transport system further including the second pusher 63, second pusher 63 and first treating section's transport mechanism 26.

An example of operation of the substrate treating apparatus in Embodiment 2 having the above construction will be described with reference to FIG. 8. The operation is the same as in Embodiment 1 except step S3 where the first treating section's transport mechanism 25 is now the first treating section's transport mechanism 26. Thus, only step S3 will be described hereinafter.

<Step S3> Transport Wafers W from the Batch Treating Station 27 to the Single-Substrate Treating Station 43.

The first treating section's transport mechanism 26 holds a group of wafers W and moves to the auxiliary transport block 9. The second pusher 63 moves up from below the transport mechanism 26 to contact and support the group of wafers W. Then, the clamps of the transport mechanism 26 open, and the second pusher 63 lowers again. As a result, the group of wafers W is transferred en bloc to the second pusher 63.

The second pusher 63 moves to a position above the second posture changer 61 standing by in vertical posture. Then, the second pusher 63 lowers to transfer the group of wafers W en bloc to the second posture changer 61.

The second posture changer 61 pivots to horizontal posture while holding the group of wafers W. Then, the second posture changer 61 swivels in a direction for facing the second treating section's transport path 41.

The second treating section's transport mechanism 45 makes extending and retracting movement in the position opposed to the second posture changer 61, to take wafers W one at a time from the second posture changer 61. After receiving each wafer W, the second treating section's transport mechanism 45, with one of the holding arms 45a holding the wafer W, moves horizontally to a position opposed to a predetermined one of the cleaning and drying units 51, carries the wafer W into the cleaning and drying unit 51, and places the wafer W on the substrate holder 53a. Then, the transport mechanism 45 returns to the position opposed to the second posture changer 61 to repeat the same wafer transport operation, to load wafers W into the other cleaning and drying units 51.

The control unit 66 controls the transport of wafers W, as in step S3, by operating the transport system including the second posture changer 61.

With the substrate treating apparatus in Embodiment 2, as described above, the second posture changer 61 changes the posture of the group of wafers W en bloc in the course of transporting the wafers W between the first treating section's transport mechanism 26 and second treating section's transport mechanism 45. This provides a convenience in transporting the wafers W between the batch treating station 27 which treats the wafers W in vertical posture, and the single-substrate treating station 43 which treats the wafers W in horizontal posture.

Since no interference occurs between the second posture changer 61 and transport block's transport mechanism 13, the control unit 66 can control these components independently of each other. The second posture changer 61 is disposed in the auxiliary transport block 9 facing the first treating section 3a and second treating section 3b, and can therefore transport wafers W with ease.

This invention is not limited to the foregoing embodiments, but may be modified as follows:

(1) In each embodiment described above, the batch treating station 27 performs resist stripping treatment while the single-substrate treating station 43 performs cleaning and drying treatment. Instead of being limited to such treatments, the treating stations 27 and 43 may be changed in design according to the particulars of treatment performed for wafers W.

(2) In each embodiment described above, the transport block's transport mechanism 13 has two holding arms 13a, each for holding one wafer W at a time. The transport mechanism 13 may have holding arms in multiple stages for transporting a group of wafers W en bloc to and from a cassette C.

(3) In each embodiment described above, each of the batch treating station 27 and single-substrate treating station 43 has a plurality of treating units. Instead, each station may include only one treating unit.

(4) In each embodiment described above, the control unit 65 or 66 performs controls based on wafer treating conditions, to treat the wafers W in the batch treating station 27, and thereafter to treat the wafers W in the single-substrate treating station 43. The order of treatments may be changed as appropriate according to the conditions for treating wafers W. For example, the wafers W may be transported first to the single-substrate treating station 43, and thereafter to the batch treating station 27. The wafers W may be transported to only one of the single-substrate treating station 43 and batch treating station 27.

(5) In each embodiment described above, the cassettes C are placed on the cassette table 1. Instead, pods may be used that can store wafers W in sealed condition.

(6) In each embodiment described above, a spin drier is used as the drying unit 29. Instead, wafers W may be dried by a device that pulls the wafers W up from deionized water stored in a treating tank, and supplies IPA (isopropyl alcohol) and nitrogen gas to the wafers W.

### Embodiment 3

Embodiment 3 of this invention will be described next with reference to the drawings.

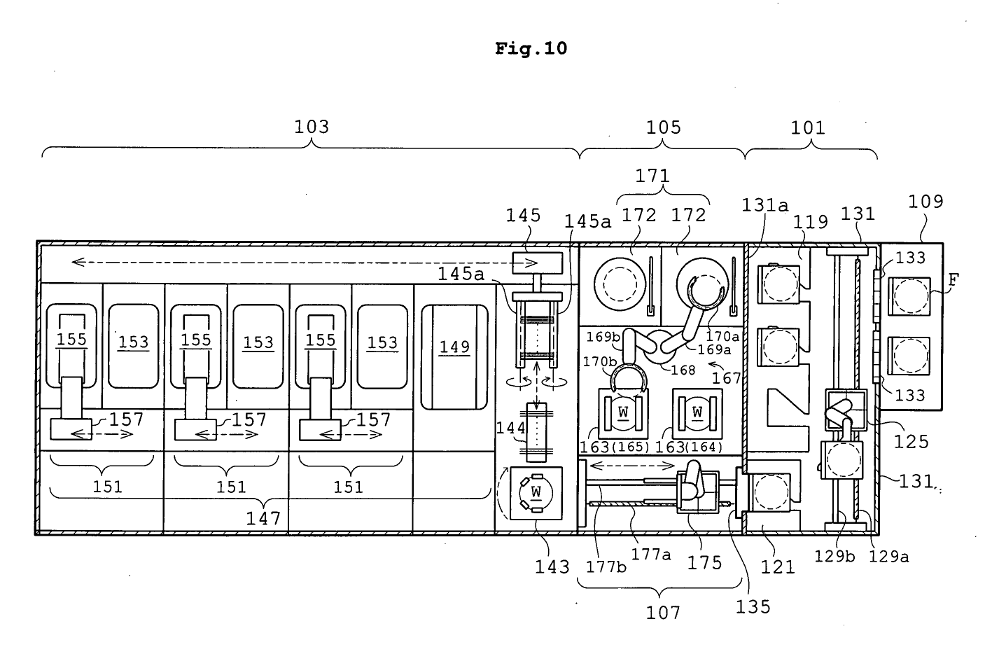

FIG. 10 is a plan view showing an outline of a substrate treating apparatus in Embodiment 3.

The substrate treating apparatus in Embodiment 3 is designed for cleaning, etching and drying wafers W (e.g. semiconductor wafers), and includes a storage block 101 for receiving sealed receptacles (known as FOUPs (front opening unified pods, and referred to hereinafter as “foups”) F, each for storing a plurality of wafers W, a first treating block 103 for treating a plurality of wafers W en bloc, a second treating block 105 for treating wafers W one at a time, and a transport block 107 for transporting wafers W between the storage block 101, first treating block 103 and second treating block 105. Each foup F corresponds to the receptacle in this invention. The storage block 101, first treating block 103, second treating block 105 and transport block 107 correspond to the storage block, first treating block, second treating block and transport block in this invention, respectively.

As shown in FIG. 10, the second treating block 105 is disposed between the first treating block 103 and storage block 101. The transport block 107 is disposed between the first treating block 103 and storage block 101, and is opposed to the second treating block 105. In other words, the second treating block 105 and transport block 107 are arranged along one side of the storage block 101. The second treating block 105 and transport block 107 are arranged also along one side of the first treating block 103. As a result, the transport block 107 is disposed in a position directly facing the storage block 101, first treating block 103 and second treating block 105.

The storage block 101 has a support table 109 disposed at the side thereof remote from the transport block 107 and second treating block 105 for receiving two foups F thereon. The support table 109 holds a foup F to be loaded into the storage block 101, and a foup F unloaded from the storage block 101.

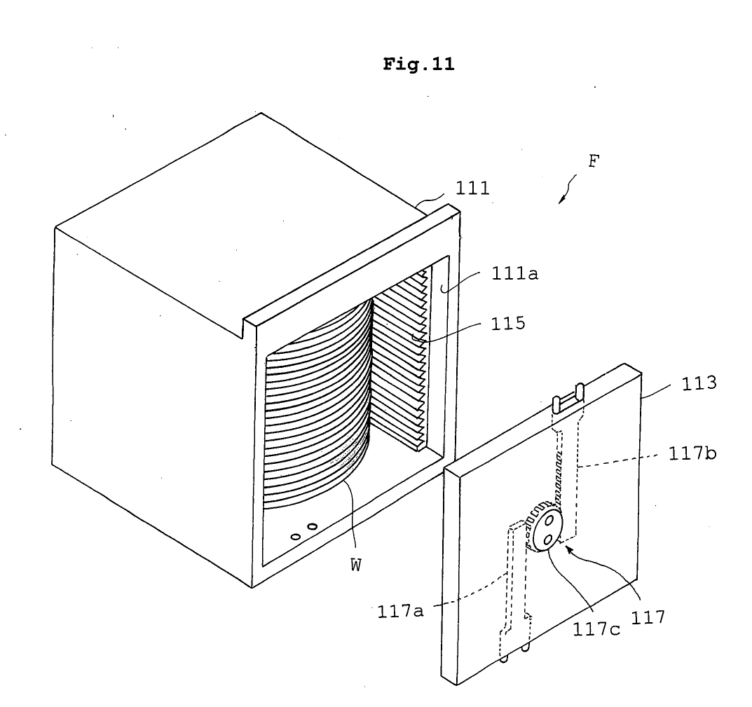

FIG. 11 refers. FIG. 11 is a perspective view of a foup F. The foup F has a case 111 with an opening formed in one side thereof, and a lid 113 removably fitted in the opening. The case 111 has horizontal grooves 115 formed in vertical arrangement in inner walls 111a thereof for engaging the edges of a plurality of (e.g. 25) wafers W to support the wafers W in horizontal posture. The lid 113 has a latch mechanism 117 for fixing the lid 113 to the case 111 when the lid 113 is fitted in the opening.

Specifically, the latch mechanism 117 includes two racks 117a and 117b each having a toothed proximal portion, and a pinion 117c meshed with the teeth of the racks 117a and 117b. The pinion 117c is rotatable to project the two racks 117a and 117b from the upper end and lower end of the lid 113, respectively. Consequently, the lid 113 is fixed to the case 111 to seal the interior of foup F.

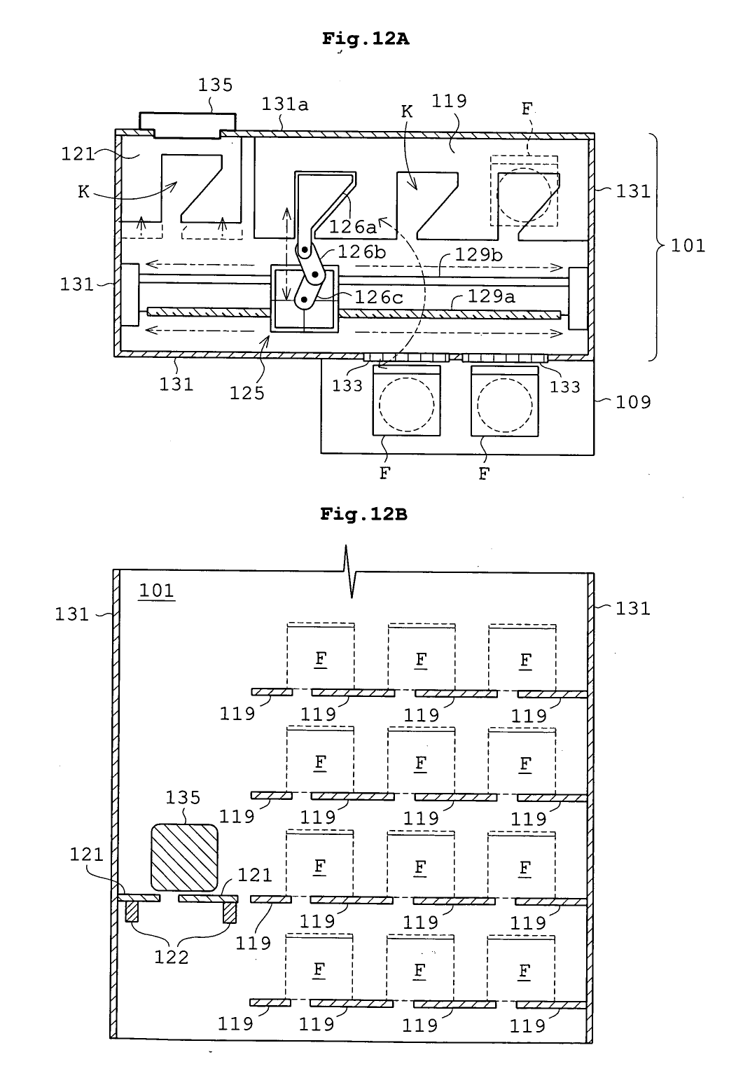

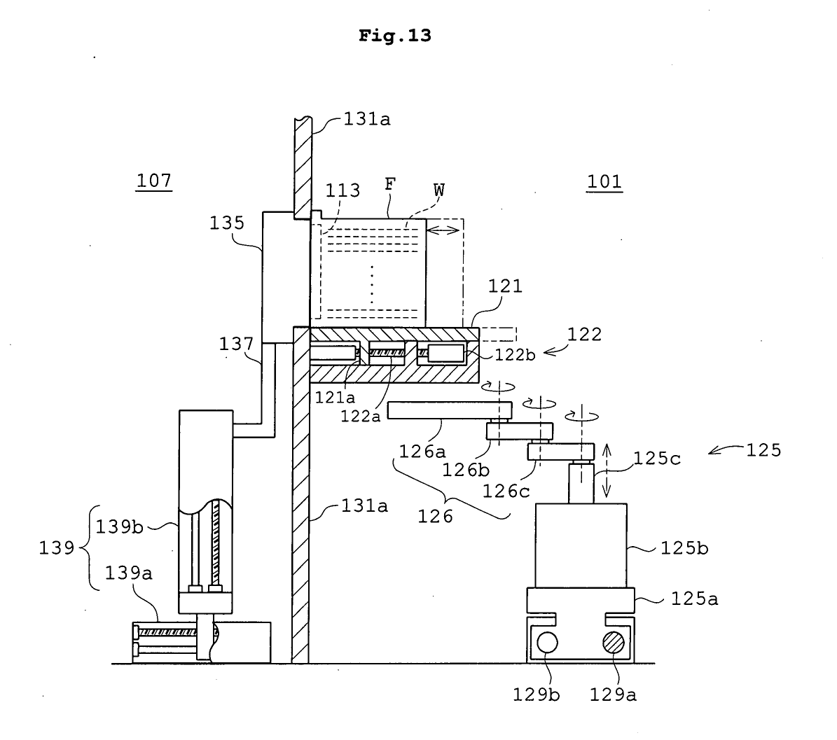

FIGS. 12 and 13 refer. FIG. 12A is a plan view of the storage block 101. FIG. 12B is a front view of an interior of the storage block 101. FIG. 13 is a side view showing portions of the storage block 101 and transport block 107. The storage block 101 for receiving foups F includes shelves 119 for holding foups F, a stage 121 for holding foups F accessed from the transport block 107, a foup transport mechanism 125 for transporting foups F between the shelves 119, stage 121 and support table 109. The storage block 101 has side walls 131 arranged circumferentially thereof to seal off the interior of the storage block 101 from outside atmosphere. In this specification, the side wall 131 that divides the storage block 101 from the transport block 107 and second treating block 105 in particular is called a partition wall 131a. The partition wall 131a corresponds to the partition in this invention.

As shown in FIG. 12B, the shelves 119 are arranged in four vertical stages on the partition wall 131a noted above. The shelves 119 in each stage have a length for holding three foups F in a row. Thus, 12 foups F can be placed on the shelves 119 as a whole. The shelves 119 have a cutout K, substantially triangular in plan view, formed in each position for holding a foup F. The shape of this cutout K corresponds to the shape, which also is substantially triangular in plan view, of a foup carrying arm 126a of the foup transport mechanism 125. The cutout K is slightly larger than the outer shape of the foup carrying arm 126a and smaller than the outer size of each foup F.

The stage 121 is attached to the partition wall 131a noted above for holding one foup F at a time. The stage 121 also defines a cutout K, substantially triangular in plan view, and the same size as one formed in each shelf 119. The stage 121 has a slide mechanism 122 disposed thereunder to be movable toward and away from the partition wall 131a.

This slide mechanism 122 is in the form of a screw feed mechanism for moving the stage 121, and includes a screw shaft 122a meshed with a projection 121a formed on an undersurface of the stage 121, and an electric motor 122b for rotating the screw shaft 122a backward and forward.

The foup transport mechanism 125 includes a horizontal driver 125a, a base 125b mounted on the horizontal driver 125a, a lift rod 125c vertically movable relative to the base 125b, and an articulated robot 126 attached to the upper end of the lift rod 125c. In the storage block 101, a screw shaft 129a and a guide rod 129b are laid to extend along the shelves 119 and stage 121 between opposite ends of the storage block 101. The horizontal driver 125a is movable horizontally along these screw shaft 129a and guide rod 129b. The articulated robot 126 has, in order from the distal end thereof, the foup carrying arm 126a, shaped substantially triangular in plan view, for holding foups F, a first link 126b for holding the foup carrying arm 126a to be swingable in a horizontal plane, and a second link 126c for holding the first link 126b to be swingable in a horizontal plane. The second link 126c is supported by the upper end of the lift rod 125c to be swingable in a horizontal plane.

The foup carrying arm 126a is extendible and retractable relative to the lift rod 125c by flexion of the first link 126b and second link 126c. The foup carrying arm 126a can freely make access to the shelves 119 or stage 121 as the lift rod 125c moves vertically relative to the base 125b, and the horizontal driver 125a moves horizontally along the screw shaft 129a. Further, the foup carrying arm 126a can freely make access to the support table 109 as the second link 126c swings relative to the lift rod 125c to swivel the foup carrying arm 126a about the lift rod 125c.

When the foup transport mechanism 125 places a foup F on a shelf 119, the foup carrying arm 126a holding the foup F is lowered from above the shelf 119. As the foup carrying arm 126a passes through the cutout K of the shelf 119, the foup F is passed from the foup carrying arm 126a on to the shelf 119. Conversely, when picking a foup F up from a shelf 119, the foup carrying arm 126a is raised from below the shelf 119. As the foup carrying arm 126a passes through the cutout K of the shelf 119, the foup F is received from the shelf 119.

When the foup transport mechanism 125 places a foup F on the stage 121 or takes a foup F from the stage 121, the foup carrying arm 126a may be moved as in the case of shelves 119 described above.

The side wall 131 disposed between the storage block 101 and support table 109 defines two openings in positions opposed to the foups F placed on the support table 109. These openings are formed slightly larger than the foups F to permit passage of the foups F. The openings are closed by two vertically movable shutter plates 133. These shutter plates 133 are vertically moved to open the openings only when the foup transport mechanism 125 makes access to the support table 109. As a result, the foup carrying arm 126a can transport foups F to and from the support table 109 through the openings. Normally, the shutter plates 133 close the openings to seal the interior of the storage block 101.

The partition wall 131a defines a single passage opening substantially the same size as foups F, in a position opposed to the foup F placed on the stage 121. This passage opening allows the transport block 107 to take wafers W out of the foup F, or deposit wafers W in the foup F. The passage opening is closed by a shutter member 135 when no foup F is present on the stage 121.

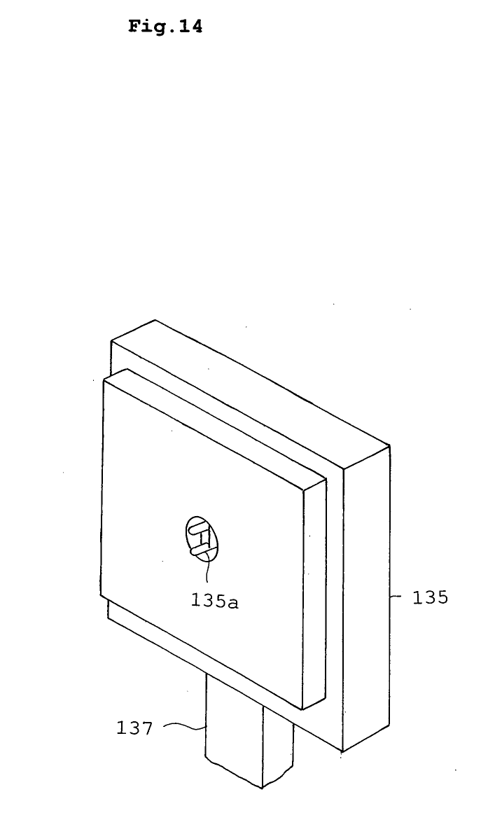

FIG. 14 refers. FIG. 14 is a perspective view of the shutter member 135. The shutter member 135 has a projection almost the same size as the passage opening to fit in and plug the passage opening of the partition wall 131a. The shutter member 135 has, disposed substantially centrally thereof, a connection member 135a corresponding to the latch mechanism 117 provided on the lid 113 of each receptacle. The connection member 135a is shaped to connect to the pinion 117c forming part of the latch mechanism 117, and turn the pinion 117c when connected thereto. In this way, the lid 113 is locked to the case 111, and is allowed to detach from the case 111. When the lid 113 is made detachable from the case 111, the shutter member 135 holds the lid 113 in this state. The shutter member 135 and connection member 135a correspond to the shutter member, and the attaching/detaching and holding mechanism in this invention, respectively.

The shutter member 135 is connected to a shutter actuator 139 through an L-shaped arm 137. The shutter actuator 139 includes a horizontal driver 139a for horizontally driving the arm 137, and a vertical driver 139b for vertically driving the arm 137. Screw feed mechanisms are used as both the horizontal driver 139a and vertical driver 139b. The shutter actuator 139 causes the shutter member 135 to move to and from the partition wall 131a and to move vertically.

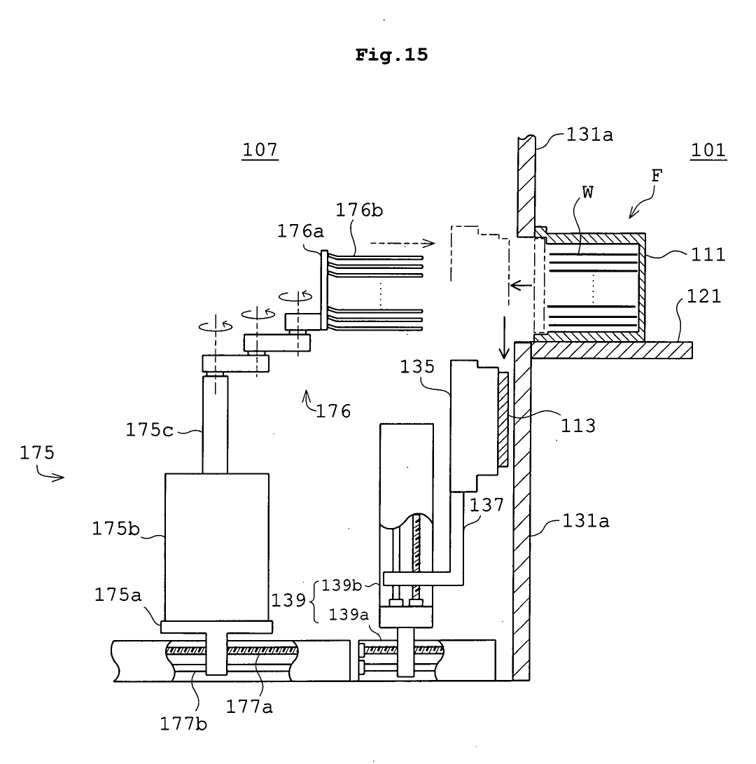

Operation of the shutter member 135 for opening and closing the passage opening will particularly be described with reference to FIG. 15. FIG. 15 is a side view illustrating the operation of the shutter member 135. When a foup F is placed on the stage 121, the foup F is advanced with the stage 121 to move the lid 113 of the foup F into contact with the shutter member 135 closing the passage opening. At this time, the connection member 135a operates the latch mechanism 117 on the lid 113 to render the lid 113 detachable from the case 111, and holds the lid 113. Then, the shutter actuator 139 lowers once and then retracts the shutter member 135 holding the lid 113. As a result, the lid 113 is removed from the foup F on the stage 121, opening the interior of the foup F toward the transport block 107 through the passage opening.

When closing the passage opening, the shutter member 135 holding the lid 113 is raised and advanced to fit into the passage opening. At this time, the lid 113 held by the shutter member 135 also is fit into the opening of the case 111 of the foup F placed on the stage 121. The connection member 135a operates the latch mechanism 117 to fix the lid 113 to the case 111. Thus, the passage opening is closed and the lid 113 attached to the foup F again.

Next, the first treating block 103 will be described. The first treating block 103 includes a substrate rack 143 for delivering and receiving a group of wafers W to/from the transport block 107, a pusher 144 for delivering and receiving a group of wafers W en bloc to/from the substrate rack 143, a first treating block's transport mechanism 145 for delivering and receiving a group of wafers W to/from the pusher 144, and a batch treating section 147 for delivering and receiving a group of wafers W to/from the transport mechanism 145, and treating the group of wafers W in vertical posture en bloc. The substrate rack 143 has a further function for changing the posture of a group of wafers W en bloc between horizontal posture and vertical posture. The transport mechanism 145 has a further function for changing intervals between the wafers W. Each component will be described hereinafter.

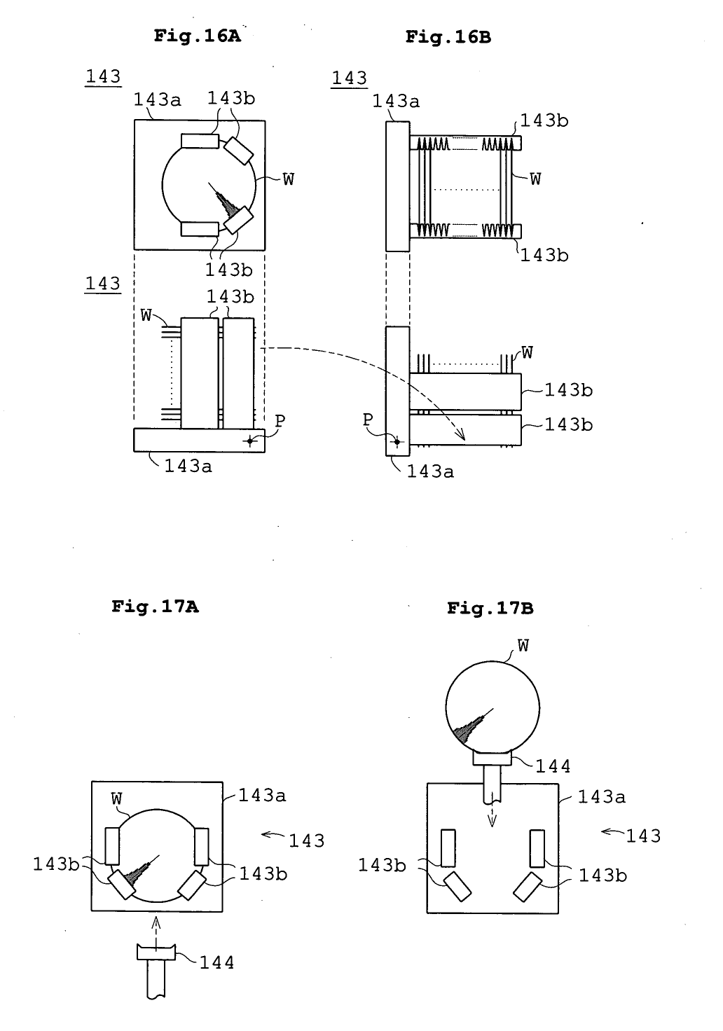

The substrate rack 143 is disposed in a position opposed to the transport block 107. FIG. 16 refers. FIG. 16A shows a plan view (above) and a side view (below) of the substrate rack 143 when a support base 143a is in horizontal posture. FIG. 16B shows a plan view (above) and a side view (below) of the substrate rack 143 when the support base 143a is in vertical posture. The substrate rack 143 includes the support base 143a, and a plurality of (e.g. four) holders 143b arranged on the support base 143a for holding a plurality of (e.g. 25) wafers W in multiple stages. The support base 143a is pivotable, by a drive mechanism not shown, about a horizontal axis P at a proximal end of the support base 143a. Thus, the support base 143a can take the horizontal posture shown in FIG. 16A, and the vertical posture shown in FIG. 16B. The holders 143b also are pivotable with the support base 143a, whereby the group of wafers W held by the holders 143b is switched between horizontal posture and vertical posture.

When the support base 143a is in horizontal posture, the substrate rack 143 is swivelable about a vertical axis in order to deliver and receive a group of wafers W to/from the pusher 144.

The pusher 144 is disposed beside the substrate rack 143. The pusher 144 is driven by a drive mechanism not shown to move vertically, and horizontally between the substrate rack 143 and first treating block's transport mechanism 145. The pusher 144 has an upper end thereof defining a plurality of grooves extending parallel to one another for contacting and holding a group of wafers W en bloc. In this embodiment, the pusher 144 can hold twice (e.g. 50) the number of wafers W placed on the substrate rack 143, as arranged at half the intervals between the wafers W placed on the substrate rack 143 (hereinafter called “half intervals” as appropriate).

FIG. 17 refers. FIGS. 17A and 17B are front views of the pusher 144 and substrate rack 143 transferring wafers W therebetween. When a group of wafers W is transferred between the pusher 144 and substrate rack 143, the support base 143a of the substrate rack 143 is in vertical posture as shown in FIG. 17A. The pusher 144 lies below the substrate rack 143. Then, as shown in FIG. 17B, the pusher 144 moves upward to thrust up the lower end of the group of wafers W placed on the substrate rack 143, thereby receiving the group of wafers W en bloc from the substrate rack 143.

The first treating block's transport mechanism 145 is movable by a drive mechanism not shown, horizontally along the batch treating section 147. The transport mechanism 145 has a pair of holding rods 145a extending horizontally for holding a group of wafers W en bloc. The transport mechanism 145 delivers and receives a group of wafers W to/from the pusher 23, in a standby position not opposed to the batch treating section 147.

The holding rods 145a have a substantially pentagonal section, with each surface defining predetermined grooves. The holding rods 145a per se are supported to be rotatable to change arrangements of the opposed grooves, thereby to provide at least three different substrate holding states. That is, a first substrate holding state Q1 is where the holding rods 145a do not act on a group of wafers W passing through between the holding rods 145a, but allow the group of wafers W just to pass through. A second substrate holding state Q2 is where the holding rods 145a stop and catch a group of wafers W arranged at the same intervals as on the substrate rack 143 (hereinafter called a “group of wafers W1” as appropriate) descending between the holding rods 145a. However, the holding rods 145a in this state do not act on a group of wafers W arranged at the half intervals (hereinafter called a “group of wafers W2” as appropriate), but allow this group of wafers W just to pass through. A third substrate holding state Q3 is where the holding rods 145a stop and catch a group of wafers W combining the group of wafers W1 and the group of wafers W2 (hereinafter called a “group of wafers W3” as appropriate) descending between the holding rods 145a.

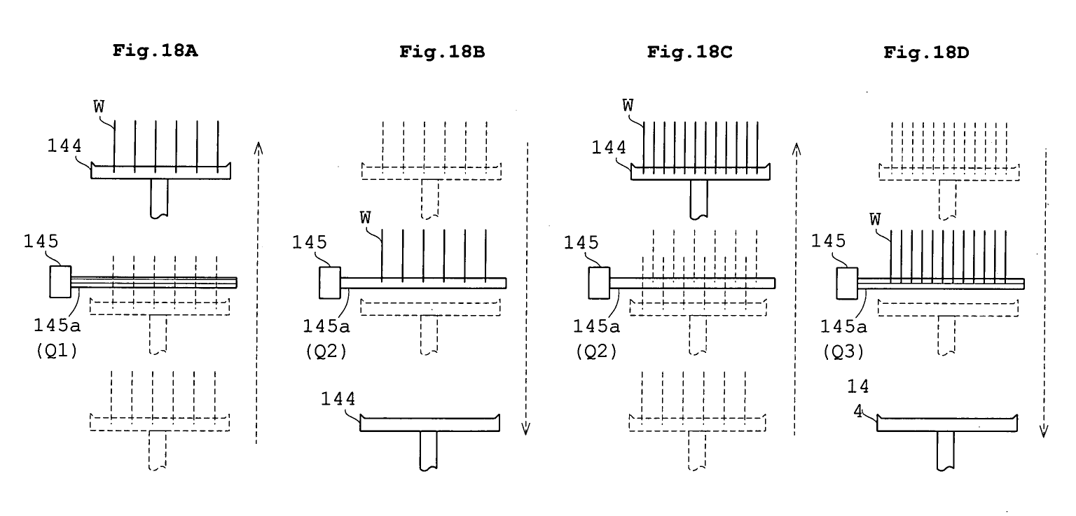

How groups of wafers W are transferred between the transport mechanism 145 having such holding rods 145a and the pusher 144 will particularly be described with reference to FIG. 18. FIGS. 18A, 18B, 18C and 18D are side views showing a transfer of groups of wafers W between the pusher 144 and first treating block's transport mechanism 145.

First, the holding rods 145a are in the first substrate holding state Q1, and the pusher 144 holding a group of wafers W is set to a predetermined position below the holding rods 145a. This group of wafers W is the same in number and in interval therebetween as on the substrate rack 143. The pusher 144 moves up, passing between the holding rods 145a. The group of wafers W held by the pusher 144 does not undergo action of the holding rods 145a at this time. The group of wafers W remains on the pusher 144 (see FIG. 18A).

Next, the holding rods 145a are switched to the second substrate holding state Q2, and the pusher 144 is lowered. When the pusher 144 passes between the holding rods 145a, the group of wafers W held by the pusher 144 is caught by the holding rods 145a (see FIG. 18B).

The pusher 144 receives a different group of wafers W en bloc from the substrate rack 143. This time the pusher 144 is set to a position shifted by half interval in a direction along the holding rods 145a from the predetermined position below the holding rods 145a. The different group of wafers W itself held by the pusher 144 is the same in number and in interval therebetween as on the substrate rack 143. When moving up between the holding rods 145a, the group of wafers W held by the pusher 144 rises so as to interpose between the group of wafers W held by the holding rod 145a. As the pusher 144 passes between the holding rods 145a, the pusher 144 pushes up the group of wafers W held by the holding rods 145a to receive this group of wafers W from the holding rods 145a. As a result, the pusher 144 now holds a group of wafers W as arranged at the half intervals, and corresponding to twice of the number of wafers W on the substrate rack 143 (see FIG. 18C).

Finally, the holding rods 145a are switched to the third substrate holding state Q3, and the pusher 144 is lowered. When the pusher 144 passes between the holding rods 145a, the group of wafers W held by the pusher 144 is caught by the holding rods 145a (see FIG. 18D).

The above operation achieves a transfer of the group of wafers W between the first treating block's transport mechanism 145 and the pusher 144, and a change in the intervals of the group of wafers W as well.

The batch treating section 147 in this embodiment includes one drying unit 149, and three cleaning units 151. Each cleaning unit 151 has a single deionized water cleaning device 153 and a single chemical cleaning device 155 arranged side by side. Such construction of the batch treating section 147 is shown only by way of example. The batch treating section 147 may be varied to perform a different function as appropriate, such as resist stripping treatment.

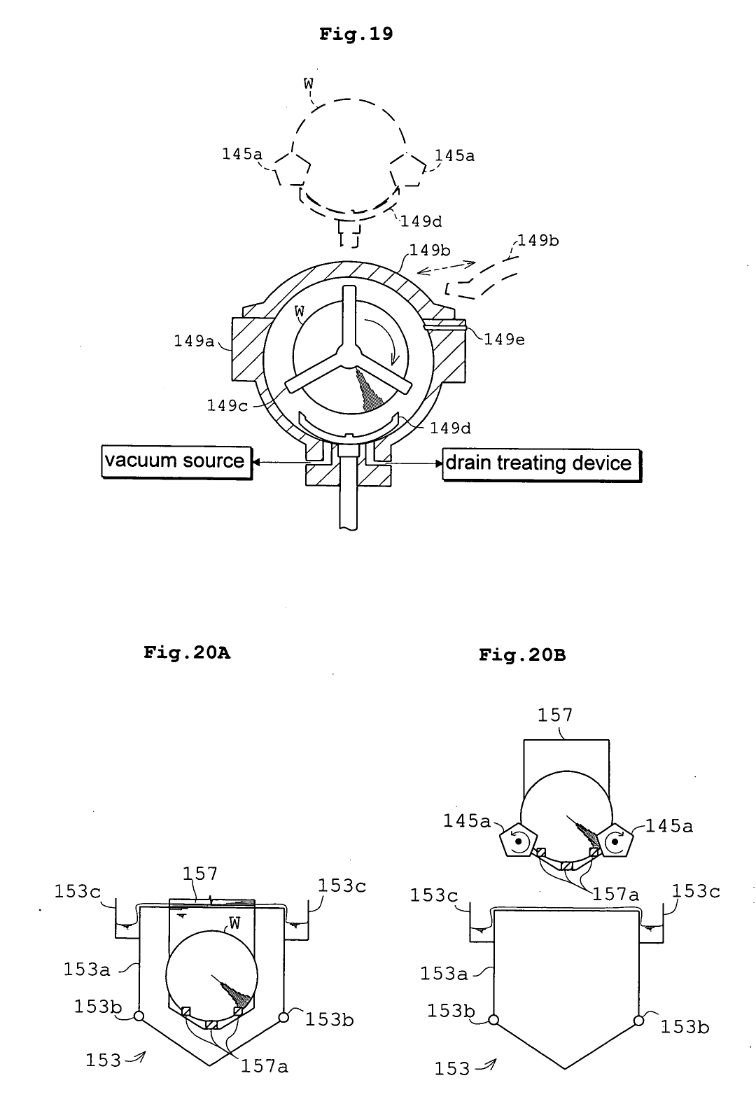

FIG. 19 refers. FIG. 19 is a schematic view showing an outline of the drying unit 149. The drying unit 149 is a spin drier having a drying container 149a defining a top opening for passing a group of wafers W therethrough, and a slide lid 149b slidable to open and close the top opening. The drying container 149a has, arranged therein, a spin holder 149c for rotatably holding a group of wafers W in vertical posture, and a drier's pusher 149d for vertically movably holding the group of wafers W. A nozzle 149e is formed in a side wall of the drying container 149a for supplying nitrogen gas and rinsing liquid. Further, the drying container 149a is in communication with a vacuum source for decompressing its interior, and a drain treating device for treating waste liquids drained from the drying container 149a.

The dryer's pusher 149d moves upward above the drying container 149a to deliver and receive a group of wafers W to/from the first treating block's transport mechanism 145 (in FIG. 19, dotted lines show the dryer's pusher 149d when delivering or receiving a group of wafers W to/from the transport mechanism 145). Further, inside the drying container 149a, the dryer's pusher 149d delivers and receives the group of wafers W to/from the spin holder 149c. Before drying treatment, the pusher 149d descends to the bottom of the drying container 149a to avoid interference with the spin holder 149c in a spin (in FIG. 19, solid lines show the dryer's pusher 149d in this state).

FIG. 20 refers. Each deionized water cleaning device 153 includes a cleaning tank 153a for storing a cleaning solution, filling pipes 153b arranged in the bottom of the cleaning tank 153a for supplying the cleaning solution, and an outer tank 153c surrounding a top opening of the cleaning tank 153a for collecting overflows of the cleaning solution.

Each chemical treating device 155 has a construction similar to the deionized water cleaning device 153, and thus its illustration is omitted. The chemical treating device 155 includes a chemical tank for storing a resist stripper which is a chemical solution, filling pipes arranged in the bottom of the chemical tank for supplying the chemical solution, and an outer tank for collecting the chemical solution. The chemical solution is selected, as appropriate, from APM (Ammonia-Hydrogen Peroxide Mixture), HPM (Hydrochloricacid-Hydrogen Peroxide Mixture), FPM (Hydrofluoricacid-Hydrogen Peroxide Mixture), DHF (Diluted Hydrofluoric acid) and O₃/DIW (ozone water), for example.

Each deionized water cleaning device 153 includes a lifter 157 movable between the deionized water cleaning device 153 and chemical treating device 155. The lifter 157 has a plurality of (e.g. three) holding rods 157a extending horizontally for contacting and supporting a group of wafers W en bloc. In this embodiment, the holding rods 157a support the group of wafers W as arranged at the half intervals, and corresponding to twice of the number of wafers W on the substrate rack 143

When transferring a group of wafers W between the lifter 157 and first treating block's transport mechanism 145, the lifter 157 moves upward between the holding rods 145a as shown in FIG. 20B, whereby the holding rods 157a push up and support the group of wafers W. Subsequently, the holding rods 145a are switched to the first substrate holding state Q1, and then the lifter 157 holding the group of wafers W lowers, to complete receipt of the group of wafers W by the lifter 157.

In this embodiment, the lifter 157 receives, above the chemical treating device 155, a group of wafers W to be treated in the batch treating section 147. The lifter 157 delivers, above the deionized water cleaning device 153, a group of wafers W treated in each cleaning unit 151 to the first treating block's transport mechanism 145.

Next, the second treating block 105 will be described. The second treating block 105 includes a single-substrate treating section 171 for cleaning and drying wafers W one at a time, second treating block's substrate racks (hereinafter called simply the “substrate racks”) 163 for holding a plurality of wafers W, and a second treating block's transport mechanism 167 for transporting wafers W one at a time between the single-substrate treating section 171 and substrate racks 163. Each component will be described hereinafter.

The substrate racks 163 are two racks of the same construction arranged side by side adjacent the transport block 107. These racks are distinguished according to the wafers W placed thereon. One of these racks is a pre-treatment substrate rack 164 for holding a group of wafers W before treatment in the single-substrate treating section 171. The other rack is a post-treatment substrate rack 165 for holding a group of wafers W after treatment in the single-substrate treating section 171.

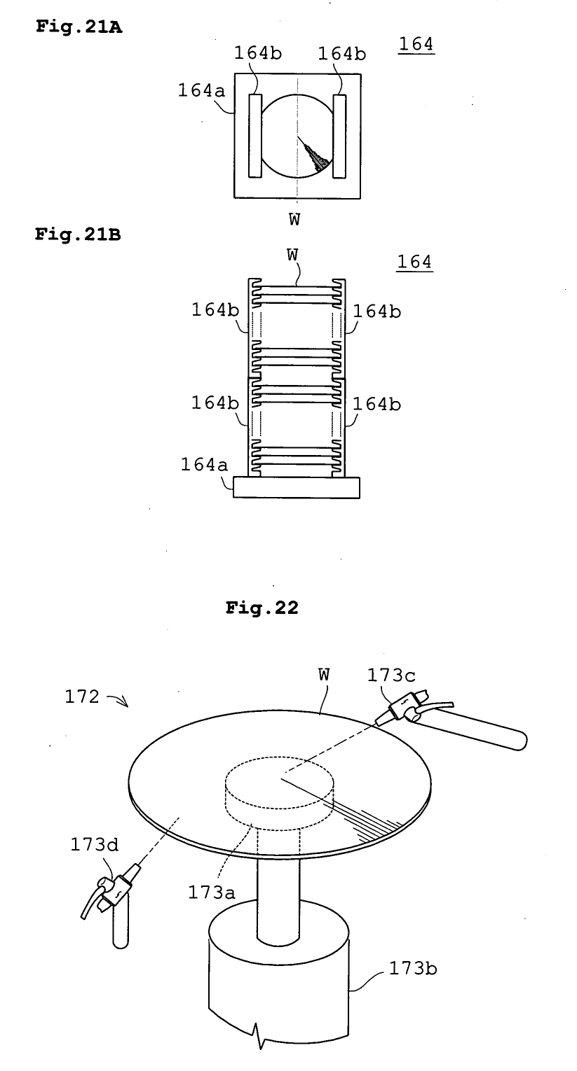

FIG. 21 refers. FIG. 21A is a plan view of the pre-treatment substrate rack 164. FIG. 21B is a front view of the pre-treatment substrate rack 164. The post-treatment substrate rack 165 has the same construction as the pre-treatment substrate rack 164, and its description is omitted. The pre-treatment substrate rack 164 has a base 164a, and two pairs of holders 164b stacked thereon one over the other in two stages. The holders 164b has a plurality of horizontal grooves formed in opposed inner surfaces thereof. By engaging opposite edges of each wafer W in the grooves, the holders 164b support a plurality of wafers W in horizontal posture. In this embodiment, each holder 164b defines 25 grooves, and thus the two pairs of holders 164b can hold 50 wafers W in two stages. This number is twice the number of wafers W (i.e. 25) a transport arm 176a of a transport block's transport mechanism 175 (to be described hereinafter) can hold en bloc. Thus, the pre-treatment substrate rack 164 can hold the number of wafers W corresponding to two capacity loads of the transport block's transport mechanism 175.

The second treating block's transport mechanism 167 has a vertically movable base 168, and two articulated robots 169a and 169b extending from the base 168 to be driven independently of each other. Each of the articulated robots 169a and 169b has a pair of upper and lower U-shaped holding arms 170a and 170b attached to a distal end thereof, each for holding one wafer W at a time. The holding arms 170a and 170b are extendible, retractable and swivelable independently of each other. Further, the holding arms 170a and 170b are vertically movable synchronously with each other.

In this embodiment, one of the holding arms 170a exclusively holds one wafer W at a time, before treatment is performed therefor in the single-substrate treating section 171. The other holding arm 170b exclusively holds one wafer W at a time, after treatment is performed therefor in the single-substrate treating section 171. In this way, the holding arms 170a and 170b have discrete functions for holding wafers W in the different states. That is, the holding arm 170a engages only in the transport from the pre-treatment substrate rack 164 to the single-substrate treating section 171, and the holding arm 170b only in the transport from the single-substrate treating section 171 to the post-treatment substrate rack 165.

The single-substrate treating section 171 includes four treating units 172 arranged in two rows and in two stages.

FIG. 22 refers. FIG. 22 is a perspective view showing an outline of each treating unit 172. The treating unit 172 includes a substrate holder 173a for holding a wafer W in horizontal posture, a motor 173b for spinning the substrate holder 173a, a nozzle 173c movably disposed above the wafer W for delivering a cleaning solution to the front surface of wafer W, and a back rinse nozzle 173d for delivering the cleaning solution to the back surface of wafer W. In this embodiment, the back rinse nozzle 173d is disposed in a position opposed to edges of the back surface of wafer W to clean edge regions, in particular, of the back surface of wafer W. The wafer W is surrounded by a cup (not shown) for preventing scattering of the cleaning solution. A blow-off unit not shown is disposed above the wafer W for blowing a clean gas down to the surface of wafer W.

FIGS. 10 and 15 refer again. The transport block 107 has a transport block's transport mechanism 175 disposed therein. This transport mechanism 175 includes a horizontal driver 175a, a base 175b mounted on the horizontal driver 175a, a lift rod 175c vertically movable relative to the base 175b, and an articulated robot 176 attached to the upper end of the lift rod 175c. A screw shaft 177a and a guide rod 177b defining a moving path of the horizontal driver 175a are laid to extend from the storage block 101 to the first treating block 103. The articulated robot 176 has a transport arm 176a at a distal end thereof. The transport arm 176a includes 25 hands 176b arranged vertically and each having two holding pieces extending horizontally in parallel for holding a plurality of wafers W in horizontal posture. The transport arm 176a is extendible, retractable and swivelable relative to the lift rod 175c, and vertically movable relative to the base 175b.

The transport block's transport mechanism 175 advances the transport arm 176a into the passage opening after the lid 113 of the foup F placed on the stage 121 is removed by the shutter member 135. Then, a group of wafers W is carried en bloc into or out of the foup F. The transport block's transport mechanism 175 acts also to load and unload a group of wafers W en bloc on/from the substrate rack 143 of the first treating block 103, and the pre-treatment and post-treatment substrate racks 164 and 165 of the second treating block 105.

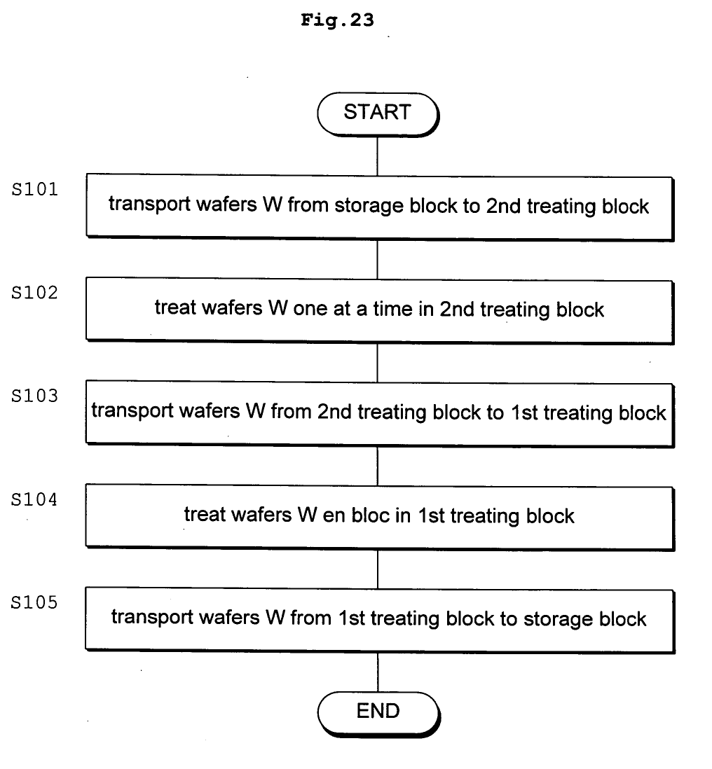

An example of operation of the substrate treating apparatus having the above construction will be described with reference to FIG. 23.

<Step S101> Transport Wafers W from the Storage Block to the Second Treating Block.

The foup transport mechanism 125 transports a foup F storing a group of wafers W to be treated, from a shelf 119 to the stage 121. The foup F placed on the stage 121, after a sliding movement, has the lid 113 removed by the shutter member 135. The transport block's transport mechanism 175 fetches the group of wafers W en bloc from the foup F through the passage opening, and transfers this group of wafers W en bloc to the pre-treatment substrate rack 164.

After the transport block's transport mechanism 175 fetches the group of wafers W from the foup F, the shutter member 135 moves forward and ascends to fit into the passage opening, and attach and fix the lid 113 to the case 111 of the foup F.

<Step S102> Treat Wafers W one at a Time in the Second Treating Block.

The holding arm 170a of the second treating block's transport mechanism 167 transports one wafer W from the pre-treatment substrate rack 164 to one of the treating units 172.

The substrate holder 173a in the treating unit 172 holds, in horizontal posture, the wafer W brought into the treating unit 172. Then, the motor 173b drives to spin the substrate holder 173a. The cleaning solution is delivered from the nozzle 173c to clean the front surface of the wafer W, and from the back rinse nozzle 173d to clean edge regions of the back surface of the wafer W. When predetermined cleaning treatment is completed, drying treatment is performed by causing the clean gas to flow from the blow-off unit, not shown, down to the wafer W spinning at high speed, to scatter away moisture from the surfaces of wafer W and dry the wafer W.

When predetermined treatment is completed for the one wafer W in the treating unit 172, the holding arm 170b of the second treating block's transport mechanism 167 transports the wafer W from the treating unit 172 to the post-treatment substrate rack 165.

<Step S103> Transport Wafers W from the Second Treating Block to the First Treating Block.

The transport block's transport mechanism 175 fetches the group of wafers W en bloc from the post-treatment substrate rack 165, and transfers the group of wafers W en bloc to the substrate rack 143 of the first treating block 103.

<Step S104> Treat Wafers W en Bloc in the First Treating Block.

First, the substrate rack 143 swivels about the vertical axis. Subsequently, the support base 143a pivots about the horizontal axis P at the proximal end thereof to take the vertical posture. With this movement, the 25 wafers W held by the holders 143b also pivot from horizontal posture to vertical posture. (In the following description of operation, the wafers are called the “group of wafers W”.)

The pusher 144 moves upward to push up the lower end of the group of wafers W placed on the substrate rack 143, thereby receiving the group of wafers W en bloc from the substrate rack 143. The pusher 144 moves up between the holders 143b of the substrate rack 143 to receive the group of wafers W en bloc from the substrate rack 143. The pusher 144 moves to a predetermined position below the first treating block's transport mechanism 145 in a standby position.

The pusher 144 vertically moves between the holding rods 145a of the first treating block's transport mechanism 145, whereby the group of wafers W is transferred from the pusher 144 to the transport mechanism 145.

Further, the pusher 144 receives a different group of wafers W from the substrate rack 143 again. The pusher 144 transfers this different group of wafers W to the transport mechanism 145 as interposed between the group of wafers W already held by the transport mechanism 145. As a result, the intervals between the wafers W held by the transport mechanism 145 are changed to half the intervals between the wafers W placed on the substrate rack 143.

The transport mechanism 145 holding the group of wafers W moves horizontally to a position above one of the chemical cleaning devices 155 where the lifter 157 stands by.

The lifter 157 moves up, and the holding rods 157a thereof contact and support the group of wafers W. Then, the lifter 157 lowers between the holding rods 145a switched to the first substrate holding state Q1, and receives the group of wafers W en bloc from the transport mechanism 145.

The lifter 157 holding the group of wafers W lowers into the chemical tank storing the chemical solution of the chemical cleaning device 155. The group of wafers W is immersed en bloc in the chemical solution. Thus, chemical cleaning treatment is performed on the group of wafers W en bloc.

When the predetermined chemical cleaning treatment is completed, the lifter 157 moves up, pulling the group of wafers W up from the chemical tank. Then, the lifter 157 moves horizontally and lowers to the deionized water tank 153a, to immerse the group of wafers W en bloc in the deionized water tank 153a. Thus, deionized water cleaning treatment is performed on the group of wafers W en bloc.

When the cleaning treatment is completed, the lifter 157 moves up, pulling the group of wafers W up from the deionized water tank 153a. The lifter 157 moves straight up to the position above the deionized water cleaning device 153 to transfer the group of wafers W to the first treating block's transport mechanism 145.

The transport mechanism 145 moves horizontally to a position above the drying unit 149. The slide lid 149b of the drying unit 149 slides, and the dryer's pusher 149d moves up from inside the drying container 149a. The pusher 149d holds the group of wafers W en bloc, and lowers again to transfer the group of wafers W to the spin holder 149c. The pusher 149d retreats to the bottom of the drying container 149a. The slide lid 149b slides to close the opening of the drying container 149a. Then, predetermined drying treatment is carried out while spinning the group of wafers W in vertical posture.

When the drying treatment is completed, the slide lid 149b is opened. The pusher 149d receives the group of wafers W en bloc from the spin holder 149c, and moves up to transfer the group of wafers W to the first treating block's transport mechanism 145.

The completion of the drying treatment marks an end of the batch treatment of the group of wafers W in the first treating block 103. Then, the group of wafers W is transferred in the reverse order, from the first treating block's transport mechanism 145 to the pusher 144, and from the pusher 144 to the substrate rack 143. When the group of wafers W is transferred from the first treating block's transport mechanism 145 to the pusher 144, the intervals between the wafers W are changed from the half intervals to the intervals between the wafers W placed on the substrate rack 143.

<Step S105> Transport the Wafer W from the First Treating Block to the Storage Block.

The transport block's transport mechanism 175 receives the group of wafers W en bloc from the substrate rack 143 of the first treating block 103, and moves horizontally to the storage block 101. At this time, an empty foup F has been placed beforehand on the stage 121, and the lid 113 of the foup F has been removed by the shutter member 135. The transport mechanism 175 loads the group of wafers W en bloc into the foup F through the passage opening of the partition wall 131a.

Subsequently, the shutter member 135 moves up and forward to fit into in the passage opening, and attach and fix the lid 113 to the case 111 of the foup F.

The substrate treating apparatus in Embodiment 3, as described above, has the first treating block 103 and second treating block 105, and the transport block 107 can transport wafers W selectively to the first treating block 103 and second treating block 105. Thus, the wafers W may be treated in the batch treating mode for treating a plurality of wafers W en block and in the single-substrate treating mode for treating wafers W one at a time.

In this embodiment, both the first treating block 103 and second treating block 105 are constructed for performing cleaning treatment of wafers W. This provides an improved quality (result) of treatment while securing an excellent throughput of wafer cleaning treatment.

Each treating unit 172 in the second treating block 105 that treats wafers W one at a time has the back rinse nozzle 173d (FIG. 22). Thus, part of each wafer W (e.g. edge regions of the back surface of wafer W) can be treated. The second treating block 105, while cleaning the entire wafer W, can apply only a required cleaning treatment to required parts. This improves the throughput of the second treating block 105.

The transport block 107 is disposed in the position surrounded by the storage block 101, first treating block 103 and second treating block 105. This arrangement shortens its transport path to assure high transporting efficiency.

The transport block 107 includes the transport arm 176a having hands 176b arranged in multiple stages. Thus, the transport arm 176a can transport a plurality of wafers W en bloc, to further increase transporting efficiency.

The first treating block 103 and second treating block 105 include the substrate rack 143 and substrate racks 163 for holding a plurality of wafers W en bloc, respectively. Thus, the two treating blocks 103 and 105 can deliver and receive wafers W as they are to/from the transport arm 176a noted above (i.e. without requiring a posture change of the wafers W). The transport block 107 can transport the wafers W smoothly to the first treating block 103 and second treating block 105.

The second treating block 105, in particular, has the pre-treatment substrate rack 164 and post-treatment substrate rack 165 provided separately. Each rack can hold the number of wafers W corresponding to twice the number of wafers W held by the transport arm 176a. Thus, the transport block's transport mechanism 175 can transport a group of wafers W to and from the second treating block 105 continuously, to promote transporting efficiency further. This construction can also avoid contamination between wafers W, such as treated wafers W being contaminated by wafers W to be treated.

The single-substrate treating section 171 includes four treating units 172 to have an increased treating capacity. Since these treating units 172 are arranged in two rows and in two stages, an increase in footprint is avoided.

The footprint is reduced since the first treating block 103, second treating block 105 and storage block 7 are arranged in order along a long side of the substrate treating apparatus. Where the first treating block 103 and second treating block 105 are arranged at one side of the storage block 7, a dead space will be formed according to a difference between the areas occupied by the first treating block 103 and second treating block 105, making it difficult to reduce the footprint.

Sealed type foups F are used as receptacles for storing wafers W, whereby there is no possibility of the wafers W being contaminated by the atmosphere around the foups F. Each foup F is sealed with increased reliability by the latch mechanism 117 provided for the lid 113.

The storage block 101 provided for receiving foups F facilitates control of the foups F. For example, a plurality of foups F stored in the storage block 101 may easily be controlled for first-in first-out. Further, the foups F are placed on and removed from the shelves 119 and stage 121 by the foup carrying arm 126a of the foup transport mechanism 125 passing through the cutouts K formed in the shelves 119 and stage 121. This feature allows the storage block 101 to have a compact construction.

The side walls 131 formed around the storage block 101 can keep the atmosphere in the storage block 101 clean. On the other hand, the partition wall 131a prevents the atmosphere of the storage block 101 flowing to the first treating block 103, second treating block 105 and transport block 107. Thus, the wafers W taken out of the foups F are free from contamination.

The passage opening formed in the partition wall 131a separating the storage block 101 and transport block 107 is closed by the shutter member 135 to prevent the atmosphere of the storage block 101 flowing to the transport block 107. Further, the lid 113 of each foup F is attached and detached by the shutter member 135 which opens and closes the passage opening of the partition wall 131a. Thus, the interior of each foup F is opened only to the transport block 107. The wafers W stored in the foup F or taken out of or loaded into the foup F are therefore free from contamination.

The two openings formed in the side wall 131 separating the storage block 101 and support table 109 are closed by the two shutter plates 133, to keep the atmosphere in the storage block 101 clean.

In the first treating block 103, the substrate rack 143 has a function to change a group of wafers W en block between horizontal posture and vertical posture. Consequently, a group of wafers W received in horizontal posture from the transport block 107 can be delivered to the batch treating section 147 for treatment in vertical posture.

When a group of wafers W is transferred between the pusher 144 and first treating block's transport mechanism 145, the intervals between the wafers W are changed. Since the number of wafers W to be treated en bloc in the batch treating section 147 can be increased, the first treating block 103 has increased throughput.

### Embodiment 4

Embodiment 4 of this invention will be described next.

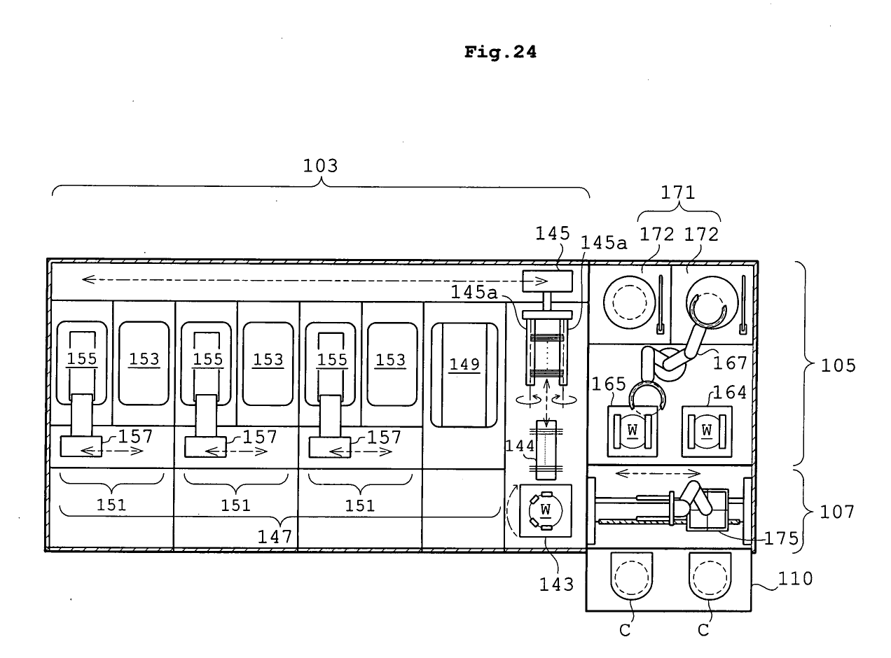

FIG. 24 is a plan view showing an outline of a substrate treating apparatus in Embodiment 4. Like reference numerals are used to identify like parts which are the same as in Embodiment 3 and will not be described again.

The substrate treating apparatus in Embodiment 4 includes a support table 110 for supporting receptacles (i.e. what is known as open type cassettes, hereinafter called simply “cassettes”) C each for storing a plurality of wafers W, a first treating block 103 for treating a plurality of wafers W en bloc, a second treating block 105 for treating wafers W one at a time, and a transport block 107 for transporting wafers W between the storage block 101, first treating block 103 and second treating block 105. Each cassette C and the support table 110 correspond to the receptacle and the receptacle table in this invention, respectively.

As shown in FIG. 24, the second treating block 105 and transport block 107 are arranged along one side of the first treating block 103. The support table 110 is disposed at the side of the transport block 107 remote from the second treating block 105 As a result, the transport block 107 is disposed in a position directly facing the first treating block 103, second treating block 105 and support table 110. No atmosphere shut-off partition wall or the like is provided between the transport block 107 and support table 110.

The support table 110 holds two cassettes C as arranged along the transport block 107. Each cassette C stores a plurality of wafers W in horizontal posture and in multiple stages. The wafers W stored in the cassette C are exposed to the atmosphere outside the cassette C.

The transport block 107 transports wafers W to and from the cassettes C placed on the support table 110. More particularly, when a transport block's transport mechanism 175 moves horizontally to a position opposed to a cassette C placed on the support table 110, a transport arm 176a of the transport mechanism 175 advances to the cassette C. The transport arm 176a loads or unloads a plurality of wafers W en bloc into/from the cassette C.

According to Embodiment 4, the open type cassettes C are applicable also to the substrate treating apparatus having the first treating block 103 and second treating block 105. The substrate treating apparatus may be simplified by omitting a construction for accommodating the cassettes C (i.e. what corresponds to the storage block 101 in Embodiment 3).

This invention is not limited to the foregoing embodiments, but may be modified as follows:

(1) In Embodiments 3 and 4 described above, the batch treating section 147 and single-substrate treating section 171 are constructed to perform cleaning and drying treatment, but this is not limitative. For example, the batch treating block 147 may be constructed to perform resist stripping treatment. The single-substrate treating block 171 may be constructed to perform etching and developing treatment.

In the described example of operation, the wafers W are first transported to the second treating block 105, and thereafter to the first treating block 103. This order is not limitative. An order may be selected freely according to the treatments performed for the wafers W.

(2) In Embodiments 3 and 4 described above, each of the batch treating section 147 and single-substrate treating section 171 has a plurality of treating units. The numbers of treating units are given only by way of example, and may be varied as appropriate. The numbers of wafers W and other numerical values given in the description may also be varied as appropriate.

(3) In Embodiment 3 described above, the transport block 107 is arranged to transport wafers W to and from a single foup F placed on the stage 121 in the storage block 101. Instead, a plurality of stages 121 may be provided, for the transport block 107 to transport wafers W to and from a plurality of foups F. This will improve the efficiency of transport to and from the storage block 101.

(4) In Embodiments 3 and 4 described above, a spin drier is used as the drying unit 149. Instead, wafers W may be dried by a device that pulls the wafers W up from deionized water while supplying IPA (isopropyl alcohol) to the wafers W.

### Embodiment 5

Embodiment 5 of this invention will be described next.

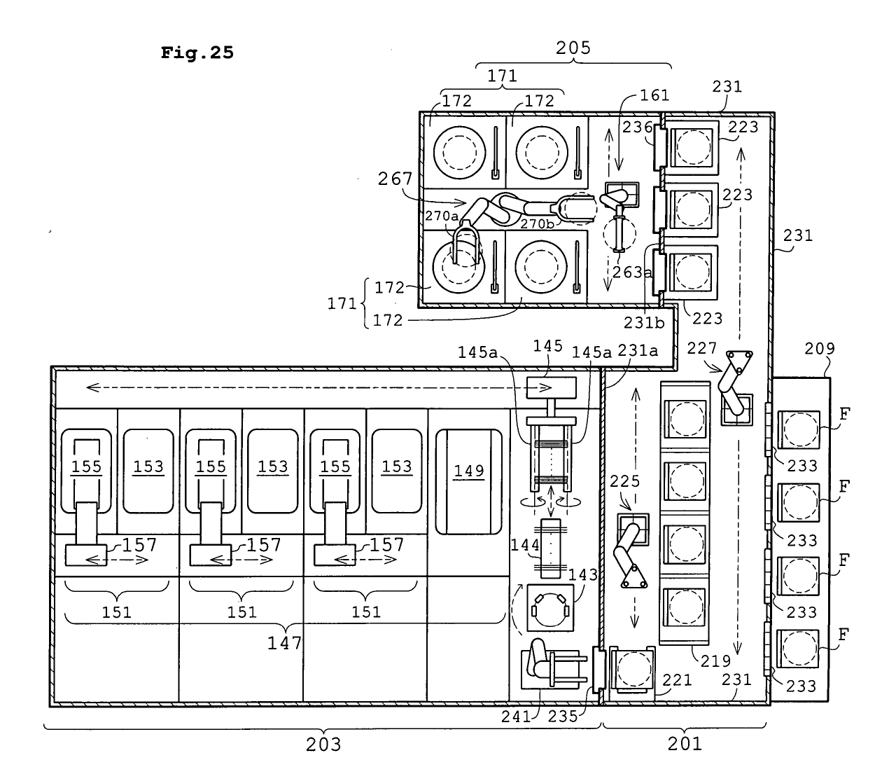

FIG. 25 is a plan view showing an outline of a substrate treating apparatus in Embodiment 5. Like reference numerals are used to identify like parts which are the same as in the foregoing embodiments, and will not be described again.

The substrate treating apparatus in Embodiment 5 is designed for performing predetermined treatment of wafers W, and includes a storage block 201 for receiving foups F, a first treating block 203 for treating a plurality of wafers W en bloc, and a second treating block 205 for treating wafers W one at a time. Each foup F corresponds to the receptacle in this invention.

As shown in FIG. 25, the first treating block 203 and second treating block 205 are arranged at one side of the storage block 201. As a result, the storage block 201 directly faces the first treating block 203 and second treating block 205.

The storage block 201 has a support table 209 disposed at the side thereof remote from the first treating block 203 and second treating block 205 for receiving four foups F thereon. The support table 209 supports foups F to be loaded into the storage block 201, and foups F unloaded from the storage block 201.

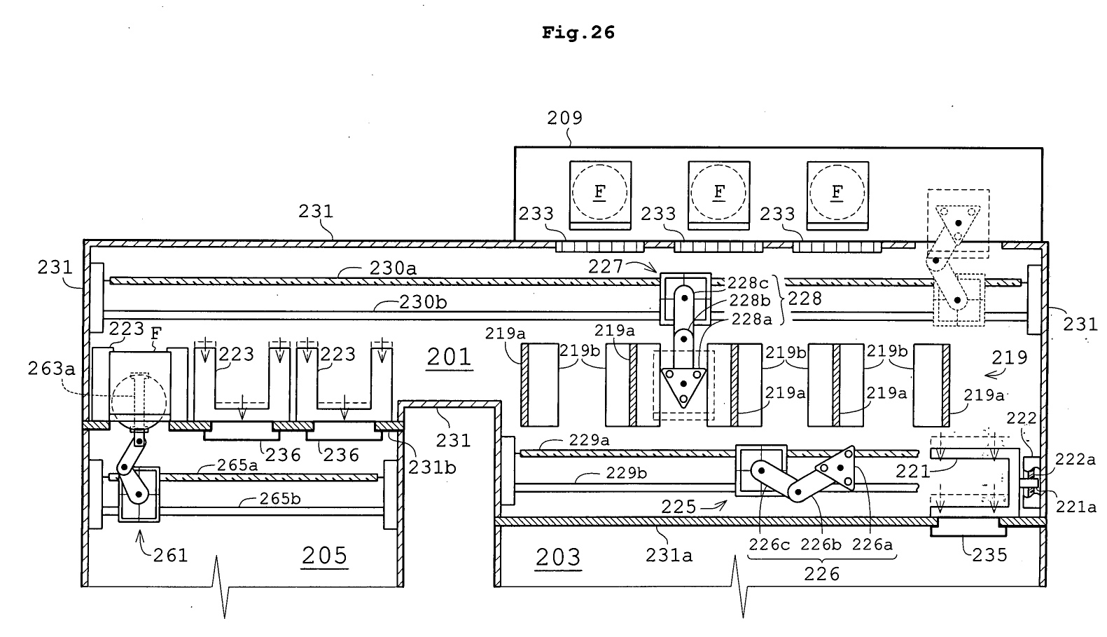

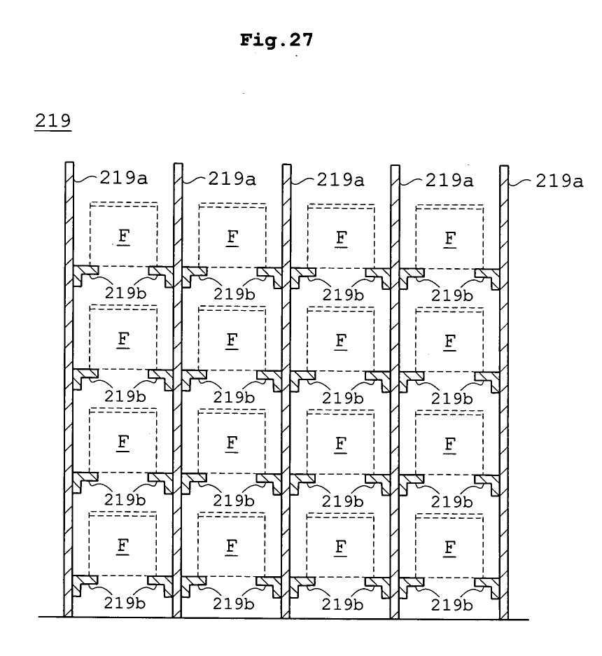

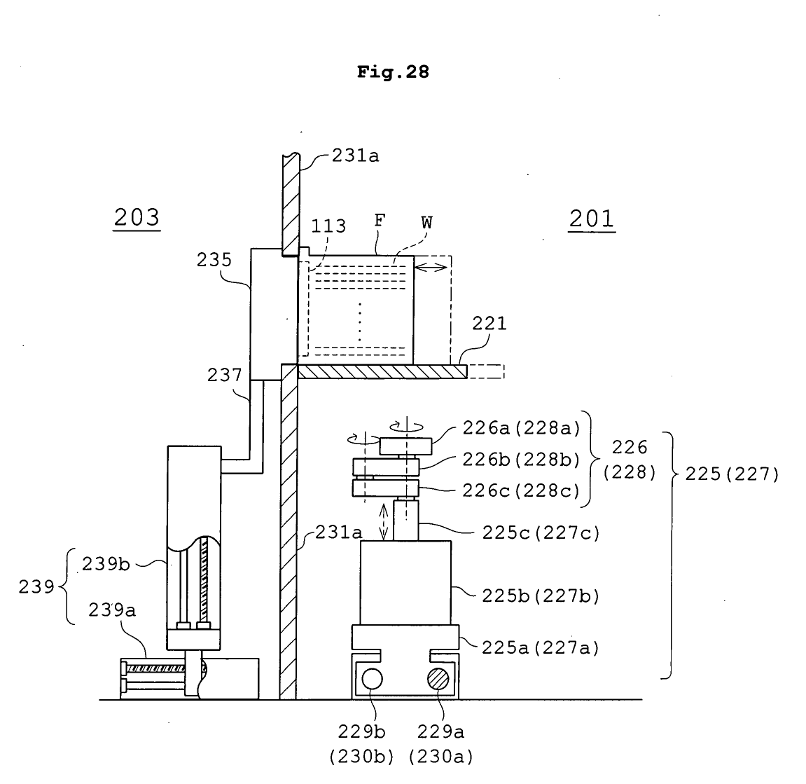

FIGS. 26, 27 and 28 refer. FIG. 26 is a plan view of the storage block 201. FIG. 27 is a front view of a rack 219. FIG. 28 is a side view showing portions of the storage block 201 and first treating block 203. The storage block 201 for receiving foups F includes a rack 219 for holding foups F, a first stage 221 for holding foups F accessed from the first treating block 203, three second stages 223 for holding foups F accessed from the second treating block 205, a first foup transport mechanism 225 for transporting foups F between the rack 219 and first stage 221, and a second foup transport mechanism 227 for transporting foups F between the support table 209, rack 219 and second stages 223. The storage block 201 has side walls 231 arranged circumferentially thereof to seal off the interior of the storage block 201 from outside atmosphere. In this specification, the side wall 231 that divides the storage block 201 from the first treating block 203 is called a partition wall 231a, and the side wall 231 that divides the storage block 201 from the second treating block 205 is called a partition wall 231b.

The rack 219 is disposed substantially centrally of the storage block 201 and in a position opposed to the first treating block 203, and has four vertical stages. The rack 219 includes five side panels 219a arranged equidistantly and upstanding parallel to one another, and 16 pairs of opposed receiving members 219b attached to the side panels 219a. A foup F may be placed on each pair of receiving members 219b with opposite ends of the foup F resting on the receiving members 219b. Thus, the rack 219 as a whole can hold 16 foups F, with four foups F arranged in each stage. Each pair of receiving members 219b has an interval therebetween larger than the width of foup carrying arms 226a and 228a of the first and second foup transport mechanisms 225 and 227, and smaller than the width of foups F. Consequently, the foup carrying arms 226a and 228a can vertically pass through between each pair of receiving members 219b.

The first stage 221 is disposed adjacent the first partition wall 231a for holding one foup F at a time. The first stage 221 is C-shaped (or channel-shaped) in plan view for allowing the foup carrying arm 226a to pass vertically through the center thereof. The first stage 221 has a slide mechanism 222 disposed laterally thereof to be movable toward and away from the first partition wall 231a.

This slide mechanism 222 is in the form of a screw feed mechanism for moving the first stage 221, and includes a screw shaft 222a meshed with a projection 221a formed on a side of the first stage 221, and an electric motor, not shown, for rotating the screw shaft 222a backward and forward. The first stage 221 corresponds to the first table in this invention.

The three second stages 223 are arranged horizontally along the second partition wall 231b, each for holding one foup F at a time. Each of the second stages 223 is C-shaped (or channel-shaped) in plan view for allowing the foup carrying arm 228a to pass vertically through the center thereof. Each second stage 223 has a slide mechanism, not shown, disposed thereunder to be movable toward and away from the second partition wall 231b. This slide mechanism, as is the slide mechanism 222, is a screw feed mechanism. Each second stage 223 corresponds to the second table in this invention.

As shown in FIG. 28, the first foup transport mechanism 225 includes a horizontal driver 225a, a base 225b mounted on the horizontal driver 225a, a lift rod 225c vertically movable relative to the base 225b, and an articulated robot 226 attached to the upper end of the lift rod 225c. In the storage block 201, a screw shaft 229a and a guide rod 229b are laid to extend along the rack 219 between the rack 219 and first treating block 203. The screw shaft 229a and guide rod 229b extend to a position adjacent the first stage 221. The horizontal driver 225a is movable horizontally along these screw shaft 229a and guide rod 229b. The articulated robot 226 has, in order from the distal end thereof, the foup carrying arm 226a, shaped substantially triangular in plan view, for holding foups F, a first link 226b for holding the foup carrying arm 226a to be swingable in a horizontal plane, and a second link 226c for holding the first link 226b to be swingable in a horizontal plane. The second link 226c is supported by the upper end of the lift rod 225c to be swingable in a horizontal plane.

The foup carrying arm 226a is extendible and retractable relative to the lift rod 225c by flexion of the first link 226b and second link 226c. The second link 226 is also rotatable relative to the lift rod 225c to swivel the foup carrying arm 226a about the lift rod 225c. The foup carrying arm 226a is freely movable to a position opposed to the rack 219 or stage 221 as the lift rod 225c moves vertically relative to the base 225b, and the horizontal driver 225a moves horizontally along the screw shaft 229a.

When the first foup transport mechanism 225 places a foup F on the rack 219, the foup carrying arm 226a holding the foup F is lowered from above a pair of receiving members 219b. As the foup carrying arm 226a passes between the pair of receiving members 219b, the foup F is passed from the foup carrying arm 226a on to the rack 219. Conversely, when picking a foup F up from a pair of receiving members 219b, the foup carrying arm 226a is raised from below the pair of receiving members 219b. As the foup carrying arm 226a passes between the pair of receiving members 219b, the foup F is received from the rack 219.

When the first foup transport mechanism 225 places a foup F on the first stage 221 or takes a foup F from the first stage 221, the foup carrying arm 226a may be moved as in the case of the rack 219 described above. The first foup transport mechanism 225 corresponds to the third transport mechanism in this invention.

The second foup transport mechanism 227 has the same construction as the first foup transport mechanism 225. That is, as referenced in parentheses in FIG. 28, the second foup transport mechanism 227 includes a horizontal driver 227a, a base 227b mounted on the horizontal driver 227a, a lift rod 227c vertically movable relative to the base 227b, and an articulated robot 228 attached to the upper end of the lift rod 227c. The articulated robot 226 has the foup carrying arm 228a, a first link 228b and a second link 228c. The foup carrying arm 228a is extendible, retractable and swivelable relative to the lift rod 227c, and vertically movable relative to the base 227b.

A screw shaft 230a and a guide rod 230b defining a transport path of the second foup transport mechanism 227 are laid to extend along the side of the rack 219 remote from the first treating block 203 (or the second treating block 205). The screw shaft 230a and guide rod 230b extend from a position opposed to the support table 209 to a position opposed to the second treating block 205. Thus, the screw shaft 230a and guide rod 230b are opposed, across the rack 219, to the screw shaft 229a and guide rod 229b defining the transport path of the first foup transport mechanism 225.

The second foup transport mechanism 227 transports foups F between the support table 209, rack 219 and second stage 223. When delivering and receiving a foup F to/from the support table 209, rack 219 and second stage 223, the foup carrying arm 228a is moved vertically as in the case of the first foup transport mechanism 225. The second foup transport mechanism 227 corresponds to the fourth transport mechanism in this invention.

The side wall 231 disposed between the storage block 201 and support table 209 defines four openings in positions opposed to the foups F placed on the support table 209. These openings are formed slightly larger than the foups F to permit passage of the foups F. The openings are closed by four vertically movable shutter plates 233. These shutter plates 233 vertically move to open the openings only when the second foup transport mechanism 227 makes access to the support table 209. As a result, the foup carrying arm 226a can transport foups F to and from the support table 209 through the openings. Normally, the interior of the storage block 201 is sealed tight.

The first partition wall 231a defines a single, first passage opening substantially the same size as foups F, in a position opposed to the foup F placed on the first stage 221. This first passage opening allows passage of wafers W transported between the foup F and first treating block 203. The first passage opening is closed by a first shutter member 235 when no foup F is present on the first stage 221.

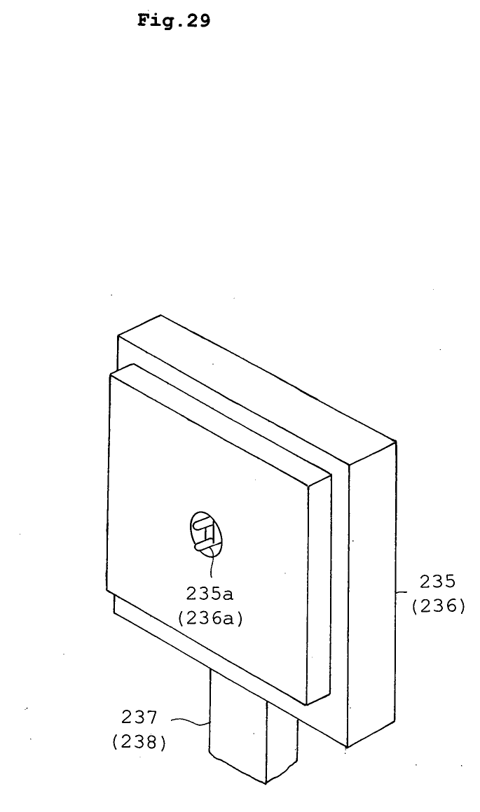

FIG. 29 refers. FIG. 29 is a perspective view of the first shutter member 235. The first shutter member 235 has a projection almost the same size as the first passage opening to fit in and plug the first passage opening. The first shutter member 235 has, disposed substantially centrally thereof, a first connection member 235a corresponding to a latch mechanism 117 provided on a lid 113 of each receptacle. The connection member 235a is shaped to connect to a pinion 117c forming part of the latch mechanism 117, and turn the pinion 117c when connected thereto. In this way, the lid 113 is locked to the case 111, and is allowed to detach from the case 111. When the lid 113 is made detachable from a case 111, the first shutter member 235 holds the lid 113 in this state. The first shutter member 235 and first connection member 235a correspond to the first shutter member, and the first attaching/detaching and holding mechanism in this invention, respectively.

The first shutter member 235 is connected to a shutter actuator 239 through an L-shaped arm 237. The shutter actuator 239 includes a horizontal driver 239a for horizontally driving the arm 237, and a vertical driver 239b for vertically driving the arm 237. Screw feed mechanisms are used as both the horizontal driver 239a and vertical driver 239b. The shutter actuator 239 causes the first shutter member 235 to move to and from the partition wall 231a and to move vertically.

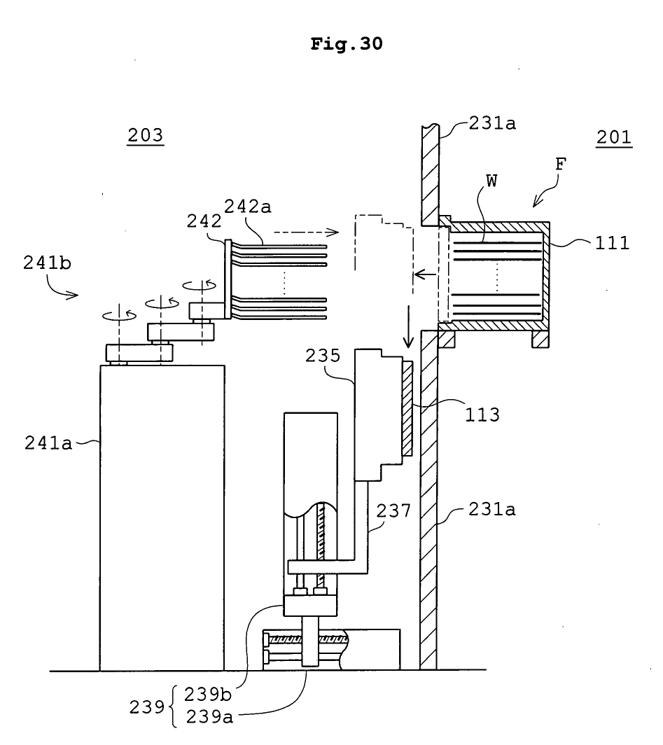

Operation of the first shutter member 235 for opening and closing the first passage opening will particularly be described with reference to FIG. 30. FIG. 30 is a side view illustrating the operation of the first shutter member 235. When a foup F is placed on the first stage 221, the foup F is advanced with the first stage 221 to move the lid 113 of the foup F into contact with the first shutter member 235 closing the first passage opening. At this time, the first connection member 235a operates the latch mechanism 117 on the lid 113 to render the lid 113 detachable from the case 111, and holds the lid 113. Then, the shutter actuator 239 lowers once and then retreats the first shutter member 235 holding the lid 113. As a result, the lid 113 is removed from the foup F on the first stage 221, opening the interior of the foup F toward the first treating block 203 through the first passage opening.

When closing the first passage opening, the first shutter member 235 holding the lid 113 is raised and advanced to fit into the first passage opening. At this time, the lid 113 held by the first shutter member 235 also is fit into the opening of the case 111 of the foup F placed on the first stage 221. The first connection member 235a operates the latch mechanism 117 to fix the lid 113 to the case 111. Thus, the first passage opening is closed and the lid 113 attached to the foup F again.

The second partition wall 231b defines three second passage openings substantially the same size as foups F, in positions opposed to the foups F placed on the second stages 223. These second passage openings allow passage of wafers W transported between the foups F and second treating block 205. The second passage openings are closed by three second shutter members 236 when no foups F are present on the second stages 223.

The second shutter members 236 have the same construction as the first shutter member 235. That is, as referenced in parentheses in FIG. 29, each second shutter member 236 has, disposed substantially centrally thereof, a second connection member 236a for operating the latch mechanism 117. Each second shutter member 236 is supported by a shutter actuator (not shown) through an L-shaped arm 238. The second shutter members 236 are horizontally and vertically movable independently of one another. By advancing, retracting and vertically moving each second shutter member 236, the corresponding second passage opening is opened and closed. At this time, the lid 113 of a foup F disposed adjacent the second passage opening is attached or detached. Each second shutter member 236 and second connection member 236a correspond to the second shutter member and the second attaching/detaching and holding mechanism in this invention, respectively.

Next, the first treating block 203 will be described. The first treating block 203 includes a first transport mechanism 241 for carrying wafers W en bloc into and out of a foup F placed on the first stage 221, a substrate rack 143 for delivering and receiving a group of wafers W to/from the first transport mechanism 241, a pusher 244 for delivering and receiving the group of wafers W en bloc to/from the substrate rack 143, a first treating block's transport mechanisms 145 for delivering and receiving the group of wafers W en bloc to/from the pusher 244, and a batch treating section 147 for delivering and receiving the group of wafers W to/from the transport mechanisms 145, and treating the group of wafers W in vertical posture en bloc. The substrate rack 143 has a further function for changing the posture of the group of wafers W en bloc between horizontal posture and vertical posture. The first treating block's transport mechanism 145 has a further function for changing intervals between the wafers W. Each component will be described hereinafter.

As shown in FIG. 30, the first transport mechanism 241 includes a base 241a fixed to a position opposed to the first stage 221 across the first partition wall 231a, and an articulated robot 241b mounted on the base 241a. The articulated robot 241b has a transport arm 242 at a distal end thereof The transport arm 242 is actuated by the articulated robot 241b to extend, retract and swivel relative to the base 241a. The transport arm 242 includes pairs of hands 242a arranged in multiple stages and extending horizontally in parallel for holding a plurality of wafers W (hereinafter called a group of wafers W as appropriate) in horizontal posture. The number of stages of the hands 242a, preferably, corresponds to the number of wafers W stored in each foup F, which is 25 stages in this embodiment.

The first transport mechanism 241 advances the transport arm 242 into the first passage opening after the lid 113 of the foup F placed on the first stage 221 is removed by the first shutter member 235. Then, a group of wafers W is carried en bloc into or out of the foup F. The transport arm 242 is swivelable to deliver or receive a group of wafers W in horizontal posture en bloc to/from the substrate rack 143 disposed beside the first transport mechanism 241.

Next, the second treating block 205 will be described. The second treating block 205 includes a second transport mechanism 261 for carrying wafers W one at a time into and out of a foup F placed on one of the second stages 223, a second treating block's transport mechanism 267 for delivering and receiving wafers W one at a time to/from the second transport mechanism 261, and a single-substrate treating section 171 for cleaning and drying one at a time the wafers W received from the second treating block's transport mechanism 267. Each component will be described hereinafter.

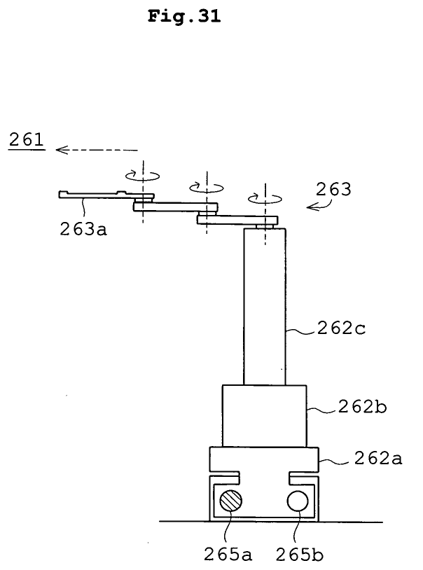

FIG. 31 refers. FIG. 31 is a side view of the second transport mechanism 261. The second transport mechanism 261 includes a horizontal driver 262a, a base 262b mounted on the horizontal driver 262a, a lift rod 262c vertically movable relative to the base 262b, and an articulated robot 263 attached to the upper end of the lift rod 262c. The second treating block 205 has a screw shaft 265a and a guide rod 265b laid in a position opposed to the storage block 201 and extending along the second partition wall 231b. These screw shaft 265a and guide rod 265b extend over a range opposed to the three second stages 223. The horizontal driver 262a is movable horizontally along the screw shaft 265a and guide rod 265b.

The articulated robot 263 has an I-shaped holding arm 263a at a distal end thereof for holding a single wafer W. The holding arm 263a is extendible, retractable and swivelable by the articulated robot 263. Further, the holding arm 263a is vertically and horizontally movable by the horizontal driver 262a and lift rod 262c.

With the construction described above, the second transport mechanism 261 operates as follows. First, one of the second shutter members 236 removes the lid 113 of a foup F placed on the corresponding second stage 223. The second transport mechanism 261 moves horizontally to the position opposed to the foup F, and the holding arm 263a vertically moves to a height corresponding to one of the wafers W in the foup F. The holding arm 263a advances into the second passage opening, and to a position under the one wafer W stored in the foup F. The holding arm 263a holds the wafer W thereon. Then, the holding arm 263a retreats to take the wafer W out of the foup F. Once the wafer W is taken out, the second transport mechanism 261 moves horizontally to the position opposed to the second treating block's transport mechanism 267 described hereinafter, and passes the fetched wafer W to the second treating block's transport mechanism 267.

When a wafer W is received from the second treating block's transport mechanism 267, the second transport mechanism 261 transports the wafer W into a foup F.

The second treating block's transport mechanism 267 has two articulated robots mounted on a vertically movable base to be driven independently of each other. Each of the articulated robots has holding arms 270a and 270b attached to a distal end thereof, each for holding one wafer W at a time. The holding arms 270a and 270b are U-shaped for conveniently delivering and receiving wafers W to/from the I-shaped holding arm 263a. The holding arms 270a and 270b are extendible, retractable and swivelable independently of each other. Further, the holding arms 270a and 270b are vertically movable synchronously with each other.

The second treating block's transport mechanism 267 delivers and receives wafers W one at a time to/from the first transport mechanism 261, and loads and unloads the wafers into/from the single-substrate treating section 171.

In this embodiment, one of the holding arms 270a of the second treating block's transport mechanism 267 exclusively holds one wafer W at a time, before treatment is performed therefor in the single-substrate treating section 171. The other holding arm 270b exclusively holds one wafer W at a time, after treatment is performed therefor in the single-substrate treating section 171. In this way, the holding arms 270a and 270b have discrete functions for wafers W in the different states.

The single-substrate treating section 171 includes four treating units 172 arranged in four directions around the second treating block's transport mechanism 267.

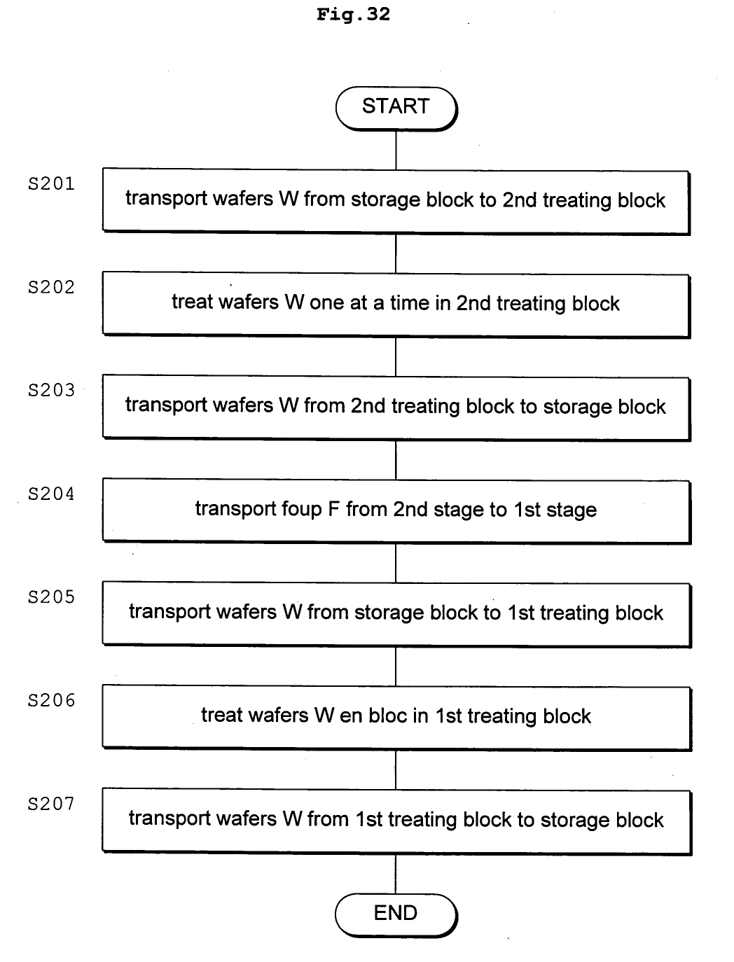

An example of operation of the substrate treating apparatus having the above construction will be described with reference to FIG. 32.

<Step S201> Transport Wafers W from the Storage Block to the Second Treating Block.

The second foup transport mechanism 227 transports a foup F storing a group of wafers W to be treated, from the rack 219 to one of the second stages 223. The foup F placed on the second stage 223, after a sliding movement, has the lid 113 removed by the second shutter member 236 corresponding to the second stage 223. The holding arm 263a of second transport mechanism 261 fetches the wafers W one at a time from the foup F through the second passage opening.

After the second transport mechanism 261 repeats this operation to fetch all the wafers W from the foup F, the second shutter member 236 moves forward and ascends to fit into the second passage opening, and attach and fix the lid 113 to the case 111 of the foup F. This completes the transport of wafers W from the storage block 201 to the second treating block 205.

The wafers W taken one at a time out of the foup F by the second transport mechanism 261 are transferred one at a time from the second transport mechanism 261 to the second treating block's transport mechanism 267. The second treating block's transport mechanism 267, with its holding arm 270a receiving each wafer W, transports the wafer W to one of the treating units 172.

<Step S202> Treat Wafers W one at a Time in the Second Treating Block.

In the treating units 172, predetermined treatment is performed for the wafers W.

<Step S203> Transport Wafers W from the Second Treating Block to the Storage Block.

When the predetermined treatment is completed for each wafer W in the treating unit 172, the second treating block's transport mechanism 167 places the wafer W on the holding arm 270b, and transports the wafer W from the treating unit 172.

The second transport mechanism 261 receives the wafer W, and moves horizontally back to the position opposed to the second stage 223. An empty foup F has been placed beforehand on the second stage 223, and the lid 113 of the foup F has been removed by the second shutter member 236. The second transport mechanism 261 loads the group of wafers W one at a time into the foup F through the second passage opening. When the wafers W have been placed in all the grooves 115 in the foup F, the second shutter member 236 moves up and forward to close the second passage opening, and attaches and fixes the lid 113 to the case 111 of the foup F. This completes the transport of wafers W from the second treating block 205 to the storage block 201.

<Step S204> Transport Foup F from the Second Stage to the First Stage.

The second foup transport mechanism 227 transports the foup storing the wafers W having been treated in the second treating block 205, from the second stage 223 to the rack 219.

After the foup F is placed on the rack 219, the first foup transport mechanism 225, in its turn, transports the foup F from the rack 219 to the first stage 221. When the foup F has been placed on the first stage 221, the first stage 221 slides toward the first partition wall 231a, to place the lid 113 of the foup F in contact with the first shutter member 235.

<Step S205> Transport Wafers W from the Storage Block to the First Treating Block.

The first shutter member 235 retracts and lowers to remove the lid 113 from the foup F placed on the first stage 221, and opens the first passage opening. The holding arm 242 of first transport mechanism 241 fetches the wafers W en block from the foup F through the second passage opening.

After the group of wafers W is taken out of the foup F, the first shutter member 235 is fitted into the first passage opening again, to attach and fix the lid 113 to the case 111 of the foup F.

The first transport mechanism 241 places on the substrate rack 143 the fetched group of wafers W as remaining in horizontal posture. The group of wafers W placed is transported to one of the cleaning units 151 via the pusher 144, first treating block's transport mechanism 145 and lifter 157.

<Step S206> Treat Wafers W en Bloc in the First Treating Block.

The group of wafers W receives predetermined treatment in the cleaning unit 151. Thereafter, the group of wafers W is transported to the drying unit 149 to be dried therein.

<Step S207> Transport the Wafer W from the First Treating Block to the Storage Block.

The group of wafers W having undergone the series of treatments in the batch treating section 147 is transferred to the first transport mechanism 241 via the transport block's transport mechanism 145, pusher 144 and substrate rack 143.

The first transport mechanism 241 receives the group of wafers, and swivels to face the first stage 221. At this time, an empty foup F has been placed on the first stage 221, and the lid 113 of the foup F has been removed by the first shutter member 235. The first transport mechanism 241 loads the group of wafers W en bloc into the foup F through the first passage opening of the partition wall 231a.

Subsequently, the first shutter member 235 moves up and forward to close the first passage opening, and attach and fix the lid 113 to the case 111 of the foup F.

The first foup transport mechanism 225 and second foup transport mechanism 227 transport the foup F containing the wafers W treated in the first treating block 203, from the first stage 221 via rack 219 to the support table 209.

The substrate treating apparatus in Embodiment 5, as described above, has the first treating block 203 and second treating block 205, and wafers W can be transported from the storage block 201 selectively to the first treating block 203 and second treating block 205. Thus, the wafers W may be treated in the batch treating mode for treating a plurality of wafers W en block and in the single-substrate treating mode for treating wafers W one at a time.

Wafers W are transported between the first treating block 203 and second treating block 205 by way of the storage block 201. The wafers W are never transferred directly between the first treating block 203 and second treating block 205. Therefore, an overall control of the first treating block 203 and second treating block 205 does not require coordination between the two treating blocks, but can control these blocks independently. The two treating blocks may be coordinated and adjusted by controlling the transport of foups F in the storage block 201.

As described, the first treating block 203 and second treating block 205 are arranged at one side of the storage block 201. This arrangement facilitates transfer of wafers W between the storage block 201 and first treating block 203, and between the storage block 201 and second treating block 205.

The first treating block 203 and second treating block 205 have the first transport mechanism 241 and second transport mechanism 261, respectively. Thus, wafers W may be transported between the storage block 201 and first treating units 203, and between the storage block 201 and second treating block 205.

Further, three second stages 223 are provided for receiving foups F thereon, so that wafers W are transferred between these foups F and the second treating units 205. This realizes an increase in the quantity of wafers W transported between the second treating block 205 and storage block 201.

The storage block 201, with the rack 219 provided therein, can accommodate a plurality of foups F in a convenient way. Further, the rack 219 is accessible from opposite sides, and the first foup transport mechanism 225 and second foup transport mechanism 227 are horizontally movable along the opposite sides of the rack 219. Thus, the first and second transport mechanisms 225 and 227 can access the rack 219 efficiently, without interfering with each other. The first and second foup transport mechanisms 225 and 227 can transport foups F independently.

The second stages 223 are arranged on an extension of this rack 219. This arrangement allows the transport path of the second foup transport mechanism 227 to be straight, thereby to increase transporting efficiency.

Further, the first stage 221 is disposed at one end of the transport path of the first foup transport mechanism 225. This increases the transporting efficiency of the first foup transport mechanism 225.

In this embodiment, both the first treating block 203 and second treating block 205 are constructed for performing cleaning treatment of wafers W. This provides an improved quality (result) of treatment while securing an excellent throughput of wafer cleaning treatment.

The foups F are placed on and removed from the rack 219 by the foup carrying arms 226a and 228a passing vertically between the pairs of receiving members 219b. This feature allows the storage block 201 to have a compact construction.

The described apparatus has the first partition wall 231a and second partition wall 231b, and the first and second shutter members 335 and 336 for closing the first and second passage openings formed in the partition walls 231a and 231b. These components prevent the atmosphere of the storage block 201 flowing to the first treating block 203 and second treating block 205. Thus, the wafers W taken out of the foups F are free from contamination.

The openings formed in the side wall 231 separating the storage block 201 and support table 209 are closed by the shutter plates 233, to keep the atmosphere in the storage block 201 clean.

### Embodiment 6

Embodiment 6 of this invention will be described next.

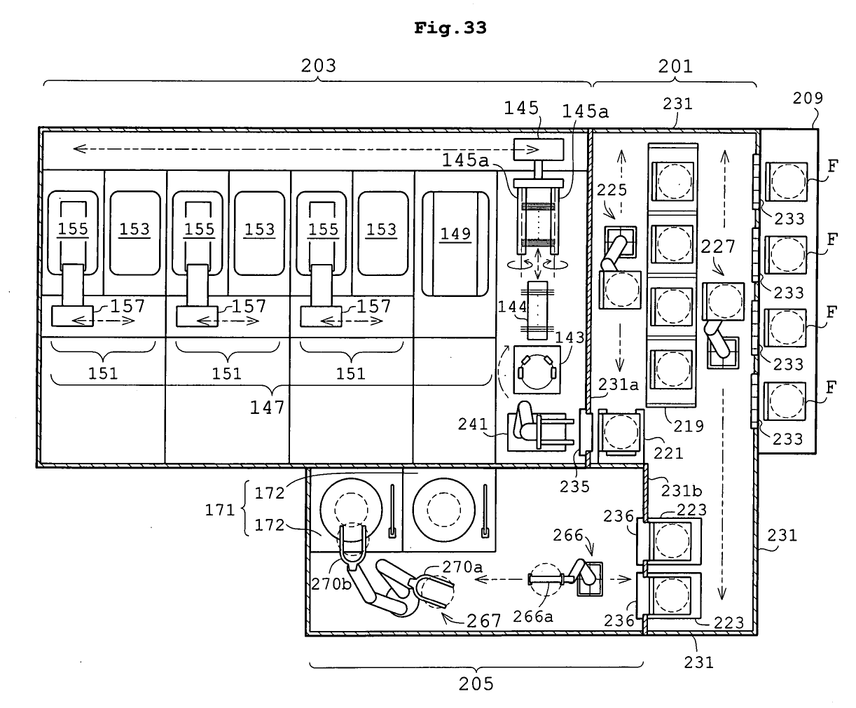

FIG. 33 is a plan view showing an outline of a substrate treating apparatus in Embodiment 6. Like reference numerals are used to identify like parts which are the same as in the foregoing embodiments, and will not be described again.

As shown in FIG. 33, the first treating block 203 and second treating block 205 are arranged at one side of the storage block 201 as in Embodiment 5. However, the second treating block 205 has a smaller width than in Embodiment 5. Consequently, the storage block 201 has the number of second stages 223 reduced to two.

In the second treating block 205, the holding arm 266a of the second transport mechanism 266 can access a foup F placed on each second stage 223 only by operation of the articulated robot. The second transport mechanism 266, therefore, is not required to move horizontally along the second partition wall 231b.

In this embodiment, the second transport mechanism 266 is horizontally movable perpendicular to the second partition wall 231b to deliver and receive wafers W to/from the second treating block's transport mechanism 267.

The single-substrate treating section 171 has treating units 172 arranged in two rows and in two stages.

According to Embodiment 6 as described above, the substrate treating apparatus has a reduced footprint.

The second transport mechanism 266 can omit the construction for horizontal movement along the second partition wall 231b.

This invention is not limited to the foregoing embodiments, but may be modified as follows;

(1) In Embodiments 5 and 6 described above, the first treating block 203 and second treating block 205 are arranged at one side of the storage block 201. The invention is not limited to such arrangement. For example, the first treating block 203 and second treating block 205 may be opposed to each other across the storage block 201. In this case, the first treating block 203 is disposed at one side of the storage block 201, and the second treating block 205 at the other side. In this arrangement also, the storage block 201 can transfer wafers W conveniently between the first and second treating blocks 203 and 205.

(2) In Embodiments 5 and 6 described above, it was the second foup transport mechanism 227 that transports foups F to the support table 209. This arrangement may be modified such that the first foup transport mechanism 225 transports foups F to the support table 209. In this case, the transport path of the first foup transport mechanism 225 is laid along the side of the rack 219 opposed to the support table 209, and the first stage 221 is disposed on an extension of the rack 219. The transport path of the second foup transport mechanism 227 is laid on the side of the rack 219 opposed to the second treating block 205, with the second stages 223 arranged at one end or opposite ends of this transport path.

(3) In Embodiments 5 and 6 described above, the second treating block 205 includes the second transport mechanism 261 and second treating block's transport mechanism 267. This is not limitative. For example, second treating block's transport mechanism 267 may be omitted, with the second transport mechanism 261 transporting wafers W directly between foups F placed on the second stages 223, and the single-substrate treating section 171.

The second transport mechanism 261 is constructed to transport wafers W one at a time, but may be modified to transport a plurality of wafers W en bloc.

The second treating block 205 may additionally include a rack for temporarily holding wafers W transported by the second transport mechanism 261. This allows the second transport mechanism 261 to transport the wafers W more smoothly.

(4) In the described example of operation, the wafers W are first transported to the second treating block 205, and thereafter to the first treating block 203. This order is not limitative. An order may be selected freely according to the treatments performed for the wafers W.

(5) In Embodiment 5 described above, the storage block 201 includes one first stage 221 and a plurality of second stages 223, but this is not limitative. For example, the storage block 201 may include a plurality of first stages 221 and one second stage 223.

### Embodiment 7

Embodiment 7 of this invention will be described next.

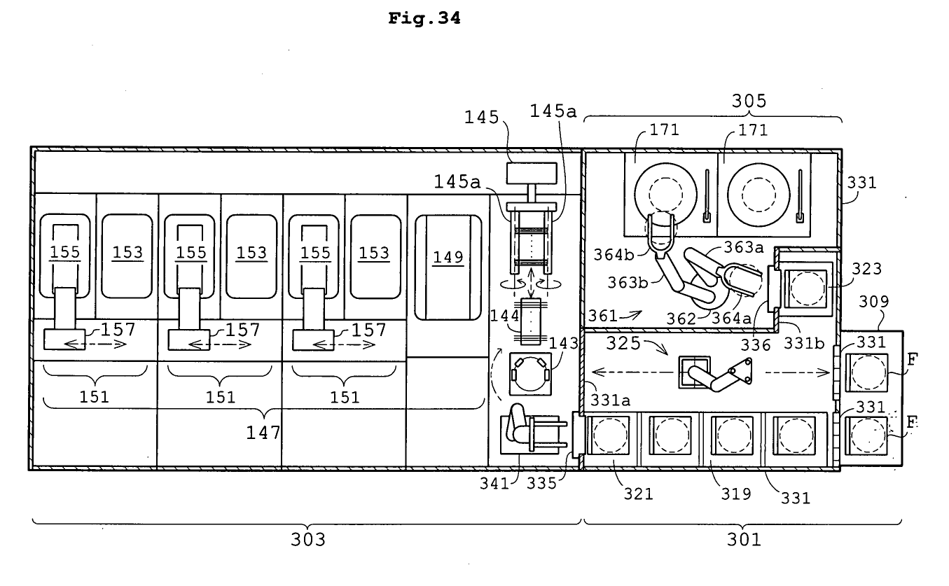

FIG. 34 is a plan view showing an outline of a substrate treating apparatus in Embodiment 7. Like reference numerals are used to identify like parts which are the same as in the foregoing embodiments, and will not be described again.

The substrate treating apparatus in Embodiment 7 is designed for performing predetermined treatment of wafers W, and includes a storage block 301 for receiving foups F, a first treating block 303 for treating a plurality of wafers W en bloc, and a second treating block 305 for treating wafers W one at a time. Each foup F corresponds to the receptacle in this invention.

As shown in FIG. 34, the second treating unit 305 is disposed between the first treating block 303 and a support table 309 (described hereinafter) forming part of the storage block 301. In other words, the second treating block 305 is disposed on an extension of a direction in which the batch treating section 147 forming part of the first treating block 303 is arranged. As a result, the first treating block 303 and second treating block 305 are arranged along one side of the substrate treating apparatus. The storage block 301 in this embodiment is L-shaped in plan view to be opposed to the first treating block 303 and second treating block 305.

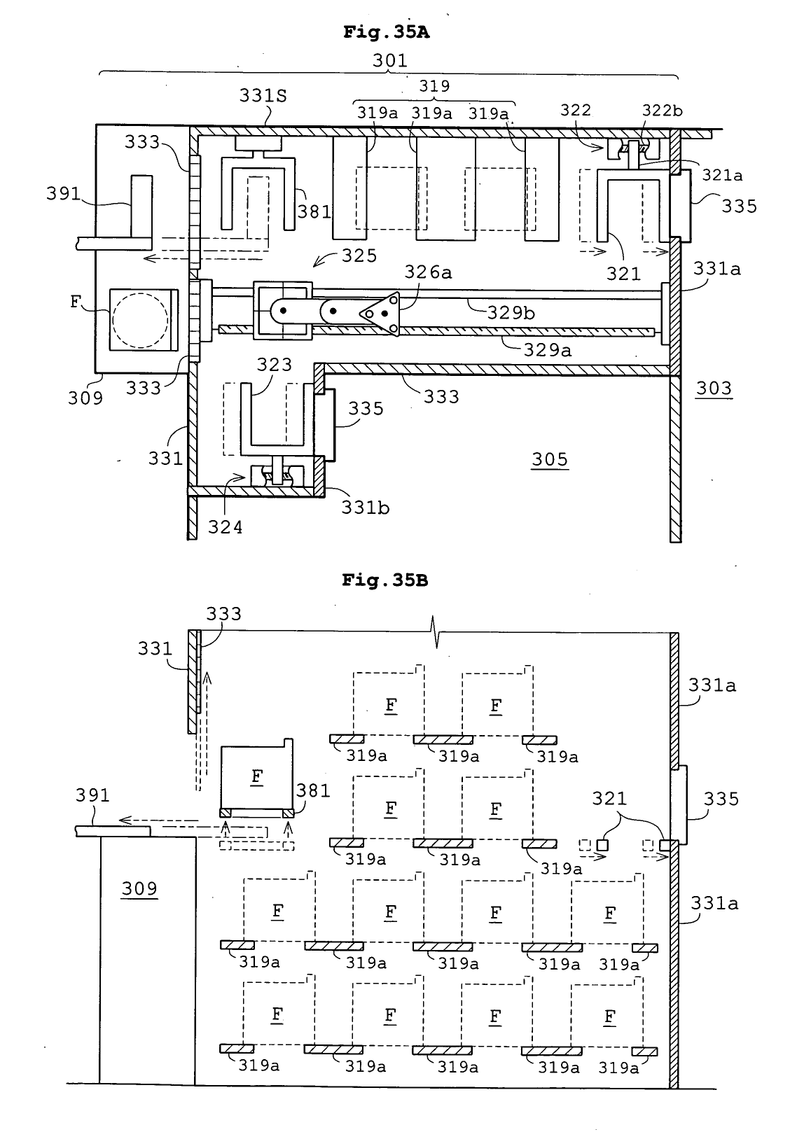

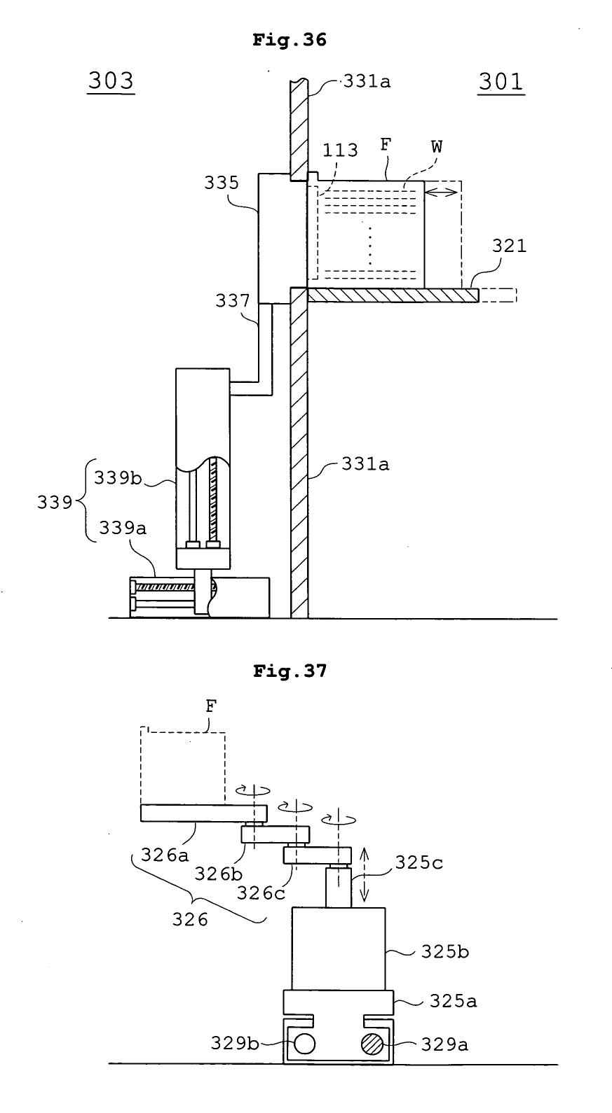

FIGS. 35, 36 and 37 refer. FIG. 35A is a plan view of the storage block 301. FIG. 35B is a front view of a rack 319. FIG. 36 is a side view showing portions of the storage block 301 and first treating block 303. FIG. 37 is a side view of a foup transport mechanism 325. The storage block 301 which accommodates foups F includes the support table 309 for receiving foups F transported to this substrate treating apparatus, shelves 319 for holding a plurality of foups F as arranged thereon, a first stage 321 for holding foups F accessed from the first treating block 303, second stages 323 for holding foups F accessed from the second treating block 305, a third stage 381 for delivering and receiving foups F to/from the support table 309, and a foup transport mechanism 325 for transporting foups F between the support table 309, shelves 319 and first second and third stages 321, 323 and 381. The storage block 301 has side walls 331 arranged circumferentially of its region excluding the support table 309 (hereinafter called “storage region 310” as appropriate), to seal off the storage region 310 from outside atmosphere. In this specification, the side wall 331 opposed to the first stage 321 is called a first partition wall 331a, and the side wall 331 opposed to the second stages 323 is called a second partition wall 331b.

The support table 309 is disposed laterally of the storage block 301, and can hold two foups F. The support table 309 holds a foup F to be carried into the storage block 301, and a foup F taken out of the storage block 301. The support table 309 corresponds to the third table in this invention.

The shelves 319 are arranged in a direction extending between the support table 309 and first treating block 303, and along the side of the storage block 301 remote from the second treating block 305. Thus, the shelves 319 are opposed to the second treating block 305. In this embodiment, the shelves 319 are arranged along the side wall 331 farthest from the second treating block 305 (which side wall is referenced “331S” in FIG. 35, and will be referred to hereinafter as “side wall 331S”) of the side walls 331 parallel to the direction extending between the support table 309 and first treating block 303 (i.e. the side walls 331 perpendicular to the first partition wall 331a).

The shelves 319 are formed of a plurality of receiving members 319a supported by the side wall 331S. A foup F may be placed on two horizontally adjacent receiving members 319a with opposite ends of the foup F resting on the receiving members 319a. The shelves 319 are arranged in four vertical stages. The two lower stages can each hold four foups F arranged horizontally. The two upper stages each hold two foups F. Thus, all the shelves 319 together can hold 12 foups F.

The intervals between the receiving members 319a are larger than the width of the foup carrying arm 326a of the foup transport mechanism 325, and smaller than the width of foups F. Consequently, the foup carrying arm 326a can vertically pass through between each pair of receiving members 319b.

One first stage 321 is installed in a vacant space formed above and laterally of the shelves 319 adjacent the first treating block 303. The first stage 321 is C-shaped (or channel-shaped) in plan view to define a center cutout for allowing the foup carrying arm 326a to pass vertically there-through. The first stage 321 is supported by the side wall 331S through a slide mechanism 322 to be horizontally movable relative to the side wall 331S. The first stage 321 holds one foup F at a time for access from the first treating block 303, and moves the foup F toward and away from the first partition wall 331a.

The slide mechanism 322 is in the form of a screw feed mechanism for moving the first stage 321, and includes a screw shaft 322a meshed with a projection 321a formed on a side of the first stage 321, and an electric motor, not shown, for rotating the screw shaft 322a backward and forward.

The first stage 321 also has the function of the shelves 319. When, for example, only the second treating block 305 and storage block 301 are operated, the first stage 321 can be used as a shelf 319. The first stage 321 corresponds to the first table in this invention.

Two second stages 323 are arranged vertically in a position opposed to the shelves 319 across the transport path of the foup transport mechanism 325, and opposed to the second partition wall 331b. Each second stage 323 is C-shaped (or channel-shaped) in plan view to define a center cutout for allowing the foup carrying arm 326a to pass vertically therethrough. Each second stage 323 is supported by the side wall 331 adjacent the second partition wall 331b through a slide mechanism 324. Thus, the second stages 323 are horizontally movable relative to the side wall 331 independently of each other. The slide mechanism 324, as is the slide mechanism 322, is a screw feed mechanism. Each second stage 223 corresponds to the second table in this invention.

One third stage 381 is installed in a vacant space formed above and laterally of the shelves 319 adjacent the support table 309. The third stage 381 also is C-shaped (or channel-shaped) in plan view to define a center cutout for allowing the foup carrying arm 326a to pass vertically there-through. The third stage 381 is supported by the side wall 331S through-a slide mechanism 322 to be vertically movable relative to the side wall 331S. The third stage 381 delivers and receives one foup F at a time to/from the support table 309. Of the two foups F placed on the support table 309, only the foup F adjacent the third stage 381 is delivered or received.

An operation for transferring a foup F between the third stage 381 and support table 309 will be described briefly with reference to FIG. 35. As shown in FIG. 35, the support table 309 has an L-shaped foup handling arm 391 for holding a foup F. The arm 391 is movable toward and away from the third stage 381 by a drive mechanism not shown. When the third stage 381 is lowered to a position below the foup handling arm 391, the arm 391 holding a foup F moves forward to the cutout of the third stage 381. Then, the third stage 381 rises above the foup handling arm 391. The foup F is thereby transferred from the foup handling arm 391 to the third stage 381. After the foup F is transferred, the foup handling arm 391 retreats to the support table 309.

As shown in FIG. 37, the foup transport mechanism 325 includes a horizontal driver 325a, a base 325b mounted on the horizontal driver 325a, a lift rod 325c vertically movable relative to the base 325b, and an articulated robot 326 attached to the upper end of the lift rod 325c. The storage block 301 has a screw shaft 329a and a guide rod 329b laid substantially centrally thereof and extending along the shelves 319. The screw shaft 329a and guide rod 329b have opposite ends thereof located adjacent the support table 309 and first treating block 303. The horizontal driver 325a is movable horizontally along the screw shaft 329a and guide rod 329b. The articulated robot 326 has, in order from the distal end thereof, the foup carrying arm 326a, shaped substantially triangular in plan view, for holding foups F, a first link 326b for holding the foup carrying arm 326a to be swingable in a horizontal plane, and a second link 326c for holding the first link 326b to be swingable in a horizontal plane. The second link 326c is supported by the upper end of the lift rod 325c to be swingable in a horizontal plane.

The foup carrying arm 326a is extendible and retractable relative to the lift rod 325c by flexion of the first link 326b and second link 326c. The foup carrying arm 326a is swivelable about the lift rod 325c by rotation of the second link 326c relative to the lift rod 325c. The foup carrying arm 326a can freely move to positions opposed to the support table 309, shelves 319, first stage 321, second stages 323 and third stage 381 as the horizontal driver 325a moves horizontally along the screw shaft 329a. In the position opposed to the support table 309, the foup carrying arm 326a makes access only to the foup F present on an extension of the transport track, of the two foups F placed on the support table 309.

When the foup transport mechanism 325 places a foup F on a shelf 319, the foup carrying arm 326a holding the foup F is lowered between the receiving members 319a. As the foup carrying arm 326a passes between the receiving members 319a, the foup F is passed from the foup carrying arm 326a on to the shelf 319. Conversely, when picking a foup F up from a shelf 319, the foup carrying arm 326a is raised between the receiving members 319a holding the foup F. As the foup carrying arm 326a passes between the receiving members 319a, the foup F is received from the shelf 319.

When the foup transport mechanism 325 accesses the first stage 321, second stages 323, third stage 381 or support table 309, the foup carrying arm 326a may be raised as in the case of shelves 319 described above. The foup transport mechanism 325 corresponds to the transport device in this invention.

The side wall 131 disposed between the support table 309 and storage region 310 defines two openings in positions opposed to the foups F placed on the support table 309. One of these openings is formed larger than the other to permit entry of the foup handling arm 391. These openings are formed slightly larger than the foups F to permit passage of the foups F. The openings are closed by two vertically movable shutter plates 333. These shutter plates 333 vertically move to open the openings only when foups F are transported between the support table 309 and foup transport mechanism 325 or third stage 381. Normally, the shutter plates 333 close the openings to seal the interior of the storage region 310.

The first partition wall 331a defines a single, first passage opening substantially the same size as foups F, in a position opposed to the foup F placed on the first stage 321. The first passage opening allows passage of wafers W transported between the foup F and first treating block 303. The first passage opening is closed by a first shutter member 335 when no foup F is present on the first stage 321.

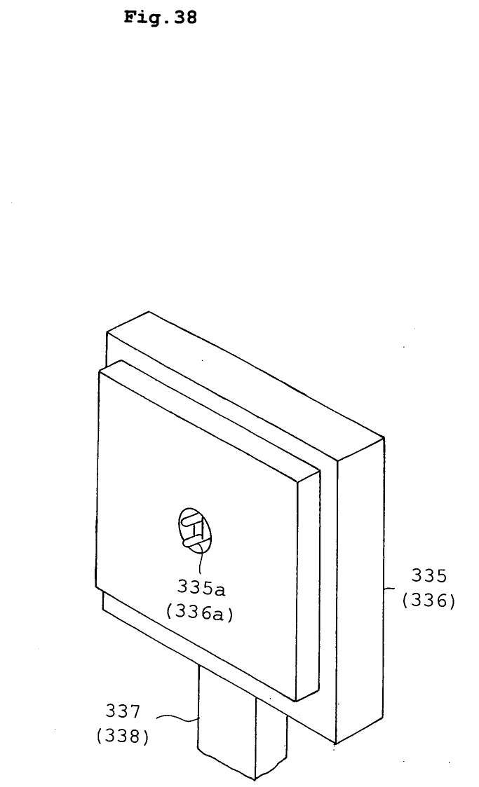

FIG. 38 refers. FIG. 38 is a perspective view of the first shutter member 335. The first shutter member 335 has a projection almost the same size as the first passage opening to fit in and plug the first passage opening. The first shutter member 335 has, disposed substantially centrally thereof, a first connection member 335a corresponding to a latch mechanism 117 provided on the lid 113 of each receptacle. The first connection member 335a is shaped to connect to a pinion 117c forming part of the latch mechanism 117, and turn the pinion 117c when connected thereto. In this way, the lid 113 is locked to the case 111, and is allowed to detach from a case 111. When the lid 113 is made detachable from the case 111, the first shutter member 335 holds the lid 113 in this state. The first shutter member 335 and first connection member 335a correspond to the shutter member, and the first attaching/detaching and holding mechanism in this invention, respectively.

The first shutter member 335 is connected to a shutter actuator 339 through an L-shaped arm 337. The shutter actuator 339 includes a horizontal driver 339a for horizontally driving the arm 337, and a vertical driver 339b for vertically driving the arm 337. Screw feed mechanisms are used as both the horizontal driver 339a and vertical driver 339b. The shutter actuator 339 causes the first shutter member 335 to move to and from the first partition wall 331a and to move vertically.

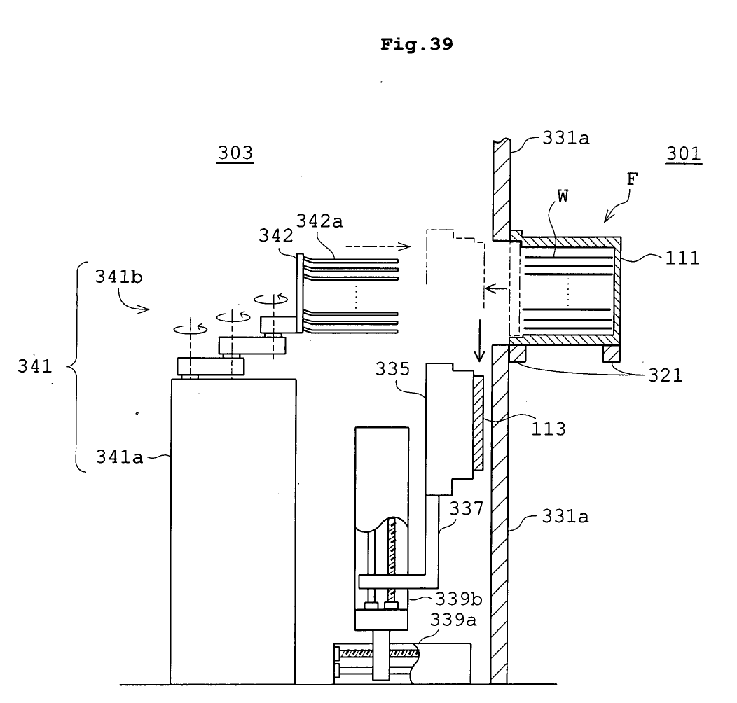

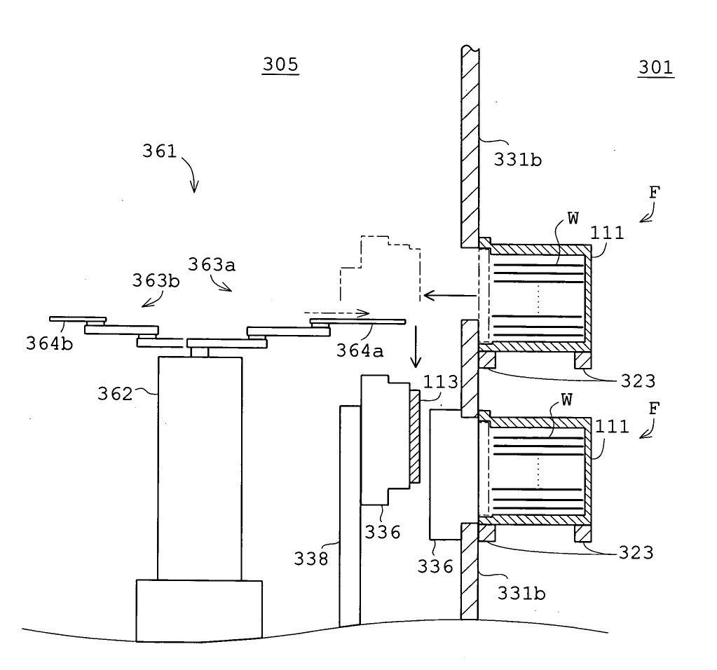

Operation of the first shutter member 335 for opening and closing the first passage opening will particularly be described with reference to FIG. 39. FIG. 39 is a side view illustrating the operation of the first shutter member 335. When a foup F is placed on the first stage 321, the foup F is advanced with the first stage 121 to move the lid 113 of the foup F into contact with the first shutter member 335 closing the first passage opening. At this time, the first connection member 335a operates the latch mechanism 117 on the lid 113 to render the lid 113 detachable from the case 111, and holds the lid 113. Then, the shutter actuator 339 lowers once and then retracts the first shutter member 135 holding the lid 113. As a result, the lid 113 is removed from the foup F on the first stage 321, opening the interior of the foup F toward the first treating block 303 through the first passage opening.

When closing the first passage opening, the first shutter member 135 holding the lid 113 is raised and advanced to fit into the first passage opening. At this time, the lid 113 held by the first shutter member 135 also is fit into the opening of the case 111 of the foup F placed on the first stage 321. The first connection member 335a operates the latch mechanism 117 to fix the lid 113 to the case 111. Thus, the first passage opening is closed and the lid 113 attached to the foup F again.

The second partition wall 331b defines two second passage openings substantially the same size as foups F, in positions opposed to the foups F placed on the second stages 323. The second passage openings allow passage of wafers W transported between the foups F and second treating block 305. The second passage openings are closed by two second shutter members 336 when no foups F are present on the second stages 323.

The second shutter members 336 have the same construction as the first shutter member 335. That is, as referenced in parentheses in FIG. 38, each second shutter member 336 has, disposed substantially centrally thereof, a second connection member 336a for operating the latch mechanism 117. The first connection member 335a is shaped to connect to a pinion 117c forming part of the latch mechanism 117, and turn the pinion 117c when connected thereto. In this way, the lid 113 is locked to the case 111, and is allowed to detach from a case 111. When the lid 113 is made detachable from the case 111, the first shutter member 335 holds the lid 113 in this state. The first shutter member 335 and first connection member 335a correspond to the shutter member, and the first attaching/detaching and holding mechanism in this invention, respectively.

An L-shaped arm 339 is provided to be connectable to and separable from one of the two second shutter members 336. A shutter actuator, not shown, drives the arm 338 horizontally and vertically. Thus, the arm 338 is different from the arm 337 that fixedly supports the first shutter member 335. Each second shutter member 336 and second connection member 336a correspond to the shutter member, and the second attaching/detaching and holding mechanism in this invention, respectively.

Operation of each second shutter member 336 for opening and closing the second passage opening will particularly be described with reference to FIG. 40. FIG. 40 is a side view illustrating the operation of the second shutter member 336. The arm 338 is driven by the shutter actuator not shown, to combine with one of the shutter members 336 (i.e. the upper shutter member 336 in FIG. 40). The combined second shutter member 336 retracts one and then descends. The lid 113 of the foup F is thereby removed, opening the interior of the foup F to the second treating block 305 through the second passage opening. The two second passage openings are not opened simultaneously.

Next, the first treating block 303 will be described. The first treating block 303 includes a first transport mechanism 341 for carrying wafers W en bloc into and out of a foup F placed on the first stage 321, a substrate rack 143 for delivering and receiving a group of wafers W to/from the first transport mechanism 341, a pusher 144 for delivering and receiving the group of wafers W en bloc to/from the substrate rack 143, a first treating block's transport mechanisms 145 for delivering and receiving the group of wafers W en bloc to/from the pusher 144, and a batch treating section 147 for delivering and receiving the group of wafers W to/from the transport mechanisms 145, and treating the group of wafers W in vertical posture en bloc. The substrate rack 143 has a further function for changing the posture of the group of wafers W en bloc between horizontal posture and vertical posture. The first treating block's transport mechanism 145 has a further function for changing intervals between the wafers W. Each component will be described hereinafter.

The first transport mechanism 341 includes a base 341a fixed to a position opposed to the first stage 321 across the first partition wall 331a, and an articulated robot 341b mounted on the base 341a. The articulated robot 341b has a transport arm 342 at a distal end thereof. The transport arm 342 is actuated by the articulated robot 341b to extend, retract and swivel relative to the base 341a. The transport arm 342 includes pairs of hands 342a arranged in multiple stages and extending horizontally in parallel for holding a plurality of wafers W (hereinafter called a group of wafers W as appropriate) in horizontal posture. The number of stages of the hands 342a, preferably, corresponds to the number of wafers W stored in each foup F, which is 25 stages in this embodiment.

As shown in FIG. 39, the first transport mechanism 341 advances the transport arm 342 into the first passage opening after the lid 113 of the foup F placed on the first stage 321 is removed by the first shutter member 335. Then, a group of wafers W is carried en bloc into or out of the foup F. The transport arm 342 is swivelable to deliver or receive a group of wafers W in horizontal posture en bloc to/from the substrate rack 143 disposed beside the first transport mechanism 341.

Next, the second treating block 305 will be described. The second treating block 305 includes a second transport mechanism 361 for carrying wafers W one at a time into and out of a foup F placed on one of the second stages 323, a second treating block's transport mechanism 367 for delivering and receiving wafers W one at a time to/from the second transport mechanism 361, and a single-substrate treating section 171 for cleaning and drying one at a time the wafers W received from the second treating block's transport mechanism 367. Each component will be described hereinafter.

As shown in FIGS. 34 and 40, the second transport mechanism 361 includes a movable base 362, and two articulated robots 363a and 363b mounted on the upper end of the movable base 362. Each of the articulated robots 363a and 363b has a U-shaped holding arm 364a or 364b at a distal end thereof for holding a single wafer W.

Each holding arm 364a or 364b is extendible, retractable and swivelable by the articulated robot 363a or 363b independently of the other. Further, the holding arms 364a and 364b are vertically movable synchronously with each other by the movable base 362.

The second transport mechanism 361 transports wafers W one at a time between the foups F placed on the second stages 323 and the single-substrate treating section 171.

In this embodiment, one of the holding arms 364a and 364b of the second transport mechanism 361 (e.g. the holding arm 364a) holds only a single wafer W before treatment in the single-substrate treating section 171, and the other (e.g. the holding arm 364b) holds only a single wafer W after the treatment in the single-substrate treating section 171. In this way, different holding arms 364a and 364b are used to hold wafers W in different states.

Specifically, the second transport mechanism 361 operates as follows. First, one of the second shutter members 336 removes the lid 113 of a foup F placed on a corresponding one of the second stages 323. The holding arm 364a swivels and vertically moves to the position opposed to the foup F. The holding arm 364a then advances into the second passage opening, and to a position under the one wafer W stored in the foup F. The holding arm 363a holds the wafer W thereon. Then, the holding arm 363a retreats to take the wafer W out of the foup F. Once the wafer W is taken out, the second transport mechanism 361 swivels and makes other movements to transport the wafer W to the single-substrate treating section 171.

When transporting a wafer W from the single-substrate treating section 171, the holding arm 364b is used. The wafer W transported is returned to the foup F placed on the second stage 323.

The single-substrate treating section 171 has four treatment units 172 arranged in two rows and two stages. The treatment units 172 are arranged at one side of the second transport mechanism 361.

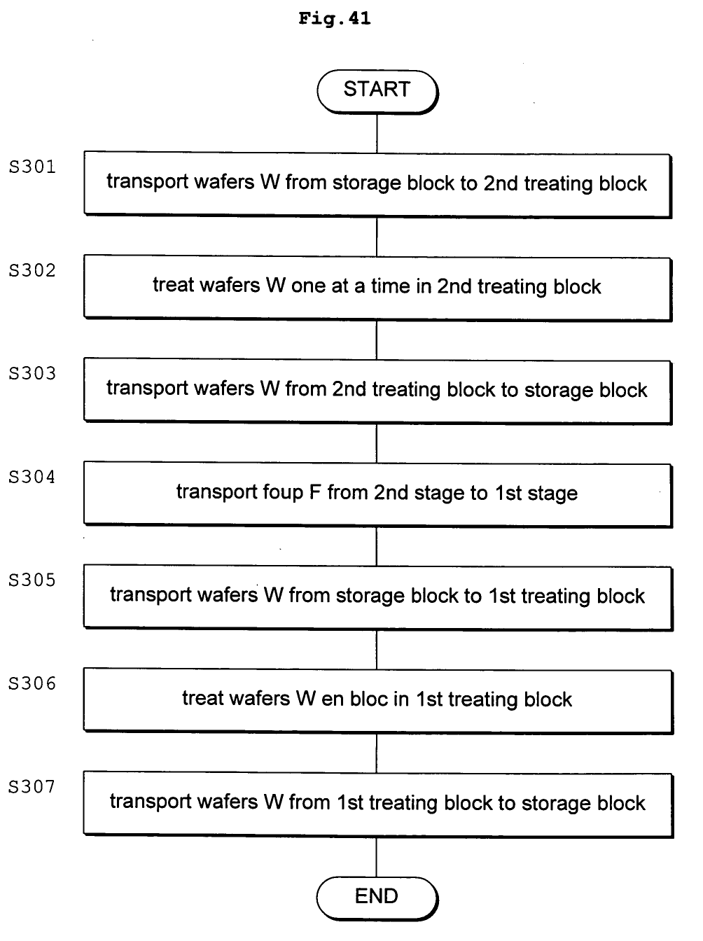

An example of operation of the substrate treating apparatus having the above construction will be described with reference to FIG. 41.

<Step S301> Transport Wafers W from the Storage Block to the Second Treating Block.

The second shutter member 336 combined with the arm 338 and holding the lid 113 of the foup F retreats once and then descends. This opens the second passage opening, and removes the lid 113.

The second transport mechanism 361 advances the holding arm 364a through the second passage opening into the foup F, to fetch wafers W one at a time. Each wafer W fetched from the foup F is loaded into one of the treating units 172.

After the second transport mechanism 261 repeats this operation to fetch all the wafers W from the foup F, the second shutter member 336 moves forward and ascends to fit into the second passage opening, and attach and fix the lid 113 to the case 111 of the foup F. This completes the transport of wafers W from the storage block 301 to the second treating block 305.

<Step S302> Treat Wafers W one at a Time in the Second Treating Block.

In the treating units 172, predetermined treatment is performed for the wafers W.

<Step S303> Transport Wafers W from the Second Treating Block to the Storage Block.

When the predetermined treatment is completed for each wafer W in the treating unit 172, the second transport mechanism 361 places the wafer W on the holding arm 364b, and transports the wafer W from the treating unit 172.

The second transport mechanism 361 swivels to the position opposed to the position opposed to the second stages 323. An empty foup F has been placed beforehand on one of the second stages 323, and the lid 113 of the foup F has been removed by the second shutter member 336. The second transport mechanism 361 loads the group of wafers W one at a time into the foup F through the second passage opening. When the wafers W have been placed in all the grooves 115 in the foup F, the second shutter member 236 moves up and forward to close the second passage opening, and attaches and fixes the lid 113 to the case 111 of the foup F. This completes the transport of wafers W from the second treating block 305 to the storage block 301.

<Step S304> Transport Foup F from the Second Stage to the First Stage.

The foup transport mechanism 325 transports the foup storing the wafers W having been treated in the second treating block 305, from the second stage 323 to the first stage 321.

When the foup F has been placed on the first stage 321, the first stage 321 slides toward the first partition wall 331a, to place the lid 113 of the foup F in contact with the first shutter member 335.

<Step S305> Transport Wafers W from the Storage Block to the First Treating Block.

The first shutter member 335 retracts and lowers to remove the lid 113 from the foup F placed on the first stage 321, and opens the first passage opening. The holding arm 342 of first transport mechanism 341 fetches the wafers W en block from the foup F through the second passage opening.

After the group of wafers W is taken out of the foup F, the first shutter member 335 is fitted into the first passage opening again, to attach and fix the lid 113 to the case 111 of the foup F.

The first transport mechanism 341 places on the substrate rack 143 the fetched group of wafers W as remaining in horizontal posture. The group of wafers W placed is transported to one of the cleaning units 151 via the pusher 144, first treating block's transport mechanism 145 and lifter 157.

<Step 306> Treat Wafers W en Bloc in the First Treating Block.

The group of wafers W receives predetermined treatment in the cleaning unit 151. Thereafter, the group of wafers W is transported to the drying unit 149 to be dried therein.

<Step S307> Transport the Wafer W from the First Treating Block to the Storage Block.

The group of wafers W having undergone the series of treatments in the batch treating section 147 is transferred to the first transport mechanism 341 via the transport block's transport mechanism 145, pusher 144 and substrate rack 143.

The first transport mechanism 341 receives the group of wafers, and swivels to face the first stage 321. At this time, an empty foup F has been placed on the first stage 321, and the lid 113 of the foup F has been removed by the first shutter member 335. The first transport mechanism 341 loads the group of wafers W en bloc into the foup F through the first passage opening of the partition wall 331a.

Subsequently, the first shutter member 335 moves up and forward to close the first passage opening, and attach and fix the lid 113 to the case 111 of the foup F.

The foup transport mechanism 325 transports the foup F containing the wafers W treated in the first treating block 303, from the first stage 321 to the support table 309.

The substrate treating apparatus in Embodiment 7, as described above, has the first treating block 303 and second treating block 305, and wafers W can be transported from the storage block 301 selectively to the first treating block 303 and second treating block 305. Thus, the wafers W may be treated in the batch treating mode for treating a plurality of wafers W en block and in the single-substrate treating mode for treating wafers W one at a time.

Wafers W are transported between the first treating block 303 and second treating block 305 by way of the storage block 301. The wafers W are never transferred directly between the first treating block 303 and second treating block 305. Therefore, an overall control of the first treating block 303 and second treating block 305 does not require coordination between the two treating blocks, but can control these blocks independently. The two treating blocks may be coordinated and adjusted by controlling the transport of foups F in the storage block 301.

As described, the first treating block 303 and second treating block 305 are arranged at one side of the storage block 301. This arrangement facilitates transfer of wafers W between the storage block 301 and first treating block 303, and between the storage block 301 and second treating block 305.

The second treating block 305 is disposed between the first treating block 303 and support table 309. This arrangement realizes a shortening of the short sides of the substrate treating apparatus, compared with the case of arranging the first treating block 303 and second treating block 305 at one side of the storage block 301. This arrangement can also eliminate dead space to reduce the footprint.

Further, the two second stages 323 provided and arranged vertically realize an increase in the quantity of wafers W transported between the second treating block 305 and storage block 301 while checking an increase in footprint.

The shelves 310 arranged between the first treating block 303 and support table 309 and in the position opposed to the second treating block 305 allow the storage block 301 to be compact.

The shelves 310 are arranged at one side and the second stages 323 at the other side of the transport path of the foup transport mechanism 325, and the support table 309 is disposed at one end of the transport path. This arrangement allows the transport path to be a relatively short straight line, and requires only one foup transport mechanism 325. This realizes improved transporting efficiency.

Since the foups F (or the lids 113) face the same direction at all times, the storage block 301 requires no mechanism for turning the foups F around.

The first stage 321 is disposed at the side of the shelves 319 adjacent the first treating block 303. Thus, effective use is made of space in the storage block 301 to render the storage block 301 compact.

The third stage 381 is disposed at the side of the shelves 319 adjacent the support table 309 for delivering and receiving foups F to/from the support tables 309. This provides an increased freedom for arranging the shelves 319, and an effective use of the space in the storage block 301.

When the foups F are placed on or fetched from the shelves 319, the foup carrying arm 326a is moved vertically between the receiving members 319a. This feature allows the storage block 301 to have a compact construction.

In this embodiment, both the first treating block 303 and second treating block 305 are constructed for performing cleaning treatment of wafers W. This provides an improved quality (result) of treatment while securing an excellent throughput of wafer cleaning treatment.

The described apparatus has the first partition wall 331a and second partition wall 331b, and the first and second shutter members 335 and 336 for closing the first and second passage openings formed in the partition walls 331a and 331b. These components prevent the atmosphere of the storage block 301 flowing to the first treating block 303 and second treating block 305. Thus, the wafers W taken out of the foups F are free from contamination.

The two second shutter members 336 share the single arm 338 and single shutter actuator. This realizes a reduced number of required components.

The opening formed in the side wall 331 separating the storage block 301 and support table 309 is closed by the shutter plates 333, to keep the atmosphere in the storage block 301 clean.

### Embodiment 8

Embodiment 8 of this invention will be described next.

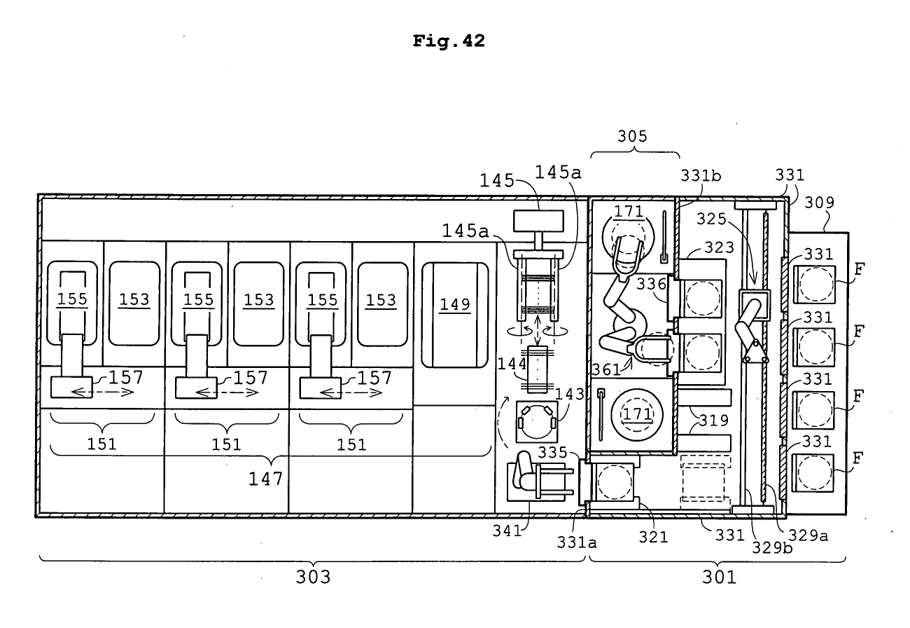

FIG. 42 is a plan view showing an outline of a substrate treating apparatus in Embodiment 8. Like reference numerals are used to identify like parts which are the same as in the foregoing embodiments, and will not be described again.

As shown in FIG. 42, the substrate treating apparatus in Embodiment 8, as in Embodiment 7, has the second treating unit 305 disposed between the first treating block 303 and a support table 309 (described hereinafter) forming part of the storage block 301. In other words, the second treating unit 305 is disposed on an extension of a direction in which the batch treating section 147 forming part of the first treating block 303 is arranged. As a result, the first treating block 303 and second treating block 305 are arranged along one side of the substrate treating apparatus. The storage block 301 in this embodiment is L-shaped in plan view to be opposed to the first treating block 303 and second treating block 305.

However, the transport path of the foup transport mechanism 325 in the storage block 301 and the arrangement of the single-substrate treating section 171 in the second treating block 305 in Embodiment 8 are different from those in Embodiment 7.

The storage block 301 includes a support table 309, shelves 319, a single first stage 321, two second stages 323, and a foup transport mechanism 325 for transporting foups F between the support table 309, shelves 319, and first and second stages 321 and 323. The storage block 301 includes nothing that corresponds to the third stage 381 described in Embodiment 7. The foup transport mechanism 325 accesses all foups F placed on the support table 309. Thus, the support table 309 does not require the foup handling arm 391 described in Embodiment 7.

The shelves 310 and first and second stages 321 and 323 are juxtaposed along a line parallel to the support table 309. In this embodiment, the shelves 310 and first and second stages 321 and 323 are arranged on a line extending along a second partition wall 331b.

The first stage 321 is horizontally movable over a distance corresponding to a spacing between the first partition wall 331a and second partition wall 331b, so that the group of wafers W in a foup F placed thereon may be transported to the first treating block 303.

The two second stages 323 are arranged horizontally in positions opposed to the second partition wall 331b.

The shelves 319 are arranged between the first and second stages 321 and 323, in four vertical stages for holding a total of four foups F. The shelves 319 may be disposed in any appropriate position on a line extending along the second partition wall 331b not interfering with the first and second stages 321 and 323.

A screw shaft 329a and a guide rod 329b defining the transport path of the foup transport mechanism 325 are laid between the support table 309 and the line extending along the second partition wall 331b (i.e. the line on which the shelves 319, and the first and second stages 321 and 323 are juxtaposed). The screw shaft 329a and guide rod 329b have opposite ends thereof extending through ranges opposed to the support table 309, shelves 319, and the first and second stages 321 and 323.

The second partition wall 331b defines two second passage openings arranged horizontally to correspond to the second stages 323. These second passage openings are opened and closed by two second shutter members 336. Each second shutter member 336 is fixedly supported by an arm (not shown). Each arm is independently driven by a separate shutter actuator.

The single-substrate treating section 171 in the second treating block 305 includes two sets of treating units 172 stacked in two stages and opposed to each other with a second transport mechanism 361 in between.

This invention is not limited to the foregoing embodiments, but may be modified as follows;

(1) In the described example of operation, the wafers W are first transported to the second treating block 305, and thereafter to the first treating block 303. This order is not limitative. An order may be selected freely according to the treatments performed for the wafers W.

(2) In Embodiments 7 and 8 described above, the second transport mechanism 361 is constructed to transport wafers W one at a time. The second transport mechanism 361 may be modified to transport a plurality of wafers W en bloc.

Further, the second treating block 305 may additionally include a rack for temporarily holding the wafers W transported by the second transport mechanism 361. This allows the second transport mechanism 361 to transport the wafers W more smoothly.

(3) In Embodiment 7 described above, the storage block 301 includes one first stage 321 and a plurality of second stages 323, but this is not limitative. For example, the storage block 301 may include a plurality of first stages 321 and one second stage 323.

This invention may be embodied in other specific forms without departing from the spirit or essential attributes thereof and, accordingly, reference should be made to the appended claims, rather than to the foregoing specification, as indicating the scope of the invention.

What is claimed is:

1. A substrate treating apparatus comprising:
a receptacle table for supporting a receptacle that stores a plurality of substrates;
a substrate treating block including a first treating section for treating a plurality of substrates en bloc, and a second treating section for treating the substrates one at a time;
a transport mechanism for transporting the substrates between said receptacle table, said first treating section and said second treating section; and
a control device for controlling, based on substrate treating conditions, a transport operation of said transport mechanism for transporting the substrates between said receptacle table, said first treating section and said second treating section.

2. An apparatus as defined in claim 1, wherein said substrate treating block is divided into two regions, said first treating section and said second treating section being arranged opposite each other, said first treating section being disposed in one of the regions, and said second treating section being disposed in the other of the regions.

3. An apparatus as defined in claim 2, further comprising a partition between said two regions.

4. An apparatus as defined in claim 1, wherein said first treating section includes:
a treating unit for treating a plurality of substrates in vertical posture with a treating solution;
a drying unit for drying the plurality of substrates in vertical posture after being treated in said treating unit;
a posture changing mechanism for delivering and receiving the plurality of substrates to/from said transport mechanism, and changing the plurality of substrates between horizontal posture and vertical posture; and
a first treating section's transport mechanism for delivering and receiving the plurality of substrates to/from said posture changing mechanism, and transporting the substrates between said treating unit and said drying unit.

5. An apparatus as defined in claim 1, wherein said second treating section includes a single-substrate treating unit for treating one substrate at a time, and a second treating section's transport mechanism for transporting the substrates between said transport mechanism and said single-substrate treating unit.

6. An apparatus as defined in claim 4, wherein said posture changing mechanism included in said first treating section is a first posture changing mechanism, said apparatus further comprising a second posture changing mechanism disposed opposite said transport mechanism across said substrate treating block, for transporting the substrates between said first treating section and said second treating section, and changing the plurality of substrates between horizontal posture and vertical posture.

7. An apparatus as defined in claim 1, wherein said transport mechanism is arranged to transport the substrates treated in said first treating section to said second treating section.

8. An apparatus as defined in claim 1, wherein said transport mechanism is arranged to transport the substrates treated in said second treating section to said first treating section.

9. A substrate treating apparatus comprising:
a storage block for receiving a receptacle that stores a plurality of substrates;
a first treating block for treating a plurality of substrates en bloc;
a second treating block for treating the substrates one at a time; and
a transport block for transporting the substrates between said receptacle received in said storage block, said first treating block and said second treating block.

10. An apparatus as defined in claim 9, wherein said second-treating block is disposed between said first treating block and said storage block, and said transport block is disposed between said first treating block and said storage block, and opposed to said second treating block.

11. An apparatus as defined in claim 9, wherein said first treating block, said second treating block and said storage block are arranged along a long side of the substrate treating apparatus.

12. An apparatus as defined in claim 9, wherein said first treating block is arranged to clean and dry a plurality of substrates en bloc, and said second treating block is arranged to clean and dry the substrates one at a time.

13. An apparatus as defined in claim 12, wherein said second treating block is arranged to clean at least edge regions on a back surface of each of the substrates.

14. An apparatus as defined in claim 12, wherein said second treating block is arranged further to etch the substrates one at a time.

15. An apparatus as defined in claim 9, wherein said transport block is arranged to transport the substrates treated in said second treating block from said second treating block to said first treating block.

16. An apparatus as defined in claim 9, wherein said transport block is arranged to transport the substrates treated in said first treating block from said first treating block to said second treating block.

17. An apparatus as defined in claim 9, wherein said transport block is arranged to transport the substrates from said receptacle to said second treating block, to transport the substrates treated in said second treating block from said second treating block to said first treating block, and to transport the substrates treated in said first treating block from said first treating block to said receptacle.

18. An apparatus as defined in claim 9, wherein:
said transport block includes a transport block's transport mechanism for transporting a plurality of substrates en bloc; and
said second treating block includes:
a single-substrate treating section for cleaning and drying the substrates one at a time;
a second treating block's substrate rack for holding a plurality of substrates; and
a second treating block's transport mechanism for transporting the substrates one at a time between said single-substrate treating section and said second treating block's substrate rack;
said transport block's transport mechanism placing and fetching a plurality of substrates en bloc on/from said second treating block's substrate rack.

19. An apparatus as defined in claim 18, wherein:
said second treating block's substrate rack includes:
a pre-treatment substrate rack for holding a plurality of substrates before treatment in the single-substrate treating section; and
a post-treatment substrate rack for holding a plurality of substrates after the treatment in the single-substrate treating section;
said second treating block's transport mechanism transporting the substrates one at a time from said pre-treatment substrate rack to said single-substrate treating section, and transporting the substrates one at a time from said single-substrate treating section to said post-treatment substrate rack;
said transport block's transport mechanism placing a plurality of substrates en bloc on said pre-treatment substrate rack, and fetching a plurality of substrates en bloc from said post-treatment substrate rack.

20. An apparatus as defined in claim 19, wherein, where said transport block's transport mechanism can transport the substrates, N in number, each of said pre-treatment substrate rack and said post-treatment substrate rack can hold the substrates, a multiple of N in number.

21. An apparatus as defined in claim 19, wherein:
said single-substrate treating section includes a plurality of treating units arranged in a plurality of rows and in a plurality of stages;
said second treating block's transport mechanism transporting the substrates one at a time from said pre-treatment substrate rack to each of said treating units, and transporting the substrates one at a time from each of said treating units to said post-treatment substrate rack.

22. An apparatus as defined in claim 9, wherein:
said transport block includes a transport block's transport mechanism for transporting a plurality of substrates en bloc; and
said first treating block includes:
a batch treating section for liquid-treating and drying a plurality of substrates en bloc;
a first treating block's substrate rack for holding a plurality of substrates; and
a first treating block's transport mechanism for transporting a plurality of substrates en block between said batch treating section and said first treating block's substrate rack;
said transport block's transport mechanism placing and fetching a plurality of substrates en bloc on/from said first treating block's substrate rack.

23. An apparatus as defined in claim 22, wherein:
said transport block's transport mechanism is arranged to deliver and receive the substrates in horizontal posture to/from said first treating block's substrate rack;
said first treating block's transport mechanism is arranged to deliver and receive the substrates in vertical posture to/from said first treating block's substrate rack; and
said first treating block's substrate rack is arranged to change a plurality of substrates en block between horizontal posture and vertical posture for transfer to said transport block's transport mechanism and said first treating block's transport mechanism.

24. An apparatus as defined in claim 9, further comprising:
a partition separating said storage block from said second treating block and said transport block, and defining a passage opening opposed to said receptacle in said storage block for allowing passage of the substrates; and
a shutter member for opening and closing said passage opening;
said transport block being arranged to load and unload the substrates into/from said receptacle in said storage block through said passage opening.

25. An apparatus as defined in claim 24, wherein said receptacle has an opening formed in one side thereof, and a lid for closing said opening, said shutter member having an attaching/detaching and holding mechanism for attaching, detaching and holding said lid of said receptacle in said storage block.

26. A substrate treating apparatus comprising:
a receptacle table for supporting a receptacle that stores a plurality of substrates;
a first treating block for treating a plurality of substrates en bloc;
a second treating block for treating the substrates one at a time; and
a transport block for transporting the substrates between said receptacle placed on said receptacle table, said first treating block and said second treating block;
wherein said second treating block is disposed between said first treating block and said receptacle table, and said transport block is disposed between said first treating block and said receptacle table and opposed to said second treating block.

27. An apparatus as defined in claim 26, wherein said first treating block is arranged to clean and dry a plurality of substrates en bloc, and said second treating block is arranged to clean and dry the substrates one at a time.

28. An apparatus as defined in claim 27, wherein said second treating block is arranged to clean at least edge regions on a back surface of each of the substrates.

29. An apparatus as defined in claim 27, wherein said second treating block is arranged further to etch the substrates one at a time.

30. An apparatus as defined in claim 26, wherein said transport block is arranged to transport the substrates treated in said second treating block from said second treating block to said first treating block.

31. An apparatus as defined in claim 26, wherein said transport block is arranged to transport the substrates treated in said first treating block from said first treating block to said second treating block.

32. An apparatus as defined in claim 26, wherein said transport block is arranged to transport the substrates from said receptacle to said second treating block, to transport the substrates treated in said second treating block from said second treating block to said first treating block, and to transport the substrates treated in said first treating block from said first treating block to said receptacle.

33. An apparatus as defined in claim 26, wherein:
said transport block includes a transport block's transport mechanism for transporting a plurality of substrates en bloc; and
said second treating block includes:
a single-substrate treating section for cleaning and drying the substrates one at a time;
a second treating block's substrate rack for holding a plurality of substrates; and
a second treating block's transport mechanism for transporting the substrates one at a time between said single-substrate treating section and said second treating block's substrate rack;
said transport block's transport mechanism placing and fetching a plurality of substrates en bloc on/from said second treating block's substrate rack.

34. An apparatus as defined in claim 33, wherein:
said second treating block's substrate rack includes:
a pre-treatment substrate rack for holding a plurality of substrates before treatment in the single-substrate treating section; and
a post-treatment substrate rack for holding a plurality of substrates after the treatment in the single-substrate treating section;
said second treating block's transport mechanism transporting the substrates one at a time from said pre-treatment substrate rack to said single-substrate treating section, and transporting the substrates one at a time from said single-substrate treating section to said post-treatment substrate rack;
said transport block's transport mechanism placing a plurality of substrates en bloc on said pre-treatment substrate rack, and fetching a plurality of substrates en bloc from said post-treatment substrate rack.

35. An apparatus as defined in claim 34, wherein, where said transport block's transport mechanism can transport the substrates, N in number, each of said pre-treatment substrate rack and said post-treatment substrate rack can hold the substrates, a multiple of N in number.

36. An apparatus as defined in claim 34, wherein:
said single-substrate treating section includes a plurality of treating units arranged in a plurality of rows and in a plurality of stages;
said second treating block's transport mechanism transporting the substrates one at a time from said pre-treatment substrate rack to each of said treating units, and transporting the substrates one at a time from each of said treating units to said post-treatment substrate rack.

37. An apparatus as defined in claim 26, wherein:
said transport block includes a transport block's transport mechanism for transporting a plurality of substrates en bloc; and
said first treating block includes:
a batch treating section for liquid-treating and drying a plurality of substrates en bloc;
a first treating block's substrate rack for holding a plurality of substrates; and
a first treating block's transport mechanism for transporting a plurality of substrates en block between said batch treating section and said first treating block's substrate rack;
said transport block's transport mechanism placing and fetching a plurality of substrates en bloc on/from said first treating block's substrate rack.

38. An apparatus as defined in claim 37, wherein:
said transport block's transport mechanism is arranged to deliver and receive the substrates in horizontal posture to/from said first treating block's substrate rack;
said first treating block's transport mechanism is arranged to deliver and receive the substrates in vertical posture to/from said first treating block's substrate rack; and
said first treating block's substrate rack is arranged to change a plurality of substrates en block between horizontal posture and vertical posture for transfer to said transport block's transport mechanism and said first treating block's transport mechanism.

39. A substrate treating apparatus comprising:
a receptacle table for supporting a receptacle that stores a plurality of substrates;
a first treating block for treating a plurality of substrates en bloc;
a second treating block for treating the substrates one at a time; and
a transport block for transporting the substrates between said receptacle placed on said receptacle table, said first treating block and said second treating block;
wherein said first treating block, said second treating block and said receptacle table are arranged in order along a long side of the substrate treating apparatus.

40. An apparatus as defined in claim 39, wherein said first treating block is arranged to clean and dry a plurality of substrates en bloc, and said second treating block is arranged to clean and dry the substrates one at a time.

41. An apparatus as defined in claim 40, wherein said second treating block is arranged to clean at least edge regions on a back surface of each of the substrates.

42. An apparatus as defined in claim 40, wherein said second treating block is arranged further to etch the substrates one at a time.

43. An apparatus as defined in claim 39, wherein said transport block is arranged to transport the substrates treated in said second treating block from said second treating block to said first treating block.

44. An apparatus as defined in claim 39, wherein said transport block is arranged to transport the substrates treated in said first treating block from said first treating block to said second treating block.

45. An apparatus as defined in claim 39, wherein said transport block is arranged to transport the substrates from said receptacle to said second treating block, to transport the substrates treated in said second treating block from said second treating block to said first treating block, and to transport the substrates treated in said first treating block from said first treating block to said receptacle.

46. An apparatus as defined in claim 39, wherein:
said transport block includes a transport block's transport mechanism for transporting a plurality of substrates en bloc; and
said second treating block includes:
a single-substrate treating section for cleaning and drying the substrates one at a time;
a second treating block's substrate rack for holding a plurality of substrates; and
a second treating block's transport mechanism for transporting the substrates one at a time between said single-substrate treating section and said second treating block's substrate rack;
said transport block's transport mechanism placing and fetching a plurality of substrates en bloc on/from said second treating block's substrate rack.

47. An apparatus as defined in claim 46, wherein:
said second treating block's substrate rack includes:
a pre-treatment substrate rack for holding a plurality of substrates before treatment in the single-substrate treating section; and
a post-treatment substrate rack for holding a plurality of substrates after the treatment in the single-substrate treating section;
said second treating block's transport mechanism transporting the substrates one at a time from said pre-treatment substrate rack to said single-substrate treating section, and transporting the substrates one at a time from said single-substrate treating section to said post-treatment substrate rack;
said transport block's transport mechanism placing a plurality of substrates en bloc on said pre-treatment substrate rack, and fetching a plurality of substrates en bloc from said post-treatment substrate rack.

48. An apparatus as defined in claim 47, wherein, where said transport block's transport mechanism can transport the substrates, N in number, each of said pre-treatment substrate rack and said post-treatment substrate rack can hold the substrates, a multiple of N in number.

49. An apparatus as defined in claim 47, wherein:
said single-substrate treating section includes a plurality of treating units arranged in a plurality of rows and in a plurality of stages;
said second treating block's transport mechanism transporting the substrates one at a time from said pre-treatment substrate rack to each of said treating units, and transporting the substrates one at a time from each of said treating units to said post-treatment substrate rack.

50. An apparatus as defined in claim 39, wherein:
said transport block includes a transport block's transport mechanism for transporting a plurality of substrates en bloc; and
said first treating block includes:
a batch treating section for liquid-treating and drying a plurality of substrates en bloc;
a first treating block's substrate rack for holding a plurality of substrates; and
a first treating block's transport mechanism for transporting a plurality of substrates en block between said batch treating section and said first treating block's substrate rack;
said transport block's transport mechanism placing and fetching a plurality of substrates en bloc on/from said first treating block's substrate rack.

51. An apparatus as defined in claim 50, wherein:
said transport block's transport mechanism is arranged to deliver and receive the substrates in horizontal posture to/from said first treating block's substrate rack;
said first treating block's transport mechanism is arranged to deliver and receive the substrates in vertical posture to/from said first treating block's substrate rack; and
said first treating block's substrate rack is arranged to change a plurality of substrates en block between horizontal posture and vertical posture for transfer to said transport block's transport mechanism and said first treating block's transport mechanism.

52. A substrate treating apparatus comprising:
a storage block for receiving receptacles each storing a plurality of substrates;
a first treating block for treating a plurality of substrates en bloc; and
a second treating block for treating the substrates one at a time;
said storage block including:
a first table for holding the receptacles for access from said first treating block;
a second table for holding the receptacles for access from said second treating block; and
a receptacle transport device for transporting the receptacles between said first table and said second table;
wherein said first treating block includes a first transport mechanism for loading and unloading the substrates into/from the receptacles placed on said first table; and
said second treating block includes a second transport mechanism for loading and unloading the substrates into/from the receptacles placed on said second table.

53. An apparatus as defined in claim 52, wherein said receptacle transport device is arranged to transport receptacles storing substrates treated in said second treating block, from said second table to said first table.

54. An apparatus as defined in claim 52, wherein said receptacle transport device is arranged to transport receptacles storing substrates treated in said first treating block, from said first table to said second table.

55. An apparatus as defined in claim 52, wherein said first treating block and said second treating block are arranged at one side of said storage block.

56. An apparatus as defined in claim 52, wherein said first treating block and said second treating block are opposed to each other.

57. An apparatus as defined in claim 52, wherein said storage block further includes a rack for holding a plurality of receptacles, said receptacle transport device having a further function for transporting the receptacles to and from said rack.

58. An apparatus as defined in claim 57, wherein said rack is disposed on a receptacle transport track between said first table and said second table.

59. An apparatus as defined in claim 57, wherein said rack is arranged to hold the plurality of receptacles as arranged along a receptacle transport track of said receptacle transport device.

60. An apparatus as defined in claim 57, wherein said receptacle transport device includes a third transport mechanism for transporting the receptacles between said first table and said rack, and a fourth transport mechanism for transporting the receptacles between said second table and said rack.

61. An apparatus as defined in claim 57, wherein said third transport mechanism is movable along one side of said rack for loading and unloading the receptacles on/from said rack at said one side, and said fourth transport mechanism is movable along the other side of said rack for loading and unloading the receptacles on/from said rack at said other side.

62. An apparatus as defined in claim 61, wherein said second table comprises a plurality of tables arranged on an extension of said rack, said fourth transport mechanism being movable along said other side of said rack which is remote from said first treating block.

63. An apparatus as defined in claim 52, further comprising:
a first partition separating said storage block from said first treating block, and defining a first passage opening opposed to the receptacles placed on said first table for allowing passage of the substrates;
a first shutter member for opening and closing said first passage opening;
a second partition separating said storage block from said second treating block, and defining a second passage opening opposed to the receptacles placed on said second table for allowing passage of the substrates; and
a second shutter member for opening and closing said second passage opening;
said first transport mechanism being arranged to load and unload the substrates en bloc into/from said receptacles on said first table through said first passage opening;
said second transport mechanism being arranged to load and unload the substrates one at a time into/from said receptacles on said second table through said second passage opening.

64. An apparatus as defined in claim 63, wherein:
each of said receptacles has an opening formed in one side thereof, and a lid for closing said opening;
said first shutter member having a first attaching/detaching and holding mechanism for attaching, detaching and holding said lid;
said second shutter member having a second attaching/detaching and holding mechanism for attaching, detaching and holding said lid.

65. An apparatus as defined in claim 52, wherein said first treating block is arranged to clean and dry a plurality of substrates en bloc, and said second treating block is arranged to clean and dry the substrates one at a time.

66. An apparatus as defined in claim 65, wherein said second treating block is arranged to clean at least edge regions on a back surface of each of the substrates.

67. A substrate treating apparatus comprising:
a storage block for receiving receptacles each storing a plurality of substrates;
a first treating block for treating a plurality of substrates en bloc; and
a second treating block for treating the substrates one at a time;
said storage block including:
a first table for holding a receptacle for access from said first treating block;
a second table for holding a receptacle for access from said second treating block;
a third table for holding receptacles for access from outside said substrate treating apparatus; and
a receptacle transport device for transporting the receptacles between said first table, said second table and said third table;
wherein said first treating block includes a first transport mechanism for loading and unloading the substrates into/from a receptacle placed on said first table; and
said second treating block includes a second transport mechanism for loading and unloading the substrates into/from a receptacle placed on said second table, and is disposed between said first treating block and said third table.

68. An apparatus as defined in claim 67, wherein the receptacles placed on said first table and said second table have substrate-loading and -unloading planes thereof facing in the same direction.

69. An apparatus as defined in claim 67, further comprising shelves arranged along a transport path of said receptacle transport device for holding a plurality of receptacles as arranged thereon, said receptacle transport device transporting the receptacles to and from said shelves.

70. An apparatus as defined in claim 69, wherein said shelves are arranged in a position between said first treating block and said third table, and opposed to said second treating block.

71. An apparatus as defined in claim 70, wherein said shelves have one lateral end thereof acting as said first table.

72. An apparatus as defined in claim 69, wherein said second table is disposed on an extension of said shelves.

73. An apparatus as defined in claim 67, wherein said second table comprises a plurality of tables arranged vertically.

74. An apparatus as defined in claim 67, further comprising:
a first partition separating said storage block from said first treating block, and defining a first passage opening opposed to the receptacles placed on said first table for allowing passage of the substrates;
a first shutter member for opening and closing said first passage opening;
a second partition separating said storage block from said second treating block, and defining a second passage opening opposed to the receptacles placed on said second table for allowing passage of the substrates; and
a second shutter member for opening and closing said second passage opening;
said first transport mechanism being arranged to load and unload the substrates en bloc into/from said receptacles on said first table through said first passage opening;
said second transport mechanism being arranged to load and unload the substrates one at a time into/from said receptacles on said second table through said second passage opening.

75. An apparatus as defined in claim 74, wherein:
each of said receptacles has an opening formed in one side thereof, and includes a lid for closing said opening;
said first shutter member having a first attaching/detaching and holding mechanism for attaching, detaching and holding said lid;
said second shutter member having a second attaching/detaching and holding mechanism for attaching, detaching and holding said lid.

76. An apparatus as defined in claim 67, wherein said first treating block is arranged to clean and dry a plurality of substrates en bloc, and said second treating block is arranged to clean and dry the substrates one at a time.

77. An apparatus as defined in claim 76, wherein said second treating block is arranged to clean at least edge regions on a back surface of each of the substrates.

78. A substrate treating apparatus comprising:
a storage block for receiving receptacles each storing a plurality of substrates;
a first treating block for treating a plurality of substrates en bloc; and
a second treating block for treating the substrates one at a time;
said storage block including:
a first table for holding a receptacle for access from said first treating block;
a second table for holding a receptacle for access from said second treating block; and
a receptacle transport device for transporting the receptacles between said first table and said second table;
said first treating block including:
a first transport mechanism for loading and unloading the substrates into/from a receptacle placed on said first table; and
a batch treating section for treating with a solution or drying a plurality of substrates en bloc;
wherein said second treating block includes a second transport mechanism for loading and unloading the substrates into/from a receptacle placed on said second table, and is disposed on an extension of a direction in which said batch treating section is arranged.

79. An apparatus as defined in claim 78, wherein the receptacles placed on said first table and said second table have substrate-loading and -unloading planes thereof facing in the same direction.

80. An apparatus as defined in claim 78, further comprising shelves arranged along a transport path of said receptacle transport device for holding a plurality of receptacles as arranged thereon, said receptacle transport device transporting the receptacles to and from said shelves.

81. An apparatus as defined in claim 80, wherein said shelves have one lateral end thereof acting as said first table.

82. An apparatus as defined in claim 80, wherein said second table is disposed on an extension of said shelves.

83. An apparatus as defined in claim 78, wherein said second table comprises a plurality of tables arranged vertically.

84. An apparatus as defined in claim 78, further comprising:
a first partition separating said storage block from said first treating block, and defining a first passage opening opposed to the receptacles placed on said first table for allowing passage of the substrates;
a first shutter member for opening and closing said first passage opening;
a second partition separating said storage block from said second treating block, and defining a second passage opening opposed to the receptacles placed on said second table for allowing passage of the substrates; and
a second shutter member for opening and closing said second passage opening;
said first transport mechanism being arranged to load and unload the substrates en bloc into/from said receptacles on said first table through said first passage opening;
said second transport mechanism being arranged to load and unload the substrates one at a time into/from said receptacles on said second table through said second passage opening.

85. An apparatus as defined in claim 84, wherein:
each of said receptacles has an opening formed in one side thereof, and includes a lid for closing said opening;
said first shutter member having a first attaching/detaching and holding mechanism for attaching, detaching and holding said lid;
said second shutter member having a second attaching/detaching and holding mechanism for attaching, detaching and holding said lid.

86. An apparatus as defined in claim 78, wherein said first treating block is arranged to clean and dry a plurality of substrates en bloc, and said second treating block is arranged to clean and dry the substrates one at a time.

87. An apparatus as defined in claim 86, wherein said second treating block is arranged to clean at least edge regions on a back surface of each of the substrates.
